(19) United States
(12) Patent Application Publication
(10) Pub. No.: US 2006/0218182 A1
(43) Pub. Date: Sep. 28, 2006

(54) Assessing data sets

(76) Inventors: Philip Morrison Giffard, Balmoral (AU); Gail Alexandra Philippa Robertson, Queensland (AU); Venugopal Thiruvenkataswamy, New South Wales (AU); Erin Peta Price, Clayfield (AU); Flavia Huygens, Westlake (AU); Frans Alexander Henskens, Broadmeadow (AU); Hayden James Shilling, Raymond Terrace (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/508,579

(22) PCT Filed: Mar. 18, 2003
(86) PCT No.: PCT/AU03/00320

§ 371 Date: Jan. 9, 2006

(30) Foreign Application Priority Data
Mar. 18, 2002 (AU) PS 1155

(51) Int. Cl. G06F 7/00

(52) U.S. Cl. 707/104.1

(57) ABSTRACT

The present invention relates generally to a method for assessing data sets, such as multi-parametric data sets. More particularly, the present invention contemplates a method for determining differences between objects in a data set wherein each object is described using one or more parameters. The present invention is particularly useful inter alia in the field of bioinformatics such as to determine differences in populations of nucleotide or amino acid sequences [100]. Such differences are referred to herein as polymorphisms such as polymorphisms within a sequence database. Populations so identified [110] may provide a fingerprint of inter alia a particular nucleic acid molecule, protein, trait or disease condition. The present invention extends, however, to identifying sub-populations of data relevant inter alia to commerce, industry or the environment. Once polymorphisms are identified, oligonucleotide or peptide based procedures may then be adopted to screen for particular informative polymorphisms in various clinical, environmental, industrial, domestic or laboratory environments.

### BACKGROUND OF THE INVENTION

1. Field of the Invention

The present invention relates generally to a method for assessing data sets, such as multi-parametric data sets. More particularly, the present invention contemplates a method for determining differences between objects in a data set wherein each object is described using one or more parameters. The present invention is particularly useful inter alia in the field of bioinformatics such as to determine differences in populations of nucleotide or amino acid sequences. Such differences are referred to herein as polymorphisms such as polymorphisms within a sequence database. Populations so identified may provide a fingerprint of inter alia a particular nucleic acid molecule, protein, trait or disease condition. The polymorphisms, therefore, are referred to as informative polymorphisms. The present invention extends, however, to identifying sub-populations of data relevant inter alia to commerce, industry, security and the environment. Once polymorphisms are identified, oligonucleotide or peptide based procedures may then be adopted to screen for particular informative polymorphisms in eukaryotic and prokaryotic cells, viruses and prions in various clinical, environmental, industrial, domestic, laboratory, military or forensic environments. The method of the present invention has broad applicability in the assessment of a range of data sets including assessing business and financial data for discriminatory features. Such information is useful in the development of the business or making investment decisions.

2. Description of the Prior Art

Bibliographic details of the publications referred to by author in this specification are collected at the end of the description.

The reference to any prior art in this specification is not, and should not be taken as, an acknowledgement or any form of suggestion that the prior art forms part of the common general knowledge in any country.

Informatics is the study and application of computer and statistical techniques for the management of information. Bioinfomatics is the systemic development and application of information technologies and determining techniques for processing, analysing and displaying data obtained by experiments, modelling database searching and instrumentation to make observations about biological processes.

In genome projects, bioinformatics includes the development of methods to search databases quickly, to analyze nucleic acid sequence information and to predict protein sequence and structure from DNA sequence data. The ability to discriminate between populations of biological molecules permits the development of new diagnostic agents and provides targets for therapeutic intervention. Furthermore, there is increasing number of DNA sequence databases and, hence, genotyping can be rapidly carried out using, for example, DNA chips. There is a need to be able to mine available sequence data to determine which polymorphic sites can be interrogated in order to discriminate between known variants.

Due to processing requirements, molecular biology is increasingly directed to reliance on the use of computers and in particular the use of powerful and fast computers. Advances in quantitative analysis, database comparisons and computational algorithms are utilised to analyze, categorize and explore research produced information.

Currently, identified nucleic acid sequences are compared with other known sequences using heuristic search algorithms such as the Basic Alignment Search Tool (BLAST). A BLAST search compares a sequence of nucleotides with all sequences in a given database and proceeds by identifying similarity matches that indicate potential identity and function of a gene under review. BLAST is employed by programs that assign a statistical significance to the matches using the methods of Karlin and Altschul (Proc. Natl. Acad. Sci. USA 87(6): 2264-2268, 1990). Homologies from between sequences are electronically recorded and annotated with information available from public sequence databases such as GenBank. Homology information derived from these comparisons is often used in an attempt to assign a function to a sequence.

However, despite the availability of sequence comparative software programs such as those described above, there is a need to develop further software to screen nucleotide and amino acid sequences to determine polymorphisms which are useful in the discrimination of particular genetic and proteinaceous populations. This is important, for example, to quickly identify new and emerging variants of pathogens such as new strains of influenza and HIV, drug resistant Staphylococcus species and drug resistant Neisseria species.

In accordance with the present invention, a method is developed for determining differences and/or identifying populations within a data set such as a multi-parametric data set. Such differences are referred to herein as “polymorphisms”. The method has wide applicability, not only in biotechnology and bioinformatics, but also in business or in any situation requiring the comparative analysis of data sets requiring the identification of distinguishing differences between sets of data. An important consequence of the present invention is the ability to find the minimum number of single nucleotide polymorphisms (SNPs) needed to obtain a reliable genetic fingerprint of, for example, a microorganism or virus for the purpose of epidemiological tracking. The identification of an informative SNP giving a high discrimination potential further enables tracking of biological reagents deliberately or accidentally released.

### SUMMARY OF THE INVENTION

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

Nucleotide and amino acid sequences are referred to by a sequence identifier number (SEQ ID NO:). The SEQ ID NOs: correspond numerically to the sequence identifiers <400>1 (SEQ ID NO:1), <400>2 (SEQ ID NO:2), etc. A summary of the sequence identifiers is provided in Table 1. A sequence listing is provided after the claims.

SNPs are frequently referred to herein by locus number, e.g. fumC435. The numbering system adopted is according to the sequence fragments defined in the MLST databases. The MLST website is at http://www.mlst.net/new/index.htm.

The present invention contemplates a method for analyzing a data set by compiling a data set for a population comprising a data string for each member of the population, identifying one or more variable parameters present in each of the data strings, comparing the one or more variable parameters between at least two of the data strings and identifying a subset of the population on the basis of the comparison.

Compiling a data set may include using a pre-existing data set. Compiling a data set may include inputting data relating to at least one member of the population. Compiling a data set may include the step of retaining input data. The population preferably comprises members that are biological entities. The biological entities may be one or more of nucleic acids, proteins, amino acids, nucleic acid sequences, amino acids sequences, microorganisms including viruses, prions, unicellular organisms, prokaryotes and eukaryotes.

Alternatively, the population may comprise members that are commercial entities. The commercial entities may be hotels, supermarkets, investment undertakings, clubs or fundraising schemes.

The population may also be a collection of words, letters or other symbols where analysis of differences between populations of words, letters or symbols may be important for security purposes or coding purposes. It is clear to a person skilled in the art that the method of the present invention may be applied to any population having members definable by a multi-parametric data set in which at least one of the parameters may vary.

Each data string preferably comprises sequential data parameters. The data set most preferably includes location identifying information for the one or more variable parameters. Each data string may comprise a nucleic acid sequence or an amino acid sequence. The data string may comprise as little as two parameters but preferably comprises a large number of parameters.

Identifying one or more variable parameters may comprise comparing at least two and preferably a plurality of data strings to detect variations. The one or more variable parameters are preferably localised to an identified site. In a preferred embodiment, the site is a site for a single nucleotide polymorphism (“SNP”).

Accordingly, another aspect of the present invention provides a method for assessing a multi-parametric data set, said method comprising:—
(a) inputting data from the multi-parametric data set;
(b) determining differences between populations of objects within the data set; and
(c) generating a fingerprint of the populations based on differences between the objects.

The present invention further provides a method of assessing a data set with respect to one or more other data, sets, each data set being formed from a sequence of elements, each element having a respective one of a number of values, the method including:
(a) determining elements having different values between the data set and any other data set;
(b) determining a discriminatory power for at least some of the elements, the discriminatory power representing the usefulness of the element in determining the similarity between the data set and any other data set; and
(c) selecting one or more of the elements in accordance with the determined discriminatory powers.

Still another aspect of the present invention contemplates a method of assessing a data set with respect to one or more other data sets, each data set being formed from a sequence of elements, each element having a respective one of a number of values, the method including:
(a) determining polymorphic elements having different values between the data set and any other data set;
(b) determining a discriminatory power for at least some of the polymorphic elements, the discriminatory power representing the usefulness of the polymorphic element in determining the similarity between the data set and any other data set; and
(c) selecting one or more of the polymorphic elements in accordance with the determined discriminatory powers.

The subject method is particularly useful for determining polymorphic elements. Generally, a “polymorphism” or “polymorphic element” is an identifiable difference at the nucleotide or amino acid level between populations of similar nucleic acid or protein molecules. However, the “polymorphism” or “polymorphic element” is used in its most general sense to include any difference in elements of a data set or in populations of elements of a data set which are useful to distinguish between data sets or populations therein.

The method of determining the polymorphic elements typically includes comparing the value of each element with the value of a corresponding element in each other data set.

Each element, therefore, typically has a respective location within the data set, each corresponding element having the same location in the other data set. In this case, the data set generally includes location information representing the location of each element.

The method may include selecting the elements, such as polymorphic elements, to determine an identifier representative of the data set. This technique can, therefore, be used to generate a fingerprint representative of the data set under consideration.

The polymorphic elements may be selected to allow the data set to be discriminated from each of the other data sets. Alternatively, the polymorphic elements may be selected to allow the data set and a selected one of other data sets to be determined as identical to each other.

The discriminatory power of each polymorphic element or combination of polymorphic elements can be determined using the formula:

$$D = 1 - \frac{1}{N ( N - 1 )} {\sum }_{j = 1}^{s} {n}_{j} ( {n}_{j} - 1 )$$

where:
N is the number of data sets being considered;
s is the number of classes defined; and
nⱼ is the number of data sets of the jth class;

However, alternative equations may also be used.

As a further alternative, the discriminatory power of each polymorphic element can be based on the number of other data sets that have an identical value for the corresponding element.

The determination of discriminatory power that is used will depend to a large extent on the purpose for which the discriminatory power is being used.

The method of selecting the elements generally includes:—
(a) selecting a first polymorphic element having the highest discriminatory power;
(b) selecting a next polymorphic element which in combination with the selected polymorphic element(s) has the next highest discriminatory power; and
(c) repeating step (b) with at least one of:—
   (i) a predetermined number of times; or
   (ii) until a predetermined level of discrimination is reached.

However, the method of selecting the elements may alternatively include:—
(a) selecting a number of sub-sets of the polymorphic elements;
(b) determining the discriminatory power of each sub-set; and
(c) selecting the elements to be the polymorphic elements of the sub-set having the highest discriminatory power.

The method of selecting a number of sub-sets of the polymorphic elements generally includes performing an initial screening process to determine a number of polymorphic elements having at least a predetermined discriminatory power. However, this is not essential and is generally only used in the event that there are a large number of polymorphic elements.

The method may further include determining a consensus data set defining a group of data sets from the data set and each other data set. For example, this can be used in defining groups of data sets.

The method of defining the consensus data set can include:—
(a) determining polymorphic elements having different values between each data set in the group; and
(b) defining the consensus data set by eliminating each of the polymorphic elements from a selected one of the data sets in the group.

Alternatively, the method of defining the consensus data set can include:—
(a) determining the values of corresponding elements in the group;
(b) determining any missing values, the missing values being values that are not present for corresponding elements in the group; and
(c) defining the consensus data set in terms of any missing values that are present in corresponding elements not included in the group.

The data set may represent any form of data, although generally represents biological entities, such as nucleic acids, proteins, amino acids, nucleic acid sequences, amino acids sequences, microorganisms including bacteria, viruses, prions, unicellular organisms, prokaryotes and eukaryotes.

Alternatively, the data set may be formed from any population having members definable by a multi-parametric data cell in which at least one of the parameters may vary. Thus, the data sets may include information regarding commercial entities, such as hotels, supermarkets, investment undertakings, clubs or fundraising schemes or the like.

Other embodiments include a method of assessing a nucleotide sequence data set which respect to one or more other nucleotide sequence data sets, each nucleotide in each data set having a respective one of a number of values, the method including:
(a) determining polymorphic nucleotides having different values between the data set and any other data set;
(b) determining a discriminatory power for at least some of the polymorphic nucleotides, the discriminatory power representing the usefulness of the polymorphic nucleotides in determining the similarity between the data set and any other data set; and
(c) selecting one or more of the polymorphic nucleotides in accordance with the determined discriminatory powers.

Yet another embodiment contemplates a method for analyzing a data set to determine a business's financial well being, said method comprising the steps of:
compiling a data set for two or more businesses, said data set comprising a data string for each business;
identifying one or more variable parameters, said variable parameters present in each of the data strings;
comprising the one or more variable parameters between at least two of the data strings; and
identifying a subset of the businesses on the basis of the comparison.

In another embodiment, the present invention provides a processing system for assessing a data set with respect to one or more other data sets, each data set being formed from a sequence of elements, each element having a respective one of a number of values, the processing system being adapted to:
(a) compare the value of each element of the data set with the value of corresponding elements in each other data set;
(b) identify one or more elements having different values between the data sets; and
(c) generate an indication of the one or more elements.

In general, the processing system includes a store for storing the one or more other data sets.

Typically, the processing system is adapted to perform the method of the first broad form of the invention.

In yet a further embodiment, the present invention provides a computer program product including computer executable code which when executed on a suitable processing system causes the processing system to:
(a) compare the value of each element of the data set with the value of corresponding elements in each other data set;
(b) identify one or more elements having different values between the data sets; and
(c) generate an indication of the one or more elements.

The computer program product is typically adapted to cause the processing system to perform the method of the first broad form of the invention.

The method of the present invention is particularly useful in finding the minimum number of SNPs needed to obtain a reliable genetic fingerprint of a, for example, microorganism or other pathogen such as a virus, for the purpose of epidemiological tracking.

The present invention further provides oligonucleotide or peptide, polypeptide or protein or other specific ligands such as antibodies which can be used to screen a nucleotide or amino acid sequence for an informative SNP. Arrays of oligonucleotides are particularly useful in screening for a range of SNPs in the genome or genetic sequence of a prokaryotic or eukaryotic organism or virus.

TABLE 1
Summary of sequence identifiers

| SEQUENCE | |
|---|---|
| ID NO: | DESCRIPTION |
| 1 | aroE-1 text [Table 20] |
| 2 | aroE-2 text [Table 20] |
| 3 | aroE-1 results [Table 22] |
| 4 | ST-1 [Table 28] |
| 5 | ST-7 [Table 31] |
| 6 | ST-7 [Table 32] |
| 7-10 | synthetic alleles [Table 34] |
| 11-12 | synthetic alleles [Table 35] |
| 13-16 | synthetic alleles [Table 36] |
| 17 | synethetic alleles [Table 37] |
| 18 | synthetic alleles [Table 38] |
| 19-22 | synthetic allele [Table 39] |
| 23-25 | synthetic alleles [Table 41] |
| 26-27 | synthetic alleles [Table 42] |
| 28-31 | synthetic alleles [Table 43] |
| 32 | fumC435-T (artificial sequence) [Table 46] |
| 33 | fumC435-C (artificial sequence) [Table 46] |
| 34 | fumC435-Rev (consensus sequence) [Table 46] |
| 35 | pdhC12-T (artificial sequence) [Table 46] |
| 36 | pdhC12-C (artificial sequence) [Table 46] |
| 37 | pdhC12-For (consensus sequence) [Table 46] |
| 38 | abcZ411-T (artificial sequence) [Table 47] |
| 39 | abcZ411-C (artificial sequence) [Table 47] |
| 40 | abcZ411-For (consensus sequence) [Table 47] |
| 41 | aroE455-A (artificial sequence) [Table 47] |
| 42 | aroE455-G (artificial sequence) [Table 47] |
| 43 | aroE455-For (consensus sequence) [Table 47] |
| 44 | fumC201-A (artificial sequence) [Table 47] |
| 45 | fumC201-G (artificial sequence) [Table 47] |
| 46 | fumC201-Rev (consensus sequence) [Table 47] |
| 47 | pdhC274-C (artificial sequence) [Table 47] |
| 48 | pdhC274-T (artificial sequence) [Table 47] |
| 49 | pdhC274-For (consensus sequence) [Table 47] |
| 50 | Mega-pgm93-A (artificial sequence) [Table 52] |
| 51 | Mega-pgm93-C (artificial sequence) [Table 52] |
| 52 | Mega-pgm93-G (artificial sequence) [Table 52] |
| 53 | Mega-pgm93-Rev (artificial sequence) [Table 52] |
| 54 | Mega-aroE283-A (artificial sequence) [Table 52] |
| 55 | Mega-aroE283-C (artificial sequence) [Table 52] |
| 56 | Mega-aroE283-G (artificial sequence) [Table 52] |
| 57 | Mega-aroE283A-T (artificial sequence) [Table 52] |
| 58 | Mega-aroE283G-T (artificial sequence) [Table 52] |
| 59 | Mega-aroE283-Rev (artificial sequence) [Table 52] |
| 60 | Mega-fumC114-C (artificial sequence) [Table 52] |
| 61 | Mega-fumC114-T (artificial sequence) [Table 52] |
| 62 | Mega-fumC114-For (artificial sequence) [Table 52] |
| 63 | Mega-abcZ183-T (artificial sequence) [Table 52] |
| 64 | Mega-abcZ183-C (artificial sequence) [Table 52] |
| 65 | Mega-abcZ183-G (artificial sequence) [Table 52] |
| 66 | Mega-abcZ183-For (artificial sequence) [Table 52] |
| 67 | Mega-abcZ54-C (artificial sequence) [Table 52] |
| 68 | Mega-abcZ54-T (artificial sequence) [Table 52] |
| 69 | Mega-abcZ54-Rev (artificial sequence) [Table 52] |
| 70 | Mega-gdh60-A (artificial sequence) [Table 52] |
| 71 | Mega-gdh60-G (artificial sequence) [Table 52] |
| 72 | Mega-gdh60-Rev (artificial sequence) [Table 52] |
| 73 | Mega-pdhC103-C (artificial sequence) [Table 52] |
| 74 | Mega-pdhC103-T (artificial sequence) [Table 52] |
| 75 | Mega-pdhC103-For (artificial sequence) [Table 52] |
| 76 | ST-30 results |
| 77 | arcC272G (forward 1) (ST-30 specific) [Table 63] |
| 78 | arcC272A (forward 2) (non-ST-30 specific) [Table 63] |
| 79 | arcC272 (reverse) [Table 63] |
| 80 | mecA P1 primer |
| 81 | HVR P1 primer |
| 82 | HVR P2 primer |
| 83 | IS P4 primer |
| 84 | MDV R5 primer |
| 85 | INS117 R2 primer |
| 86 | arcC210 (forward) (artificial sequence) [Table 66] |
| 87 | arcC210C (reverse 1) (artificial sequence) [Table 66] |
| 88 | arcC210T (reverse 2) (artificial sequence) [Table 66] |
| 89 | arcC210A (reverse 3) (artificial sequence) [Table 66] |
| 90 | tpi243A (forward 1) (artificial sequence) [Table 66] |
| 91 | tpi243G (forward 2) (artificial sequence) [Table 66] |
| 92 | tpi243 (reverse) (artificial sequence) [Table 66] |
| 93 | arcC162T (forward 1) (artificial sequence) [Table 66] |
| 94 | arcC162A (forward 2) (artificial sequence) [Table 66] |
| 95 | arcC162 (reverse) (artificial sequence) [Table 66] |
| 96 | tpi241G (forward 1) (artificial sequence) [Table 66] |
| 97 | tpi241A (forward 2) (artificial sequence) [Table 66] |
| 98 | tpi241 (reverse) (artificial sequence) [Table 66] |
| 99 | yqiL333C (forward 1) (artificial sequence) [Table 66] |
| 100 | yqiL333T (forward 2) (artificial sequence) [Table 66] |
| 101 | yqiL333 (reverse) (artificial sequence) [Table 66] |
| 102 | aroE132A (forward 1) (artificial sequence) [Table 66] |
| 103 | aroE132G (forward 2) (artificial sequence) [Table 66] |
| 104 | aroE132 (reverse) (artificial sequence) [Table 66] |
| 105 | gmk129C (forward 1) (artificial sequence) [Table 66] |
| 106 | gmk129T (forward 2) (artificial sequence) [Table 66] |
| 107 | gmk129 (reverse) (artificial sequence) [Table 66] |
| 108 | pta294 (forward) (artificial sequence) [Table 75] |
| 109 | pta294A (reverse 1) (artificial sequence) [Table 75] |
| 110 | pta294C (reverse 2) (artificial sequence) [Table 75] |
| 111 | pta294T (reverse 3) (artificial sequence) [Table 75] |
| 112 | aroE87G (forward 1) (artificial sequence) [Table 75] |
| 113 | aroE87A (forward 2) (artificial sequence) [Table 75] |
| 114 | aroE87 (reverse) (artificial sequence) [Table 75] |

### BRIEF DESCRIPTION OF THE FIGURES

FIG. 1 is a diagrammatic representation showing the relationship between the various classes.

FIG. 2 is a diagrammatic representation showing AlleleTree for aroE-1 by Defined Allele method. (RV refers to ResultVector, R refers to Result, list refers to keyList).

FIG. 3 is a diagrammatic representation showing AlleleTree for the locus aroE by generalized method.

FIG. 4 is a diagrammatic representation showing an interaction diagram of objects.

FIG. 5 is a representation showing the Allele options window.

FIG. 6 is a schematic diagram of an example of a system for implementing the present invention.

FIG. 7 is a flow diagram showing the generalised structure of programs designed to extract informative SNPs from nucleotide sequence alignments.

FIG. 8 is a flow diagram showing the procedure for determining the discriminatory power of single SNPs or groups of SNPs in “specified allele” programs.

FIG. 9 is a flow diagram showing the method of determining the discriminatory power of single SNPs or groups of SNPs in “generalized” programs.

FIG. 10 is a flow diagram showing the procedure for finding useful SNPs by the anchored method.

FIG. 11 is a flow diagram showing the procedure for finding useful SNPs by the complete method.

FIG. 12 is a flow diagram showing the procedure for transforming an alignment for the purpose of defining SNPs that define a group of alleles rather than a single allele.

FIG. 13 is a flow diagram showing the procedure for identifying SNPs that both define a group of interest and discriminate the members of the group of interest from each other.

FIG. 14 is a flow diagram showing the “Defined sequence type/SNP-type” procedure for combining the results of SNP search procedures from several different loci.

FIG. 15 is a flow diagram showing the “Generalized/SNP-type” procedure for combining the results of SNP search procedures from several different loci.

FIG. 16 is a flow diagram showing the procedure for converting allele and sequence type data into a single alignment.

FIG. 17 is a flow diagram showing the procedure for extracting highly discriminatory alleles from sequence types: defined sequence type/complete method.

FIG. 18 is a flow diagram showing the procedure for determining the power of defined SNPs to discriminate multiple defined sequence types.

FIG. 19 is a schematic diagram of an alternative system for implementing the present invention.

FIG. 20 is a schematic diagram of the end station of FIG. 18.

FIG. 21 is a representation showing the truncated downstream region characteristic of community acquired MRSA and the binding sites of the primers. HVR: hypervariable region, dcs; downstream common sequence (Oliveira et al., Antimicrobiol Agents and Chemotherapy 44: 1906-1910, 2000; Huygens et al., J. Clin. Microbiol. 40: 3093-3097; 2002).

FIG. 22 is a photomicrograph showing electrophoresis of amplification products from genomic preparations of three MRSA community acquired isolates and one MRSA hospital acquired isolate. Lanes 1-3: community acquired isolate 1; lanes 4-6: community acquired isolate 2; lanes 7-9: community acquired isolate 3; lanes 10-12: hospital acquired isolate. Lanes marked M: molecular weight markers. In each set of three lanes, the first lane is the product primers mecA P1 and HVR P2, the second lane is the product of primers HVR P1 and MDV R5 and the third lane is the product of primers IS P4 and Ins117 R2.

### DETAILED DESCRIPTION OF THE INVENTION

The present invention provides a software program to identify and discriminate the sequence types in the form of informative single nucleotide polymorphisms (SNPs). The software takes a nucleotide sequence alignment as input and finds SNP sites that, when interrogated, provide maximal quantitative discriminatory power between the members of the alignment.

The program enables operators to perform two main functions, based on the way in which the discriminatory power is measured:—
(1) Defined Allele discrimination identifies a particular sequence. This involves defining one or more members of the alignment. The program then finds SNPs which discriminate that group of alignment members from the rest of the alignment members. In this case, the discriminatory powers of the alignment members are measured by percentage discrimination.
(2) Generalized discrimination reveals whether two sequences are the same or different. The program finds the SNPs which maximally discriminate between the members of the alignment. In this case, Simpson Index of Diversity measure is utilised to measure discrimination among the alignment members.

The instant software was developed using two approaches:—
(i) The SNP-type method. This is a two-stage process. The first step tests the SNP combinations against an allele profile database by converting each allele into a “type” or “SNP allele” defined by the SNPs only. In the second step, the results from the first stage are combined and used as the input for the calculation of the discriminatory power at the sequence type level; and
(ii) The Mega-alignment method. In mega-alignment, each strain is represented by a sequence formed by the concatenation of the genetic codes of the respective sevel allele sequences. This alignment is created in the program and is directly tested for the discrimination of strains in terms of SNPs.

The tasks of identification and discrimination of SNPs is quantified in two ways: (i) percentage discrimination; and (ii) Simpson index of diversity measure.

Percentage discrimination is used to determine a minimal set of SNPs that uniquely identify an allele at a locus or a strain in a Mega-alignment for “Specified Allele” and/or “Specified Strain” programs. The calculation of this is demonstrated for a hypothetical example shown below.

Consider, by way of example only, an alignment of eight alleles at some locus (Table 2), as an example.

TABLE 2

| | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| >Allele1 | A | C | G | T | A | C | G | T | A | C | G | A | C | G | T |
| >Allele2 | A | C | G | T | A | C | G | T | C | C | G | A | C | G | T |
| >Allele3 | A | C | G | T | A | C | G | T | G | C | G | A | C | C | T |
| >Allele4 | A | C | G | T | A | C | G | T | T | C | A | A | A | C | T |
| >Allele5 | A | C | G | T | A | C | G | C | A | A | A | T | A | C | T |
| >Allele6 | A | C | G | T | A | C | G | C | C | A | C | T | A | C | T |
| >Allele7 | A | C | G | T | A | C | G | C | G | G | C | T | A | C | T |
| >Allele8 | A | C | G | T | A | C | G | A | T | G | C | T | A | C | T |

First, for a selected allele, e.g. Allele 1, the number of other alleles (x in Table 3) are determined which share the same SNP value in the same column with the remaining number of alleles (seven in this example). Then the percentage discrimination is calculated by using the following formula, as shown in the example below for Allelel.

$$\begin{matrix}Percentage \\ Discrimination\end{matrix} = \frac{\{ \begin{matrix}( Total no . of alleles - 1 ) - \\ ( \begin{matrix}No . of alleles that share the same \\ SNP value in the same position\end{matrix} )\end{matrix} \} \times 100}{( Total no . of alleles - 1 )}$$

TABLE 3

| | SNP positions | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| x | 7 | 7 | 7 | 7 | 7 | 7 | 7 | 3 | 1 | 3 | 2 | 3 | 2 | 1 | 7 |
| (7 − x)/7 | 0/7 | 0/7 | 0/7 | 0/7 | 0/7 | 0/7 | 0/7 | 4/7 | 6/7 | 4/7 | 5/7 | 4/7 | 5/7 | 6/7 | 0/7 |
| Percentage | 0 | 0 | 0 | 0 | 0 | 0 | 0 | 57.1 | 85.7 | 57.1 | 71.4 | 57.1 | 71.4 | 85.7 | 0 |
| Discrimination | | | | | | | | | | | | | | | |

When more alleles share the same SNP value, then the percentage discrimination becomes less and vice versa.

In the above example, positions 9 and 14 are the most discriminatory SNPs with maximum 85.7% discrimination.

The second most discriminatory SNPs are determined by removing the alleles with unshared SNPs at position 9 with Allelel (Table 4), followed by calculation of % discrimination (Table 5) for the reduced Allele set.

TABLE 4

| | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| >Allele1 | A | C | G | T | A | C | G | T | A | C | G | A | C | G | T |
| >Allele5 | A | C | G | T | A | C | G | C | A | A | A | T | A | C | T |

Note that Allele1 is shown in Table 4 for clarity only.

TABLE 5

| | SNP positions | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| x | 1 | 1 | 1 | 1 | 1 | 1 | 1 | 0 | 1 | 0 | 0 | 0 | 0 | 0 | 1 |
| (1 − x)/1 | 0 | 0 | 0 | 0 | 0 | 0 | 0 | 1 | 0 | 1 | 1 | 1 | 1 | 1 | 0 |
| Percentage | 0 | 0 | 0 | 0 | 0 | 0 | 0 | 100 | 0 | 100 | 100 | 100 | 100 | 100 | 0 |
| Discrimination | | | | | | | | | | | | | | | |

The above sequential steps conclude that the following combinations will discriminate Allelel from the rest with 100% confidence. The combinations are given in Table 6.

TABLE 6

(1) 9: A, 85.7%; 8: T, 100.0%;
(2) 9: A, 85.7%; 10: C, 100.0%;
(3) 9: A, 85.7%; 11: G, 100.0%;
(4) 9: A, 85.7%; 12: A, 100.0%;
(5) 9: A, 85.7%; 13: C, 100.0%;
(6) 9: A, 85.7%; 14: G, 100.0%;

Similarly, by removing the alleles with unshared SNPs at position 14 with Allelel, and repeating the above steps gives the combination for maximum discrimination with 100% confidence as Table 7.

TABLE 7
(7) 14: G, 85.7%; 9: A, 100.0%;

In the example shown above, only 15 SNP positions for a set of eight alignments has been considered. The discrimination with 100% confidence was arrived with two recursive steps. However, in the case of mega-alignment, the number of SNPs and alignments will be in the order of thousands. Accordingly, the number of recursive steps in the discriminatory process would increase. Also, the minimum set of informative SNP combinations for the specific sequence identification would be more.

The algorithms adapted in the current software to do the above tasks are described below:—
Step 1: Load the required alignment—either allele file or mega-alignment.
Step 2: Select an alignment that needs to be analyzed (Allelel in the above example of Table 2). Remove and store the selected alignment separately.
Step 3: Calculate the percentage discrimination for the selected alignment (as described above in Table 3).
Step 4: Search for SNP set of positions corresponding to highest % discrimination (9 and 14 in the above example).
Step 5: For each SNP position in the above set, make a list of alignments that share the common SNP value with the selected one at this SNP position (as in Table 4). (This process involves the removal of alignments, which do not share SNP value at the selected SNP position). Make a record of the SNP positions and the list of these alignments.
Step 6: Recursively process steps 3 to 5 for each of the above reduced alignment list sequentially until 100% confidence is reached.
Step 7: Gather the most significant SNP combinations, store and display the results (Tables 6 and 7).

Simpson's Index of Diversity (D), based on probability theory, measures the likelihood of two strains selected from a particular population will give different results. The D value is given by

$$D = 1 - \frac{1}{N ( N - 1 )} {\sum }_{j = 1}^{s} {n}_{j} ( {n}_{j} - 1 )$$

where, N is the number of sequences in the alignment, s is the number of types defined by the typing procedure (i.e. the number of groups the alignment is divided into by interrogating polymorphic sites), and nⱼ is the number of sequences of the jth type (number of sequences having particular SNP value at a particular position).

Simpson Index is used to determine a minimal set of SNPs that uniquely discriminate allele populations at a locus or strain population in a mega-alignment for “generalized” programs. The calculation of Simpson Index for the hypothetical example discussed earlier is given below.

Considering one SNP position at a time (i.e. the selected column) for the same set of Alleles in Table 2, the D values are calculated as follows:

For the SNP position 8, the sequence can be divided into three groups, based on SNP values.

Applying the above formula for Simpson Index,
D=1−[{(4×3)+(3×2)+(1×0)}/(8×7)]=0.67

For the SNP position 9, the sequence can be divided into four groups of two members each.

Applying the above formula for Simpson Index,
D=1−[{(2×1)+(2×1)+(2×1)+(2×1)}/(8×7)]=0.85

For the SNP position 10, the sequence can be divided into three groups.

Applying the above formula for Simpson Index,
D=1−[{(4×3)+(2×1)+(2×1)}/(8×7)]=0.71

For the SNP position 11, the sequence can be divided into three groups.

Applying the above formula for Simpson Index,
D=1−[{(3×2)+(2×1)+(3×2)}/(8×7)]=0.75

For the SNP position 12, the sequence can be divided into two groups.

Applying the above formula for Simpson Index,
D=1−[{(4×3)+(4×3)}/(8×7)]=0.57

For the SNP position 13, the sequence can be divided into two groups.

Applying the above formula for Simpson Index,
D=1−[{(3×2)+(5×4)}/(8×7)]=0.53

For the SNP position 14, the sequence can be divided into two groups.

Applying the above formula for Simpson Index,
D=1−[{(2×1)+(6×5)}/(8×7)]=0.42

For the remaining positions (1 to 7 and 15),
D=1−[{(8×7)/(8×7)}]=0

Tabulating all the D values gives Table 8.

TABLE 8

| | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| Simpson | 0 | 0 | 0 | 0 | 0 | 0 | 0 | .67 | .85 | .71 | .75 | .57 | .53 | .42 | 0 |
| Index | | | | | | | | | | | | | | | |

Now, considering two SNP positions in combination at a time, the sequence can be divided into eight groups for the set 9 and 8. For this set, the D value is:
D=1−[{(1×0)+(1×0)+(1×0)+(1×0)+(1×0)+(1×0)+(1×0)+(1×0)}/(8×7)]=1

Similarly, for positions 9 and 10, 9 and 11 and 9 and 12, D=1.

TABLE 9

(1) 9: Simpson Index = 0.85, 10: Simpson Index = 1
(2) 9: Simpson Index = 0.85, 11: Simpson Index = 1
(3) 9: Simpson Index = 0.85, 12: Simpson Index = 1

A D value of 1 implies that these SNP combinations are highly informative and can be used to discriminate the whole set of allele population.

Again, in the example shown above, there are only 15 SNP positions for a set of eight alignments. However, in the case of mega-alignment, the number of SNPs and alignments will be in the order of thousands. Accordingly, the number of recursive steps in the discriminatory process is high. Also, the minimum set of informative SNP combinations for the specific sequence identification would be more.

The algorithms adapted in the current software to do the above tasks are described below:
Step 1: Load the required alignment—either allele file or mega-alignment (allele in the above example of Table 2).
Step 2: Calculate the Simpson index of diversity (D) for each of the SNP positions in the whole alignment (as shown in Table 8 in the above example).
Step 3: Search for SNP set of positions corresponding to highest D value (9 in Table 8 of the above example, with D=0.85). If this D value is 1, then stop the process. Otherwise proceed to the next step.
Step 4: For each selected SNP position in the above set, find other suitable SNP positions (such as 10, 11 and 12 in the above example), two in combination at a time with the selected one (position 9 in the above example), which gives high combined D value (as discussed for positions 9 and 10, etc. in the above example). If this D value is 1, then stop the process. Otherwise proceed to the next step.
Step 5: Repeat step 4 for combinations of three or more SNPs with the selected ones from the previous step, recursively, until the D value becomes 1 or any other required value.
Step 6: Gather the most significant SNP combinations, store and display the results. (Table 9).

Linked List is utilized to store the required data input, either at locus level or at sequence level, for an alignment. To perform the discrimination tasks, each SNP in the above stored alignment has several sub-segment SNPs connected to it. Therefore, a tree data structure is required to store the outcome of discrimination task at each iteration. In each node, vectors are utilised to store the computed data. The desired result is achieved by an automated tree building process. The results are retrieved from the tree by traversing from each leaf to the root of the tree. All these results are stored separately in Linked List data structure.

The main feature of the current program is an extension of a published program (Hunter and Gaston, J. Clin. Microbiol. 26: 2465-2456, 1988) in which two types of trees were employed: Allele Tree and Strain Tree. The Allele tree is used to identify the SNP sequence at locus level and the Strain tree is used to identify the strains in terms of strain profile, both using percentage discrimination measure.

The major focus of the present invention is the Allele tree and discrimination of sequence in terms of SNPs.

The software design develops an existing data structure, in Java programming environment, so that it allows the user to perform typing of informative bacterial SNPs at strain level. The main requirements are as follows:—
It is capable of loading an alignment, either at locus level or at sequence level.
It has an option for construction and loading of mega-alignment for a given MLST database of a selected species.
It has the option to perform the discrimination by percentage or Simpson Index diversity measures.
It displays all the results in the tex field, which can also be stored.

The MLST website is http://www.mlst.net/new/index.htm. Other information can be found in Maiden et al., Proc. Natl. Acad. Sci. USA 95: 3140-3145, 1998 and at http://Hw,w.mlst.net/new/misc/further_info.htm.

The Graphical User Interface (GUI) developed by Shilling (supra) was further extended and modified for the above purpose. In this GUI, all the functional tasks are event (menu and button) driven.

The GUI consists of the following object types: JMenuBar, JMenu, JMenuItem, JTextField, JLabel and JButton components. The important events are produced by clicking JmenuItem and JButton. All file related operations such as loading data files, and other Tools, View and About related operations are controlled by JmenuItems. The computational tasks are controlled by JButton objects. The JTextField displays the top and bottom text areas, showing the selected alignments and the computed results, respectively. The IdentitiyCheck text box also takes user input for data manipulation and analysis. The operation procedures for these objects are discussed in detail in below.

Considering the scope and analysis of the given problem, the classes needed to support the application are determined and the overall responsibilities for each class were delineated. The four groups of classes employed are shown in Table 10.

TABLE 10
Four groups of classes that support this application software

| Group 1 | Group 2 | Group 3 | Group 4 |
|---|---|---|---|
| GUI.java | Allele.java | Result.java | StrainList.java |
| Run.java | AlleleList.java | ResultVector.java | StrainSearch.java |
| AboutDialog.java | AlleleTree.java | Sort.java | StrainTree.java |
| | BuildAlleleTreeTask.java | SwingWorker.java | BuildStrainTreeTask.java |
| | PrimerDialog.java | MatchingPair.java | |
| | BindingAnalysis.java | FileAccess.java | |
| | BindingTask.java | LinkedList.java | |
| | MatchingBind.java | Node.java | |
| | OptionDialog.java | MessageDialog.java | |
| | | PrintReport.java | |

Group 1 initiates the program and develops the graphical user window. The function of Group 2 of classes is to do the task of typing of informative bacterial SNPs, either at locus level or at strain level. This group operates in conjunction with group 3. The classes in Group 3 are utilized for groups 2 and 4. The functional task of Group 4 is to bring about the typing of informative bacterial strains in terms of strain profile. This works in conjunction with group 3.

The scope of each of the above classes is described below.

Run.java: This is the main class and has the main method that executes the program. This class determines the resolution of the user's monitor and creates a new GUI object based on the screen size and resolution.

GUI.java: The Class GUI lays out all the graphical components for the user to interact with the program.

AboutDialog.java: This class is called from the GUI. It simply displays brief information about the program.

Allele.java: The class Allele forms the basic element that is stored in object AlleleList. The Allele is a container for an Allele ID (i.e. aroE1,) and the genetic code corresponding to that particular allele. Each Allele object has a reference to the previous as well as the next Allele in the AlleleList. The last Allele in the list has its next reference pointing to null, conversely, the first Allele in the list has its previous reference pointing to null.

AlleleList.java: This class contains a list of Allele objects. The Allele objects are created and organized into AlleleList while loading the allele sequence files to the program.

AlleleTree.java: The class AlleleTree defines the data structure necessary to describe an allele identification. The tree contains nodes that may have any number of children. Each node is of type ResultVector. Each node contains at least one object of type Result.

BuildAlleleTreeTask.java: This class uses SwingWorker to perform the construction of an AlleleTree.

BindingAnalysis.java: The BindingAnalysis class is used to create a binding report for a specified locus of alleles. It tells us if a certain primer will bind to an allele. The primer is tested with the entire locus of alleles.

BindingTask.java: This class uses SwingWorker to perform a BindingAnalysis task.

MatchingBind.java: This class is used in BindingAnalysis to store the number of mismatches between a primer and an allele. When a mismatch occurs it is stored in mismatchArray. The total number of mismatches is stored in numOfMismatches. The allele name that the primer is being bound to is stored in AlleleName.

OptionDialog.java: This creates a dialog window which is used to set computational options for allele identification.

PrimerDialog.java: PrimerDialog is used to scroll through existing primers or define a new one. The PrimerDialog is set up like a record set. A new primer may be added by entering the name of the primer, then typing in the genetic code for the primer. Each primer should have a unique name. Existing primers may be scrolled through by clicking next, previous, first or last etc.

Result.java: The Result is an object that is held in ResultVector. An Result stores the minimum count of matching SNP's for the specified list of allele keys (i.e. fumC1, fumC8, . . . ) or Simpson Index of Discrimination. The list of keys is stored in keyList. An ResultVector object may contain one to many Result objects. Each Result object has an owner, which is a ResultVector. Many Result objects may have the same owner. Also, if a Result object is not contained in a leaf, it will have a child of type ResultVector. Two or more Result objects may have the same child.

ResultVector.java: The ResultVector is the building block of the Tree data structure utilised in this program. It forms a node in a Tree.

Sort.java: This has class methods for sorting the data.

SwingWorker.java: This is the third version of SwingWorker (also known as SwingWorker 3), an abstract class that you subclass to perform GUI-related work in a dedicated thread. For instructions on using this class, see: http://iava.sun.com/docs/books/tutorial/uiswing/misc/threads.html It should be noted that the API changed slightly in the third version: a start( ) needs to be invoked on the SwingWorker after creating it.

MatchingPair.java: This stores Matching pair data, used by either AlleleTree or StrainTree. For example, MatchingPair (123, 7) means that there were seven matches against the selected allele for SNP site 123. This also stores Simpson Index of Discrimination in the case of AlleleTree.

FileAccess.java: This is used to write to or read from the text data files.

LinkedList.java: A LinkedList is a list of Node objects. A node may hold any type of object.

Node.java: The class Node forms the basic element that is stored in the LinkedList. The node is a container for a String value as well as an object. A node may be created using the constructor with a value associated with it. This value may be accessed using the getValue( ) or getObject( ) methods. Each node has a reference to the previous as well as the next node in the LinkedList. The last node in the list has its next reference pointing to null, conversely, the first node in the list has its previous reference pointing to null.

MessageDialog.java: This dialog is used to display error messages to the user. For example if the user enters text into a box that expects a number, a wrong type message will be displayed to the user.

PrintReport.java: Prints text to the selected printer. Lines are wrapped if they exceed the length of the page. This class object is called from GUI to print the contents of the report.

StrainList.java: This stores profile information about strains in the LinkedList while loading the strain profile file to the program.

StrainSearch.java: Stores information about a strain, searches and finds Matching Strain for given allele pool.

StrainTree.java: The class StrainTree defines the data structure necessary, to describe a strain identification. The tree contains nodes that may have any number of children. Each node is of type ResultVector. Each node contains at least one object of type Result.

BuildStrainTreeTask.java: This class uses SwingWorker to perform a StrainTree task.

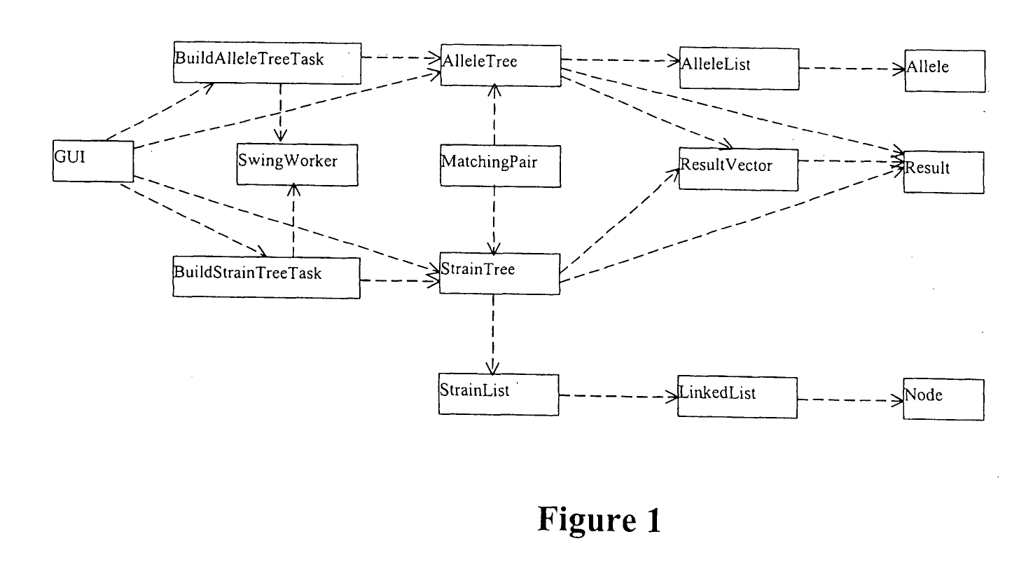

The Class diagrams for some of the critical classes in the program and their relations are shown in Tables 11 to 18 and in FIG. 1.

TABLE 11
Class diagram of GUI.java
GUI

−fileAccess: FileAccess
−displayDiversityMeasure: boolean
−trimmedMegaAlignment: AlleleList
−resTree: AlleleTree
−strainTree: StrainTree
−identificationTimer: Timer
−identificationTask: BuildAlleleTreeTask
−strainIdentificationTask: BuildStrainTreeTask
+displayAllele( )
+displayStrain( )
+getPercentage(v:Vector): double
+getSimilarAlleles(v:Vector): String
+writeReport(ls:LinkedList)
+writeOutput(ls:LinkedList)
+loadAlleles( )
+addCustomReport( )
+getIndexOfDiversity(v:Vector): double
+computeIndexOfDiversity(v:Vector, allelePopulationSize:
double): double
+acceptTestProfile( ):String
+getSimilarProfileAlleles(v:Vector): String
+acceptAlleles( )
+loadAllelePool(testProfile:String, allelesSet: Vector,
newAlleleName: String)
+displaySimilarST( )
+makeMegaAllignmentList( )
+setMegaAllignmentList( )
+addIdentificationTimer( )
+addStrainIdentificationTimer( )
+actionPerformed(ActionEvent evt)

TABLE 12
Class diagram of Allele.java
Allele

−nextNode: Allele
−previousNode: Allele
−id: String
−code:String
+Allele ( )
+setID(i:String)
+setCode(c:String)
+appendCode(c:String)
+getCode( ):String
+getCodeLength( ):int
+getID( ): String
+setNext(a:Allele)
+setPrevious(on:Allele)
+getNext( ):Allele
+getPrevious( ):Allele

TABLE 13
Class diagram of AlleleList.java
AlleleList

−headNode: Allele
−tempPointer: Allele
−lastNode: Allele
−size: int
−megaAlignmentProfile: String
+AlleleList ( )
+getHeadNode( ): Allele
+countAllele(data:String, id:String): int
+loadList(data:String, identifier:String): LinkedList
+removeCarriageReturns(s:String): String
+insert(n:Allele)
+find(key:String): Allele
+getIndex(key:String): int
+getAlleleCode(index:int): String
+getAllele(key:String): Allele
+getAlleleCode(key:String): String
+getCodeLength( ): int
+getLocusName( ): String
+setMegaProfile(profile:String)
+appendMegaProfile(profile:String)
+getMegaProfile( ): String
+remove (key:String)
+countList( ): int
+getSize( ): int

TABLE 14
Class diagram of AlleleTree.java
AlleleTree

−headNode: ResultVector = null
−tempNode: ResultVector = null
−currentRes: Result = null
−alleleCode: String
−alleleList: AlleleList
−keyList: LinkedList
−SNPMatrix:char[ ][ ]
−resultID: int
−gui: GUI
−isComplete: boolean
−abort: boolean = false
−realMegaAlignmentActive: boolean
+AlleleTree(s:String, alleleList:AlleleList, keyList:LinkedList)
+setMegLociProfile(lociOrderColunmValue:String)
+buildTree( )
+add(rv:ResultVector)
+complete( ):boolean
+abortCalc( )
+traverse(node:ResultVector)
+createMinSumMatchingPairArray(ls:LinkedList): MatchingPair[ ]
+makeSimpsonIndexMatchingPairArray( ):MatchingPair[ ]
+isLeaf(rv:ResultVector): boolean
+getConfidence(rv:ResultVector): double
+getPercentage(v:Vector): double
+getIndexOfDiversity(v:Vector): double
+createIDReport( ): LinkedList

TABLE 15
Class diagram of Result.java
Result

−keyList: LinkedList
−child: ResultVector
−owner: ResultVector
−minCount: int
−columnNum: int
−discrimination: double
−resultID: int
+Result (colNum: int, minCnt: int, list:LinkedList)
+setID(I:int)
+getID( ): int
+getColumnNum( ): int
+getPairCount( ):int
+getDiscrimination( ): double
+setDiscrimination(discrimination: double)
+getList( ):LinkedList
+print( )
+toString( ): String
+setChild(rv:ResultVector)
+getChild( ): ResultVector
+setOwner(rv:ResultVector)
+getOwner( ):ResultVector

TABLE 16
Class diagram of ResultVector.java
ResultVector

−Depth: int = −1
−ResultVector: Vector = new Vector( )
−parent: Result
−rvID: int = −1
−leaf: boolean = false
+ResultVector( )
+setParent(r:Result)
+getParent( ):Result
+add(res:Result)
+setDepth(d:int)
+getDepth( ): int
+print( )
+toString( ):String
+get(int i): Result
+size( ): int
+setID(i:int)
+getID( ): int
+setAsLeaf(tORf:boolean)
+isLeaf( ):boolean

TABLE 17
Class diagram of MatchingPair.java
MatchingPair

−columned:int
−matchingPairCount: int
−double simpsonIndex
+MatchingPair (x:int, x:int)
+getColumnNum( ):int
+getMatchingPairCount( ): int
+increment( )
+toString( ): String
+setSimpsonIndex(diversity: double)
+getSimpsonIndex( ):double

TABLE 18
Class diagram of StrainList.java
StrainList

Strains: LinkedList
Gui: GUI
loadStrainFile( ): String
loadStrainList(s:String)
getStrainList( ):LinkedList
getHeadingList( ):LinkedList
getKeyList(selection:String):LinkedList
width( ):int
find(selection:String):LinkedList

TABLE 19
Class diagram of StrainTree.java
StrainTree

−headNode: ResultVector = null
−tempNode: ResultVector = null
−currentRes: Result = null
−leafContainer: Vector = new Vector( )
−select: String
−selectStrain: LinkedList
−strainList: StrainList
−keyList: LinkedList
−matchMatrix: char[ ][ ]
−timeout: long = 30000
−lastLeafTime: long
−timedOut: boolean = false
−isComplete: boolean
−abort: boolean = false
+StrainTree(s:String, strainList:StrainList, keyList:LinkedList)
+ getIDReport( ):LinkedList
+setStartTime(l:long)
+setTimeOut(l:long)
+buildTree( )
+add(rv:ResultVector)
+complete( ):boolean
+abortCalc( )
+traverse(node:ResultVector)
+getNextList( ):LinkedList
+createMinSumMatchingPairArray(ls:LinkedList):MatchingPair[ ]
+boolean empty( )
+getNumOfResults( ):int
+get (colNum:int, list:LinkedList):String

The main functional task of this program lies in the quantification of discrimination and storing these data in a hierarchial order. A special kind of tree data structure is required to instantaneously store the outcome of discrimination task at each iteration. The tree building process is automated until desired result is achieved. The AlleleTree and StrainTree perform this job. Traversing from each leaf to the root gives the final result.

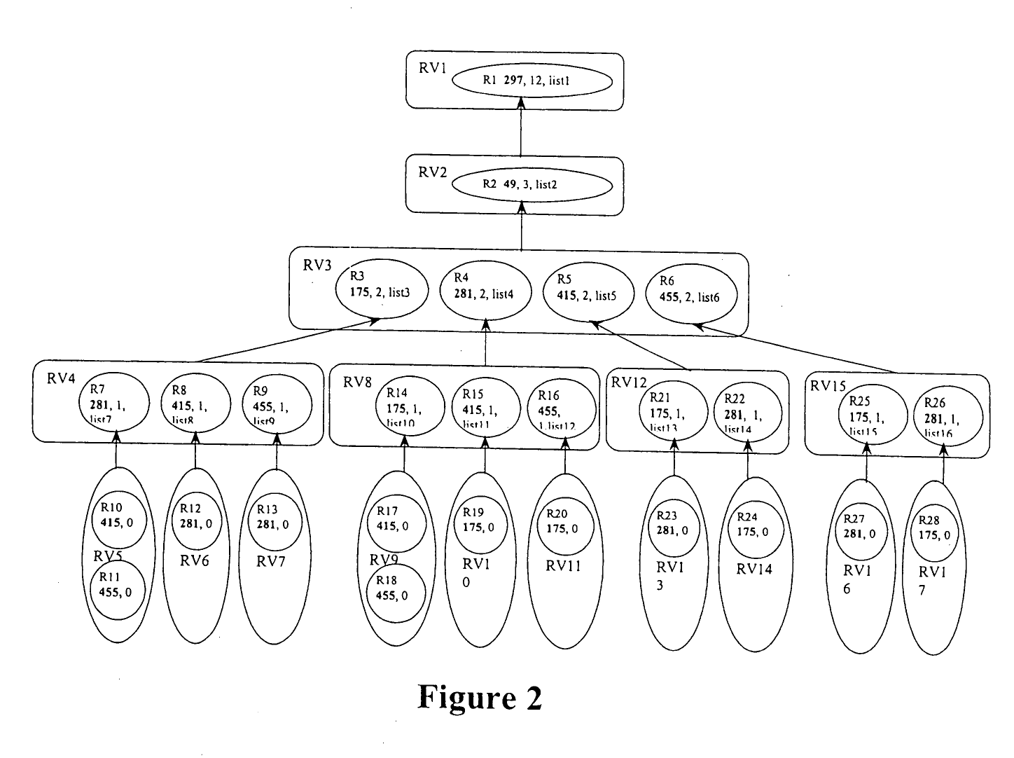

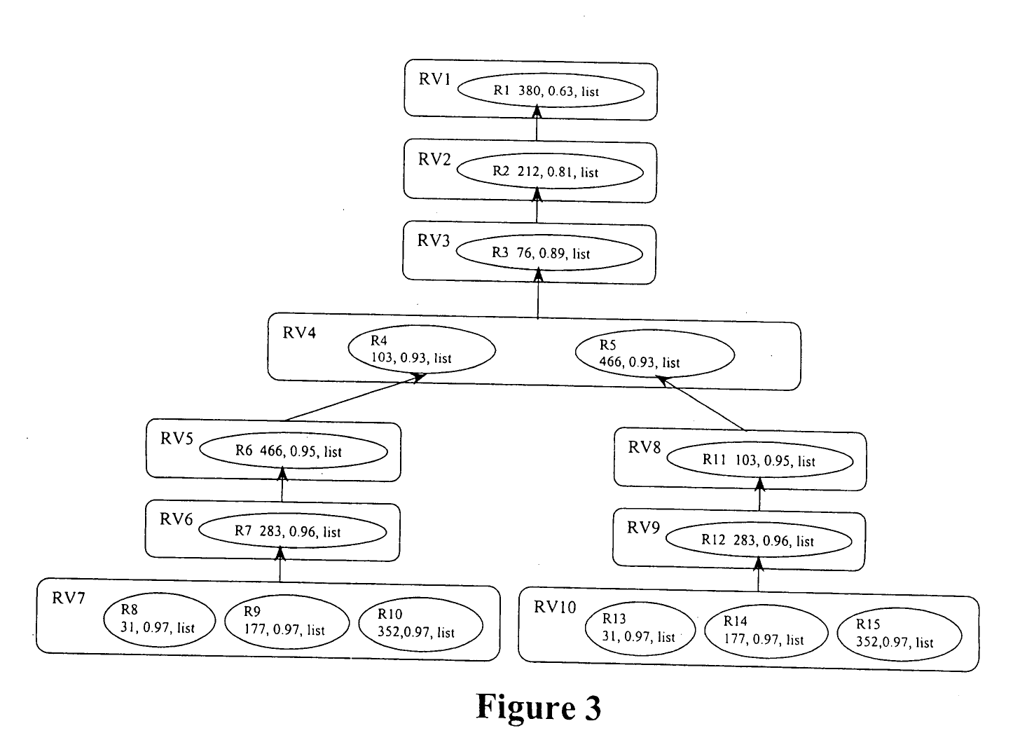

The function of an AlleleTree is described further below, by considering aroE as an example. AlleleTrees are shown in FIGS. 2 and 3, for defined allele and generalised methods, respectively.

In FIG. 2, each node of the tree is created based on the algorithm and is represented by a vector type object called ResultVector(RV). A ResultVector is created at each iteration of tree building process. It contains the set of Result objects (denoted as R). The number of Result objects created in the set is equal to the sorted number of SNP sites with the same highest discriminatory value. Each Result object has the most discriminatory SNP for every SNP site created, the size of the key list or Simpson Index of discrimination value and a key list of AlleleSet that shares most discriminatory SNP value at that SNP position. Each ResultVector, except the root node, is connected to a Result as its parent. Similarly, all Results, except in the leaf node, has ResultVector as its child.

The sorted key list referred to, in FIG. 2, is noted below:
list1: aroE-7, aroE-8, aroE-12, aroE-77, aroE-108, aroE-119, aroE-134, aroE-141, aroE-171, aroE-189, aroE-190, aroE-198.
list2: aroE-171, aroE-189, aroE-198.
list3: aroE-189, aroE-198.
list4: aroE-171, aroE-198.
list5: aroE-171, aroE-189.
list6: aroE-171, aroE-189.
list7: aroE-198.
list8: aroE-189.
list9: aroE-189.
list10: aroE-171.
list11: aroE-171.
list12: aroE-171.
list13: aroE-189.
list14: aroE-189.
list15: aroE-171.
list16: aroE-171.

The bottom most nodes, called the Leaf Nodes, are added to the leaf container, which is an object of Vector type. The leaf container keeps track of all leaves and is used to read the tree after it has been fully constructed. Allele identifications are obtained by traversing from each leaf to the root via the shortest path and collecting the data from the Result object in the path. The number of results is equal to the number of Result objects in the leaf container.

The tree building process has some constraints, such as, Time Out, Maximum Number of Results, Percentage of Confidence or Simpson Index Limit, etc. Due to the nature of the identification algorithm and under certain constraints, the program is not able to calculate any answers. If this condition occurs, the program automatically stops executing. Clicking the Abort button also terminates the tree construction process.

Allele identification for a particular set of SNP sites is manually obtained without constructing an AlleleTree, by typing comma separated SNP sites in the Identity Check Text Box and clicking the Add button (see Table 19 for details). In this case, alleles, which share the same SNP values at the given SNP sites, are sequentially sorted by using discriminatory measures and displayed by the GUI class.

The GUI.java class supports some of the functional task involving user-assisted two-stage processes, such as, Multi Locus Defined Allele Program, Abbreviated “SNP Alleles” Alignment Construction and Mega Alignment Construction.

In the case of Multi Locus Defined Allele Program, sets of alleles corresponding to each locus are collected based on the user's SNP site requirements in the first stage. Vector objects are utilized for storing this data. At the second stage, Strain Profile file are loaded and sequentially sorted by removing the strain that do not share above collected allele pool. The StrainSearch:java class performs sorting operation with this GUI class. These sorted ST set along with the user's SNP sites at various loci will be displayed in the final output.

Both Abbreviated “SNP Alleles” Alignment Construction and Mega-Alignment Construction are functionally similar methods. In the first stage, alleles corresponding to selected loci with full or abbreviated allele codes are stored in a LinkedList object. In the second stage, Strain Profile file is loaded and a new allele list, of size equal to the number of strains, is created only with Allele IDs having the same strain IDs. This newly created allele list is utilized for Mega-Alignment repository. Mapping the Strain Profile with the respective allele codes collected from the first stage creates set of allele codes for each strain. These codes are concatenated according to the order of the loci and stored.

The construction of StrainTree is very similar to that of AlleleTree, but it only incorporates the percentage discrimination.

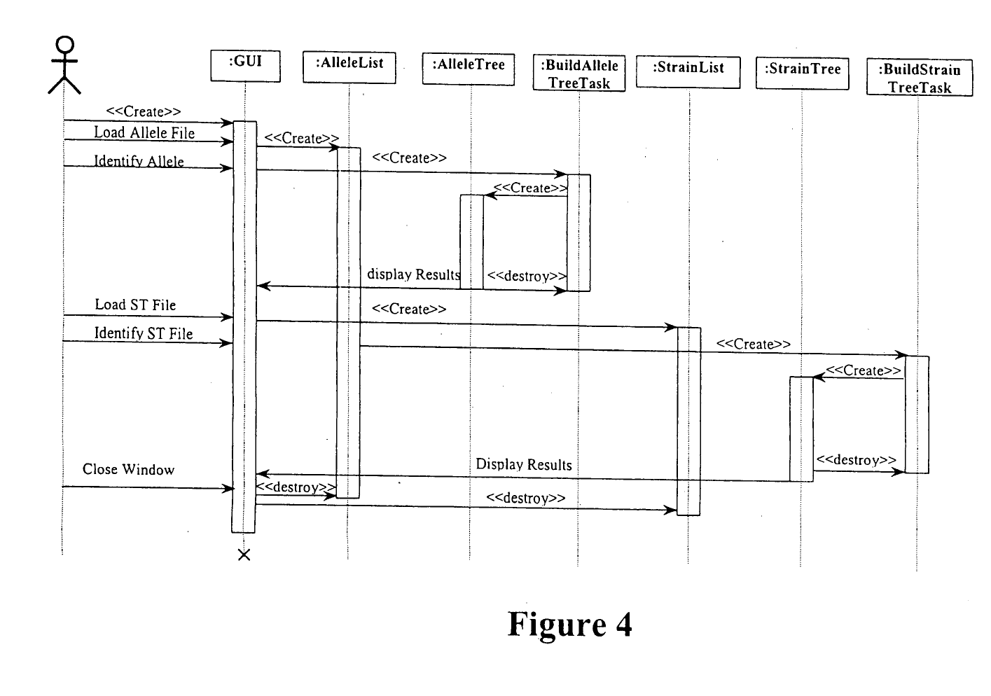

The Object Interaction diagram indicating the ways the program executes the main tasks is shown in FIG. 4.

The multi-locus sequence typing (MLST) databases for the required bacteria are to be downloaded from www.mlst.net. As a model example, for Neisseria meningitidis the database provides the following allele sequence files in FASTA format (*.tfa.txt). The allelic profile (or strain) file, which is in tab-delimited text format (profiles.txt), is downloaded from http://neisseria.org/nm/typing/mlst/profiles/profiles.txt.
abcZ.tfa.txt
adk_*tfa.txt
aroE.tfa.txt
fumC.tfa.txt
gdh_.tfa.txt
pdhC.tfa.txt
pgm_.tfa.txt
profiles.txt

An example of a part of an allele file (showing the first two alleles of aroE) is shown in Table 20. The allele sequence files consists of an identifier for an allele (e.g. >aroE-1) followed by the genetic code of the allele.

TABLE 20
aroE.tfa.text

| | |
|---|---|
| aroE-1 | |
| ATCGGTTTGGCCAACGACATCACGCAGGTCAAAAACATTGCCATCGAAGGCAAAACCAT | [SEQ ID NO: 1] |
| TTGCTTTTGGGCGCGGGCGGCGCGGTGCGCGGCGTGATTCCTGTTTTGAAAGAACACCG | |
| CCTGCCCGTATCGTCATTGCCAACCGCACCCACGCCAAAGCCGAAGAATTGGCGCGGCT | |
| TTCGGCATTGAAGCCGTCCCGATGGCGGATGTGAACGGCGGTTTTGATATCATCATCAA | |
| GGCACGTCCGGCGGCTTGAGCGGTCAGCTTCCTGCCGTCAGTCCTGAAATTTTCCTCGG | |
| TGCCGCCTTGCCTACGATATGGTTTACGGCGACGCGGCGCAGGAGTTTTTGAACTTTGC | |
| CAAAGCAACGGTGCGGCCGAAGTTTCAGACGGACTGGGTATGCTGGTCGGTCAAGCGGC | |
| GCTTCCTACGCCCTCTGGCGCGGATTTACGCCCGATATCCGCCCTGTTATCGAATACAT | |
| AAAGCCATG | |
| aroE-2 | |
| TATCGGTTTGACCAACGACATCACGCAGGTCAAAAATATTGCCATCGAGGGCAAAACCAT | [SEQ ID NO: 2] |
| TTTGCTTTTGGGCGCAGGCGGCGCGGTGCGCGGCGTGATTCCTGTTTTGAAAGAACACCG | |
| TCCTGCCCGTATCGTCATTGCCAACCGTACCCGCGCCAAAGCCGAGGAATTGGCGCAGCT | |
| TTTCGGCATTGAAGCCGTCCCGATGGCGGATGTGAACGGCGGTTTTGATATCATCATCAA | |
| CGGCACGTCGGGCGGTCTAAACGGTCAGATTCCCGATATTCCGCCCGATATTTTTCAAAA | |
| CTGCGCGCTTGCCTACGATATGGTGTACGGCTGCGCGGCAAAACCGTTTTTAGATTTTGC | |
| ACGACAATCGGGTGCGAAAAAAACTGCCGACGGACTGGGTATGCTAGTCGGTCAAGCGGC | |
| GGCTTCCTACGCCCTCTGGCGCGGATTTACGCCCGATATCCGCCCCGTTATCGAATACAT | |
| GAAAGCCCTA | |

On down loading the allelic profile (or strain) file (profile.txt), the data can be seen using the Word Pad or Note Pad. An example of this text file showing the first three strains is shown in Table 21.

TABLE 21
Profiles.txt
File generated Sun Oct 20 02:45:00 2002

| ST | abcZ | adk_{—} | aroE | fumC | gdh_{—} | pdhC | pgm_{—} | clonal | complex |
|---|---|---|---|---|---|---|---|---|---|
| 1 | 1 | 3 | 1 | 1 | 1 | 1 | 3 | ST-1 | complex/subgroup I/II |
| 2 | 1 | 3 | 4 | 7 | 1 | 1 | 3 | ST-1 | complex/subgroup I/II |
| 3 | 1 | 3 | 1 | 1 | 1 | 23 | 13 | ST-1 | complex/subgroup I/II |

The strain file consists of the alleles corresponding to the seven loci for each of the known strains of Neisseria meningitidis. For example, the seven loci labels for strain 1 (ST1) are abcZ1, adk3, aroE1, fumC1, gdh1, pdhC1, pgm3.

In MS-DOS command prompt or the Unix shell prompt, type “javac Run.java” for compilation. To execute, type “java Run” at the command prompts.

For MS-DOS prompt the compilation and execution is also directly performed by double clicking the three batch files: compileRun.bat, manifest.bat, and Run.bat, in this order, consecutively.

Instead of Run.bat file, the program can also be executed by double clicking on the executable MLST.jar file.

On execution, the program opens up the initial Graphic User Interface window. There are two main text areas in the Window, a smaller one at the top and a larger one down the bottom. The text area located at the top of the screen is used to display the genetic code of selected alleles or the alleles that make up a strain. The bottom text area is used for displaying reports or results.

To load an allele file, select File Load Allele File from the main menu of the program. After an allele file has been loaded for the first time a reference to this file is placed in File |Alleles for quick access the next time the file is required.

When an allele file has been loaded, the allele combo box is filled with all the identifiers for the particular locus that was loaded.

An allele may be selected from the combo box to change the current allele. Alternatively, pressing the F1 key moves to the previous allele, and pressing F2 moves to the next allele in the list. This may be useful if the user wants to check how a particular SNP site changes as the alleles are scrolled through in either direction. The cursor stays in the same position when alleles are displayed using F1 or F2. The position text box tells the user what SNP position the user is currently on. For example, if the position box reads 245, the SNP position directly before the cursor is 245.

The “%” and “D” buttons denote the required mode of discrimination: either Percentage (%) or D for Simpson Index, as discussed below. By default, the % button is selected at the beginning of the program.

After selecting an allele for analysis, ensure that the % button is selected. Clicking the Identify Allele button produces an identification that is reported to the bottom text area. At any time, the calculation is aborted by clicking on the Abort Calc button. This also applies to strain and binding calculations. Once a report has been created, it can be either saved to a text file or printed to a printer. The Result Count text box displays how many results were produced for the particular allele identification.

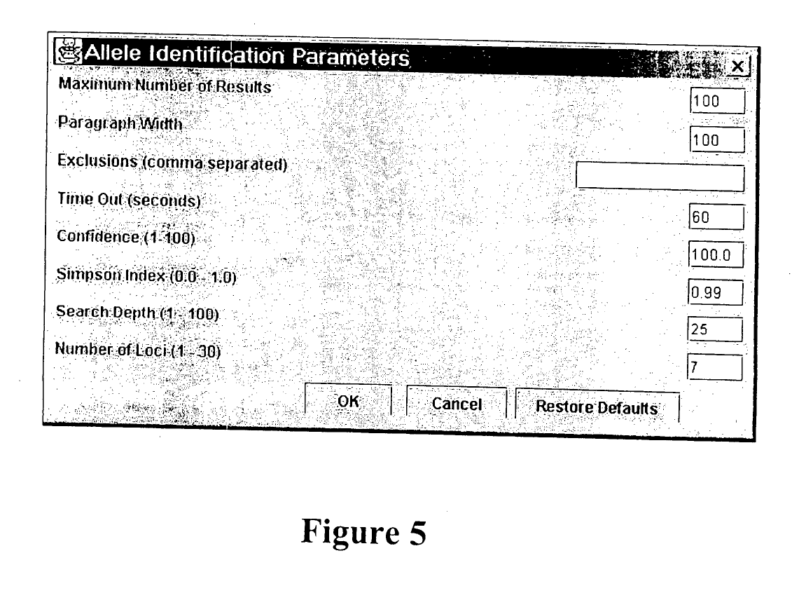

A number of constraints may be placed on allele identification. The constraints are set by selecting Tools|Allele Options from the top menu. This displays another window where these settings can be entered. The Allele options window is shown in FIG. 5.

The descriptions of the various parameters are:
(1) Maximum Number of Results: This specifies the maximum number of results that will be produced for a particular allele identification. Some allele identifications may produce thousands of results and this may need to be limited.
(2) Paragraph Width: This specifies the paragraph width of the displayed allele in characters.
(3) Exclusions: Certain SNP positions are known not to bind well to a primer. Due to this, it may be desirable to remove these SNPs from an answer. Exclusions are entered as comma separated values. For example, to remove sites 22 and 422 from an identification, 22,422 is typed in the exclusions text box.
(4) Time Out: Specifies how long the program will attempt to produce a result in seconds. For example, if allele abcZ10 is analyzed, SNP 411 could be excluded from the result to keep the confidence at 100%. In this scenario, the program will time out after the specified timer interval and produce no results.
(5) Confidence level: This is a percentage ranging between 1 and 100. The confidence level refers to the degree of certainty that a produced identification will actually identify the allele. For example, a 100% confidence produces identifications that are sure to identify the selected allele and only the selected allele. An 80% confidence produces results with a total confidence of at least 80%, and an operator can be sure that each identification distinguishes the selected allele from 80% of all alleles. That is, the other 20% of alleles in the locus share the same identification.
(6) Simpson Index: This is used for the “generalized” programs. It measures the discriminatory power of a SNP position or a set of SNP positions in a given locus (alignment) or in a mega-alignment (strain level). Its value ranges from 0 to 1.
(7) Search Depth: This is utilised to obtain the most discriminatory results for a required number of best SNP combinations and varies from 1 to 100.
(8) Number of Loci: This is the number of given alignments for the strain of interest. For Neisseria meningitidis this number is seven.

A sample report output for aroE-1 allele identification is given in Table 22.

TABLE 22
Report output for aroE-1 allele identification

| | |
|---|---|
| >aroE-1 Results: | |
| >aroE-1 | |
| TATCGGTTTGGCCAACGACATCACGCAGGTCAAAAACATTGCCATCGAAGGCAAAACCAT | [SEQ ID NO: 3] |
| CTTGCTTTTGGGCGCGGGCGGCGCGGTGCGCGGCGTGATT | |
| CCTGTTTTGAAAGAACACCGTCCTGCCCGTATCGTCATTGCCAACCGCACCCACGCCAAA | |
| GCCGAAGAATTGGCGCGGCTTTTCGGCATTGAAGCCGTCC | |
| CGATGGCGGATGTGAACGGCGGTTTTGATATCATCATCAACGGCACGTCCGGCGGCTTGA | |
| GCGGTCAGCTTCCTGCCGTCAGTCCTGAAATTTTCCTCGG | |
| CTGCCGCCTTGCCTACGATATGGTTTACGGCGACGCGGCGCAGGAGTTTTTGAACTTTGC | |
| CCAAAGCAACGGTGCGGCCGAAGTTTCAGACGGACTGGGT | |
| ATGCTGGTCGGTCAAGCGGCGGCTTCCTACGCCCTCTGGCGCGGATTTACGCCCGATATC | |
| CGCCCTGTTATCGAATACATGAAAGCCATG | |
| <Identification Constraints> | |
| Time Out: 60 seconds. | |
| Confidence: 100.0%. | |
| Maximum Number of Results: 100. | |
| Excluded SNP's: None. | |

| | |
|---|---|
| (1) | 297: T, 94.2%; 49: A, 98.5%; 175: G, 99.0%; 281: A, 99.5%; 415: A, 100.0%; |
| (2) | 297: T, 94.2%; 49: A, 98.5%; 175: G, 99.0%; 281: A, 99.5%; 455: G, 100.0%; |
| (3) | 297: T, 94.2%; 49: A, 98.5%; 175: G, 99.0%; 415: A, 99.5%; 281: A, 100.0%; |
| (4) | 297: T, 94.2%; 49: A, 98.5%; 175: G, 99.0%; 455: G, 99.5%; 281: A, 100.0%; |
| (5) | 297: T, 94.2%; 49: A, 98.5%; 281: A, 99.0%; 175: G, 99.5%; 415: A, 100.0%; |
| (6) | 297: T, 94.2%; 49: A, 98.5%; 281: A, 99.0%; 175: G, 99.5%; 455: G, 100.0%; |
| (7) | 297: T, 94.2%; 49: A, 98.5%; 281: A, 99.0%; 415: A, 99.5%; 175: G, 100.0%; |
| (8) | 297: T, 94.2%; 49: A, 98.5%; 281: A, 99.0%; 455: G, 99.5%; 175: G, 100.0%; |
| (9) | 297: T, 94.2%; 49: A, 98.5%; 415: A, 99.0%; 175: G, 99.5%; 281: A, 100.0%; |
| (10) | 297: T, 94.2%; 49: A, 98.5%; 415: A, 99.0%; 281: A, 99.5%; 175: G, 100.0%; |
| (11) | 297: T, 94.2%; 49: A, 98.5%; 455: G, 99.0%; 175: G, 99.5%; 281: A, 100.0%; |
| (12) | 297: T, 94.2%; 49: A, 98.5%; 455: G, 99.0%; 281: A, 99.5%; 175: G, 100.0%; |

There is one more additional feature for allele identification. Entering comma separated SNP positions into the Identity Check text box of the main window produce a confidence for the combination of SNPs entered. Click Add or press Enter after the values have been entered. For example, when >aroE-1 is selected, entering 297, 49, 175 into the Identity Check text box produces the report shown in Table 23.

TABLE 23

Identity Check: >aroE-1
297: T, 94.2%; 49: A, 98.5%; 175: G, 99.0%;
Alleles that share the same profile:
>aroE-1, >aroE-189, >aroE-198

The required allele file is loaded using file menu (e.g. aroE.tfa.txt). Under Tools menu bar select Allele Options that brings Allele Identification Parameters dialog window. Set Simpson Index value, Search Depth, Time Out, and Maximum Number of Results and click the “OK” button.

Select and Click the D option button and then click Identify Allele button. The computed output of SNP positions at various combinations along with respective Simpson Index converges to value 1. This output displays maximum discriminatory values in generalized terms at locus level.

A typical test output for the alignment aroE is shown in Table 24.

TABLE 24
A typical test output for the alignment of aroE

Diversity Measure Results:
<Identification Constraints>
Time Out: 180 seconds.
Simpson Index: 0.99.
Maximum Number of Results: 10.
Excluded SNP's: None.
(1) 380: Index = 0.63; 212: Index = 0.81; 76: Index = 0.89; 103: Index = 0.93; 466: Index = 0.95;
283: Index = 0.96; 31: Index = 0.97; 352: Index = 0.97; 11: Index = 0.98; 389: Index = 0.98;
406: Index = 0.98; 431: Index = 0.98; 488: Index = 0.98; 37: Index = 0.98; 44: Index = 0.99;
(2) 380: Index = 0.63; 212: Index = 0.81; 76: Index = 0.89; 103: Index = 0.93; 466: Index = 0.95;
283: Index = 0.96; 31: Index = 0.97; 352: Index = 0.97; 11: Index = 0.98; 389: Index = 0.98;
406: Index = 0.98; 431: Index = 0.98; 488: Index = 0.98; 37: Index = 0.98; 88: Index = 0.99;
(3) 380: Index = 0.63; 212: Index = 0.81; 76: Index = 0.89; 103: Index = 0.93; 466: Index = 0.95;
283: Index = 0.96; 31: Index = 0.97; 352: Index = 0.97; 11: Index = 0.98; 389: Index = 0.98;
406: Index = 0.98; 431: Index = 0.98; 488: Index = 0.98; 37: Index = 0.98; 185: Index = 0.99;
(4) 380: Index = 0.63; 212: Index = 0.81; 76: Index = 0.89; 103: Index = 0.93; 466: Index = 0.95;
283: Index = 0.96; 31: Index = 0.97; 352: Index = 0.97; 11: Index = 0.98; 389: Index = 0.98;
406: Index = 0.98; 431: Index = 0.98; 488: Index = 0.98; 37: Index = 0.98; 207: Index = 0.99;
(5) 380: Index = 0.63; 212: Index = 0.81; 76: Index = 0.89; 103: Index = 0.93; 466: Index = 0.95;
283: Index = 0.96; 31: Index = 0.97; 352: Index = 0.97; 11: Index = 0.98; 389: Index = 0.98;
406: Index = 0.98; 431: Index = 0.98; 488: Index = 0.98; 37: Index = 0.98; 210: Index = 0.99;
(6) 380: Index = 0.63; 212: Index = 0.81; 76: Index = 0.89; 103: Index = 0.93; 466: Index = 0.95;
283: Index = 0.96; 31: Index = 0.97; 352: Index = 0.97; 11: Index = 0.98; 389: Index = 0.98;
406: Index = 0.98; 431: Index = 0.98; 488: Index = 0.98; 37: Index = 0.98; 211: Index = 0.99;
(7) 380: Index = 0.63; 212: Index = 0.81; 76: Index = 0.89; 103: Index = 0.93; 466: Index = 0.95;
283: Index = 0.96; 31: Index = 0.97; 352: Index = 0.97; 11: Index = 0.98; 389: Index = 0.98;
406: Index = 0.98; 431: Index = 0.98; 488: Index = 0.98; 37: Index = 0.98; 376: Index = 0.99;
(8) 380: Index = 0.63; 212: Index = 0.81; 76: Index = 0.89; 103: Index = 0.93; 466: Index = 0.95;
283: Index = 0.96; 31: Index = 0.97; 352: Index = 0.97; 11: Index = 0.98; 389: Index = 0.98;
406: Index = 0.98; 431: Index = 0.98; 488: Index = 0.98; 37: Index = 0.98; 455: Index = 0.99;
(9) 380: Index = 0.63; 212: Index = 0.81; 76: Index = 0.89; 103: Index = 0.93; 466: Index = 0.95;
283: Index = 0.96; 31: Index = 0.97; 352: Index = 0.97; 11: Index = 0.98; 389: Index = 0.98;
406: Index = 0.98; 431: Index = 0.98; 488: Index = 0.98; 41: Index = 0.98; 1: Index = 0.98;
(10) 380: Index = 0.63; 212: Index = 0.81; 76: Index = 0.89; 103: Index = 0.93; 466: Index = 0.95;
283: Index = 0.96; 31: Index = 0.97; 352: Index = 0.97; 11: Index = 0.98; 389: Index = 0.98;
406: Index = 0.98; 431: Index = 0.98; 488: Index = 0.98; 41: Index = 0.98; 2: Index = 0.98;

Similar to percentage discrimination, even for generalized discrimination, entering comma separated SNP positions into the Identity Check text box of the main window produce a confidence for the specific allele. Click Add or press Enter after the values have been entered. The output identifies individual allele in terms of “D” (Simpson Index) value.

For example, when >aroE-1 is selected, entering 380, 212, 76, 103, 466 into the Identity Check text box will produce the following report shown in Table 25.

TABLE 25
Identity Check: >aroE-1
380: G, Index = 0.63; 212: G, Index = 0.81; 76: G, Index = 0.89; 103:
T, Index = 0.93; 466: T, Index = 0.95;
Alleles that share the same profile:
>aroE-1, >aroE-108, >aroE-110, >aroE-171, >aroE-189, >aroE-198

To produce a unique identification for a strain, load the allelic profile file (profile.txt) by selecting File|Load ST File. When a strain file has been loaded, the strain combo box is filled with all the identifiers for the particular strain that was loaded.

The Identify ST button may be clicked to identify the currently selected strain. As with the alleles, pressing F1 or F2 after placing the cursor in the top text area will move backward or forward through the strains. Although there are no constraints that may be placed on the calculation, yet the computation is based on percentage discrimination with 100% confidence limit.

An example of strain identification for ST 8 is given in Table 26.

TABLE 26
Strain Identification for ST 8
(1) adk_3, aroE7, fumC2, gdh_8, pdhC5

The multi-locus defined allele program is activated as follows:—
1. Pess Start button.
2. Load the required allele file using File|Load Allele File (e.g. aroE.tfa.txt).
3. Select the required allele of interest at that locus and enter the required set of SNP positions in the Identity Check box.
4. Click Add to find out which alleles are the same as the selected one at the defined SNP position profiles.
5. Click the Insert button to have the program automatically provide the appropriate SNP profile in the text box between the Start and Accept buttons. Alternatively, one can manually provide the desired SNP profile in this text box (instead of steps 3 and 4). For each locus, all possible SNP profiles are entered in a single step.
6. Click the Accept button to lock-in the defined SNP profile for the selected locus.
7. Repeat steps 2 to 6 to define the properties of any other loci of interest to be included in the analyses or to redefine a locus that had previously been defined. When all the needed loci have been defined, continue to step 8.
8. Click Finish, which brings up a dialogue that allows you to select the required ST file. Select the ST file as appropriate. This will bring the set of indistinguishable Strains that share the same defined SNP profile at different loci, in the Report text area.

The following example shows the result (in Table 27) for the selected alleles >abcZ-2, >adk_-3, >aroE-7 and >pdhC-5. The defined SNP positions for these alleles are:
342, 27, 28, 367, 141 for >abcZ-2,
216, 21, 189, 135, 285 for >adk_-3,
137, 46, 250 for >aroE-7,

42, 271 for >pdhC-5.

TABLE 27
Alleles that share the same profile at each selected locus are as follows:
342: T, 27: T, 28: G, 367: T, 141: G,
>abcZ-2, >abcZ-21, >abcZ-50, >abcZ-93, >abcZ-150,
>abcZ-154: of confidence 96.9%
216: T, 21: C, 189: C, 135: A, 285: T,
>adk_-1, >adk_-3, >adk_-12, >adk_-14, >adk_-21, >adk_-24,
>adk_-60, >adk_-64, >adk_-67,
>adk_-80, >adk_-115, >adk_-123: of confidence 90.9%
137: G, 46: T, 250: C,
>aroE-7, >aroE-119: of confidence 99.5%
42: T, 271: A,
>pdhC-5, >pdhC-12, >pdhC-110: of confidence 98.9%
Indistinguishable group of STs based on the above loci are as follows:
ST8, ST66, ST153, ST481, ST487, ST1058, ST1094, ST1349, ST1887,

The abbreviated “SNP Alleles” alignment construction is a two-stage process, as given below. Whilst the steps 1 to 7 are the user defined SNP profile selection process, the step 8 is the final construction and loading process:—
1. Click the “D” option button. Then click the Start button.
2. Under Tools menu bar select Allele Options which opens up Allele Identification Parameters dialog window.
3. Set Simpson Index value (up to maximum of 0.99), Search Depth, TimeOut (>180 seconds), Maximum Number of Results and click the OK button.
4. Load any allele file using File menu.
5. Select and click Identify Allele. This results in the computed output of SNP positions at various combinations along with respective Simpson Index converges to value one. This output displays maximum discriminatory values in generalized terms at locus level.
6. Type one set of SNP positions from the above output in the Identity Check text box and click the Accept button.
7. Repeat the steps 4 to 6 until all allele files (loci) or selected allele files of interest are included in the analyses or to redefine a locus that had previously been defined. When all the needed loci have been defined, continue to step 8.
8. Finally click the Finish button, which automatically brings file dialog window. Pick the appropriate Strain (ST) File and click open. This will create and load “SNP Alleles” alignment data. As a result, the allele combo box gets filled with all the identifiers for the particular strain that was loaded.

It is to be noted here that the strain in allele combo box represents the newly created identifiers for the “SNP Alleles” alignment. By default the abbreviated code for the first strain is displayed in the top text area (Table 28). The bottom Report area shows the mapped actual SNP positions for each of the loci (Table 29):

TABLE 28
Top text area

[SEQ ID NO: 4]

| | |
|---|---|
| ST 1 | TCCTGCCTACTCGTGGTGTCGACCCGCCAGTGAGTTCGGT |

TABLE 29
Bottom Report area

>abcZ >>> 1:60, 2:95, 3:183, 4:372, 5:417, >adk_{—} >>> 6:21,
7:108, 8:127, 9:174, 10:189, 11:216,
12:460, >aroE >>> 13:76, 14:103, 15:212, 16:380, 17:466,
>fumC >>> 18:9, 19:72, 20:114,
21:330, 22:441, 23:447, >gdh_{—} >>> 24:30,
25:46, 26:60, 27:132, 28:171, 29:290, 30:420, >pdhC
>>> 31:28, 32:129, 33:177, 34:297, 35:456,
>pgm_{—} >>> 36:24, 37:93, 38:126, 39:193, 40:215,

Now the “SNP Alleles” alignment is ready for analysis and the allele drop box has the strain ID (e.g. ST 1 etc.). Since “SNP Alleles” alignment is in allele format it is analyzed only using “Identify Allele” button. This could then be used as input for a D and Percentage discrimination.

The example outputs of general discrimination (D) of all strains and specific % discrimination for strain ST 7 are given in Tables 30 and 31, respectively.

TABLE 30
General Discrimination of all strains

>abcZ >>> 1:60, 2:95, 3:183, 4:372, 5:417, >adk_{—} >>> 6:21, 7:108, 8:127, 9:174, 10:189, 11:216,
12:460, >aroE >>> 13:76, 14:103, 15:212, 16:380, 17:466, >fumC >>> 18:9, 19:72, 20:114,
21:330, 22:441, 23:447, >gdh_{—} >>> 24:30, 25:46, 26:60, 27:132, 28:171, 29:290, 30:420, >pdhC
>>> 31:28, 32:129, 33:177, 34:297, 35:456, >pgm_{—} >>> 36:24, 37:93, 38:126, 39:193, 40:215,
Diversity Measure Results:
<Identification Constraints>
Time Out: 180 seconds.
Simpson Index: 0.99.
Maximum Number of Results: 30.
Excluded SNP's: None.
(1) 37: Index = 0.65; 16: Index = 0.86; 20: Index = 0.92; 3: Index = 0.96; 26: Index = 0.97;
35: Index = 0.98; 1: Index = 0.99;
(2) 37: Index = 0.65; 16: Index = 0.86; 20: Index = 0.92; 3: Index = 0.96; 26: Index = 0.97;
35: Index = 0.98; 7: Index = 0.99;
(3) 37: Index = 0.65; 16: Index = 0.86; 20: Index = 0.92; 3: Index = 0.96; 26: Index = 0.97;
35: Index = 0.98; 17: Index = 0.99;

TABLE 31
Specific % discrimination for strain ST7

>abcZ >>> 1:60, 2:95, 3:183, 4:372, 5:417,
>adk_ >>> 6:21, 7:108, 8:127, 9:174, 10:189,
11:216, 12:460,
>aroE >>> 13:76, 14:103, 15:212, 16:380, 17:466,
>fumC >>> 18:9, 19:72, 20:114, 21:330, 22:441,
23:447,
>gdh_ >>> 24:30, 25:46, 26:60, 27:132, 28:171,
29:290, 30:420,
>pdhC >>> 31:28, 32:129, 33:177, 34:297, 35:456,
>pgm_ >>> 36:24, 37:93, 38:126, 39:193, 40:215,
ST 7 Results:
ST7

[SEQ ID NO: 5]

TCCTGCCTACTCATGACGTCGACCTACCGACGGGCCGTGT
<Identification Constraints>
Time Out: 180 seconds.
Confidence: 100.0%.
Maximum Number of Results: 30.
Excluded SNP's: None.

| | |
|---|---|
| (1) | 38: T, 94.1%; 37: G, 99.7%; 13: A, 100.0%; |
| (2) | 38: T, 94.1%; 37: G, 99.7%; 16: A, 100.0%; |
| (3) | 38: T, 94.1%; 37: G, 99.7%; 22: A, 100.0%; |
| (4) | 38: T, 94.1%; 37: G, 99.7%; 27: C, 100.0%; |
| (5) | 38: T, 94.1%; 37: G, 99.7%; 31: C, 100.0%; |
| (6) | 38: T, 94.1%; 37: G, 99.7%; 34: G, 100.0%; |

The procedure for constructing the “mega-alignment consists of two stages. In the first stage, the user-defined loci are selected (steps 1 to 4). In the second stage (step 5) each strain is converted into a single sequence composed of user-selected allele sequences (mega-alignment):—
1. Select and Click the D button. Then click the Start button.
2. Load any allele file using File menu.
3. Type * in the Identity Check text box and click the Accept button.
4. Repeat the steps 2 and 3 until all allele files (loci) or selected allele files of interest are included in the analyses or to redefine a locus that had previously been defined. When all the needed loci have been defined, continue to step 5.
5. Finally click the Finish button, which automatically brings file dialog window. Pick the appropriate Strain File and click open. This will create and load mega-alignment data. As a result, the allele combo box gets filled with all the identifiers for the particular strain that was loaded.

The mega-alignment is now ready for analysis and the allele drop box will have the strain ID (e.g. ST 1 etc.). Since mega-alignment is in allele format it is analyzed only using “Identify Allele” button. This could then be used as input for a D and Percentage discrimination. The resulting best SNP positions have been decoded into positions corresponding to the individual locus.

The example outputs of specific strain % discrimination for ST 7 and general discrimination (D) of all strains are given in Tables 32 and 33, respectively.

In the result:
(1) 3264==>pgm_{—}>>430: A, 99.9%; 9==>abcZ>>9: T, 100.0%;

3264 refers to the position in the mega-alignment, 430 refers to the corresponding mapping position in the locus pgm_{—}, 9 refers to the position in the mega-alignment, 9 refers to the corresponding mapping position in the locus abcZ.

Similarly, in the result for General discrimination (D) of all strains,

(1) 2927>>>pgm_{—}>>93: Index=0.65; 1181>>>aroE>>283: Index=0.87; 2810>>>pdhC>>456: Index=0.93; 1502>>>fumC>>114: Index=0.96; 54>>>abcZ>>54: Index=0.98; 1913>>>gdh_{—}>>60: Index=0.98; 183>>>abcZ>>183: Index=0.99;

2927 refers to the position in the mega-alignment, and 93 refers to the corresponding real position in the locus pgm_{—}, 1181 refers to the position in the mega-alignment, and 283 refers to the corresponding real position in the locus aroE, etc.

TABLE 32
Specific strain % discrimination for ST 7

| | |
|---|---|
| >abcZ COMMENCES AT: 1; | |
| >adk_ COMMENCES AT: 434; | |
| >aroE COMMENCES AT: 899; | |
| >fumC COMMENCES AT: 1389, | |
| >gdh_ COMMENCES AT: 1854; | |
| >pdhC COMMENCES AT: 2355; | |
| >pgm_ COMMENCES AT: 2835; | |
| ST 7 Results: | |
| ST 7 | |
| TTTGATACTGTTGCCGAAGGTTTGGGCGAAATTCGCGATTTATTGCGCCGTTATCATCA | [SEQ ID NO: 6] |
| TTGCAACTTGAGA.........................................CAATGCCAAGTTTGAA | |
| <Identification Constraints> | |
| Time Out: 180 seconds. | |
| Confidence: 100.0%. | |
| Maximum Number of Results: 30. | |
| Excluded SNP's: None. | |

| | |
|---|---|
| (1) | 3264==>pgm_>>430: A, 99.9%; 9==>abcZ>>9: T, 100.0%; |
| (2) | 3264==>pgm_>>430: A, 99.9%; 27==>abcZ>>27: C, 100.0%; |
| (3) | 3264==>pgm_>>430: A, 99.9%; 30==>abcZ>>30: A, 100.0%; |
| (4) | 3264==>pgm_>>430: A, 99.9%; 72==>abcZ>>72: G, 100.0%; |
| (5) | 3264==>pgm_>>430: A, 99.9%; 79==>abcZ>>79: A, 100.0%; |

TABLE 33
General discrimination (D) of all strains

>abcZ >>> COMMENCES AT: 1; >adk_{—} >>> COMMENCES AT: 434; >aroE >>>
COMMENCES AT: 899; >fumC >>> COMMENCES AT: 1389; >gdh_{—} >>> COMMENCES AT:
1854; >pdhC >>> COMMENCES AT: 2355; >pgm_{—} >>> COMMENCES AT: 2835;
Diversity Measure Results:
<Identification Constraints>
Time Out: 3600 seconds.
Simpson Index: 0.99.
Maximum Number of Results: 100.
Excluded SNP's: None.
(1) 2927 >>>pgm_>>93: Index = 0.65; 1181>>>aroE>>283: Index = 0.87; 2810>>> pdhC
>>456: Index = 0.93; 1502 >>> fumC >>114: Index = 0.96; 54>>>abcZ>>54: Index = 0.98;
1913>>> gdh_{—} >> 60: Index = 0.98; 183>>>abcZ>>183: Index = 0.99;
(2) 2927>>>pgm_>>93: Index = 0.65; 1181>>>aroE>>283: Index = 0.87; 2810>>> pdhC
>>456: Index = 0.93; 1502>>> fumC >>114: Index = 0.96; 54>>>abcZ>>54: Index = 0.98;
1913>>> gdh_{—} >> 60: Index = 0.98; 318>>>abcZ>>318: Index = 0.99;
(3) 2927>>>pgm_>>93: Index = 0.65; 1181>>>aroE>>283: Index = 0.87; 2810>>> pdhC
>>456: Index = 0.93; 1502>>> fumC >>114: Index = 0.96; 54>>>abcZ>>54: Index = 0.98;
1913>>> gdh_{—} >> 60: Index = 0.98; 330>>>abcZ>>330: Index = 0.99;
(4) 2927>>>pgm_>>93: Index = 0.65; 1181>>>aroE>>283: Index = 0.87; 2810>>> pdhC
>>456: Index = 0.93; 1502>>> fumC >>114: Index = 0.96; 54>>>abcZ>>54: Index = 0.98;
1913>>> gdh_{—} >> 60: Index = 0.98; 334>>>abcZ>>334: Index = 0.99;
(5) 2927>>>pgm_>>93: Index = 0.65; 1181>>>aroE>>283: Index = 0.87; 2810>>> pdhC
>>456: Index = 0.93; 1502>>> fumC >>114: Index = 0.96; 54>>>abcZ>>54: Index = 0.98;
1913>>> gdh_{—} >> 60: Index = 0.98; 342>>>abcZ>>342: Index = 0.99;

The identification of informative SNPs which have high discriminatory power enables the development of diagnostic agents useful in identifying or sourcing biological entities such as prokaryotic or eukaryotic microorganisms, pathogenic cells, viruses, prions and non-animal cells such as plant cells. The diagnostic reagents are particularly useful in epidemiological studis or analyses, forensic analysis and disease control in a range of environments including domestic, industrial, hospital and military environments. For example, a source of Staphylococcus could be traced if detected in a hospital. Alternatively or in addition, the diagnostic agents could identify whether an outbreak of Staphylococcus or other pathogen is particular pathogenic or only mildly pathogenic. In forensics, sources of biological contaminants such as anthrax spores could be traced to particular stockpiles. In epidemiological studies, diagnostic agents could be quickly generated to identify flu strains or pathological microbial strains.

Consequently, the present invention contemplates diagnostic and prognostic methods to detect or assess a SNP or an organism, cell or virus comprising same. In addition, the method can be performed by detecting an absence of a SNP.

Direct DNA sequencing, either manual sequencing or automated fluorescent sequencing, can detect a SNP. Another approach is the single-stranded conformation polymorphism assay (SSCP) [Orita et al., Proc. Nat. Acad. Sci. USA 86: 2776-2770, 1989]. This method can be optimized to detect SNPs. The increased throughput possible with SSCP makes it an attractive, viable alternative to direct sequencing for SNP detection on a research basis. The fragments which have shifted mobility on SSCP gels are then sequenced to determine the exact nature of the SNP. Other approaches based on the detection of mismatches between the two complementary DNA strands include clamped denaturing gel electrophoresis (CDGE) [Sheffield et al., Am. J. Hum. Genet. 49: 699-706, 1991], heteroduplex analysis (HA) [White et al., Genomics 12: 301-306, 1992] and chemical mismatch cleavage (CMC) [Grompe et al., Proc. Natl. Acad. Sci. USA 86: 5855-5892, 1989]. Other methods which might detect SNPs in regulatory regions include a protein truncation assay or the asymmetric assay. A review of methods of detecting. DNA sequence variation can be found in Grompe (Proc. Natl. Acad. Sci. USA 86: 5855-5892, 1993). Once a mutation is known, an allele specific detection approach such as allele specific oligonucleotide (ASO) hybridization can be utilized to rapidly screen large numbers of other samples for that same mutation. Such a technique can utilize probes which are labeled with gold nanoparticles to yield a visual color result (Eighanian et al., Science 277: 1078-1081, 1997).

A rapid preliminary analysis to detect polymorphisms in DNA sequences can be performed by looking at a series of Southern blots of DNA cut with one or more restriction enzymes, preferably a large number of restriction enzymes. Each blot contains a series of normal individuals and a series of tumor cases. Southern blots displaying hybridizing fragments (differing in length from control DNA when probed with sequences near or including the SNP locus) indicate a possible mutation. If restriction enzymes which produce very large restriction fragments are used, then pulsed field gel electrophoresis (PFGE) is employed.

Detection of SNPs may also be accomplished by molecular cloning and sequencing that allele using techniques well known in the art. Alternatively, the gene sequences can be amplified, using known techniques, directly from a genomic DNA preparation from the tumor tissue. The DNA sequence of the amplified sequences can then be determined.

Other tests for confirming the presence or absence of a SNP include single-stranded conformation analysis (SSCA) [Orita et al., (1989; supra)]; denaturing gradient gel electrophoresis (DGGE) [Wartell et al., Nucl. Acids Res. 18:2699-2705, 1990; Sheffield et al., Proc. Natl. Acad. Sci. USA 86: 232-236, 1989); RNase protection assays (Finkelstein et al., Genomics 7. 167-172, 1990; Kinszler et al., Science 251: 1366-1370, 1991); denaturing HPLC; allele-specific oligonucleotide (ASO hybridization) [Conner et al., Proc. Natl. Acad. Sci. USA 80: 278-282, 1983); the use of proteins which recognize nucleotide mismatches such as the E. coli mutS protein (Modrich, Ann. Rev. Genet. 25: 229-253, 1991) and allele-specific PCR (Ruano and Kidd, Nucl. Acids. Res. 17:8392, 1989). For allele-specific PCR, primers are used which hybridize at their 3′ ends to a particular SNP or to junctions of DNA caused by a SNP. If the particular SNP is not present, an amplification product is not observed. Amplification Refractory Mutation System (ARMS) can also be used, as disclosed in European Patent Publication No. 0 332 435 and in Newtown et al. (Nucl. Acids. Res. 17: 2503-2516, 1989). Insertions and deletions of genes can also be detected by cloning, sequencing and amplification. In addition, restriction fragment length polymorphism (RFLP) probes for the gene or surrounding marker genes can be used to score alteration of an allele or the absence of a polymorphic site. Such a method is particularly useful for screening relatives of an affected individual for the presence of the SNP found in that individual.

DNA sequences which have been amplified by use of PCR or other amplification reactions may also be screened using allele-specific or SNP-specific probes. These probes are nucleic acid oligomers, each of which contains a region of a gene sequence harboring a known SNP. For example, one oligomer may be about 20-40 nucleotides in length, corresponding to a portion of the gene sequence. By use of a battery of such allele-specific probes, PCR amplification products can be screened to identify the presence of a SNP as herein identified. Hybridization of allele-specific probes with amplified sequences can be performed, for example, on a nylon filter. Hybridization to a particular probe under stringent hybridization conditions indicates the presence of the same mutation in the tumor tissue as in the allele-specific probe.

Microchip technology is also applicable to the present invention. In this technique, thousands of distinct oligonucleotide or cDNA probes are built up in an array on a silicon chip or other solid support such as polymer films and glass slides. Nucleic acid to be analyzed is labeled with a reporter molecule (e.g. fluorescent label) and hybridized to the probes on the chip. It is also possible to study nucleic acid-protein interactions using these nucleic acid microchips. Using this technique, one can determine the presence of SNPs in the nucleic acid being analyzed or one can measure expression levels of a gene of interest or multiple genes of interest having a particular SNP or group of SNPs. The technique is described in a range of publications including Hacia et al. (Nature Genetics 14: 441-447, 1996), Shoemaker et al. (Nature Genetics 14: 450-456, 1996), Chee et al. (Science 274: 610-614, 1996), Lockhart et al. (Nature Biotechnology 14: 1675-1680, 1996), DiRisi et al. (Nature Genetics 14: 457-460, 1996) and Lipshutz et al. (Biotechniques 19: 442-447, 1995).

The particularly definitive test for a SNP in a candidate locus is to directly compare genomic sequences from subjects or cells or viruses from those from a control population. Alternatively, one could sequence messenger RNA after amplification, e.g. by PCR, thereby eliminating the necessity of determining the exon structure of the candidate gene.

Real-time PCR is a particularly useful method for interrogating SNPs. This is a single step method as there is no post-PCR processing and is a closed system meaning that the amplified material is not released into a laboratory thus reducing the risk of contamination.

Real-time analysis technologies permit accurate and specific amplification products (e.g. PCR products) to be quantitatively detected within an amplification vessel during the exponential phase of the amplification process, before reagents are exhausted and the reaction plateaus or non-specific amplification limits the reaction. The particular cycle of amplification at which the detected amplification signal first crosses a set threshold is proportional to the starting copy number of the target molecules.

Instruments capable of measuring real-time include Taq Man 7700 AB (Applied Biosystems), Rotorgene 2000 (Corbett Research), LightCycler (Roche), iCycler (Bio-Rad) and Mx4000 (Stratagene).

Assay methods of the present invention are suitable for use with a number of direct reaction detection technologies and chemistries such as Taq Man (Perkin-Elmer), molecular beacons and the LightCycler (trademark) fluorescent hybridization probe analysis (Roche Molecular Systems):

One useful system for real-time DNA amplification and detection is the LightCycler (trademark) fluorescent hybridization probe analysis. This system involves the use of three essential components: two different oligonucleotides (labeled) and the amplification product. Oligonucleotide 1 carries a fluorescein label at its 3′ end whereas oligonucleotide 2 carries another label, LC Red 640 or LC Red 705, at its 5′ end. The sequence of the two oligonucleotides are selected such that they hybridize to the amplified DNA fragment in a head to tail arrangement. When the oligonucleotides hybridize in this orientation, the two fluorescent dyes are positioned in close proximity to each other. The first dye (fluorescein) is excited by the LightCycler's LED (Light Emitting Diode) filtered light source and emits green fluorescent light at a slightly longer wavelength. When the two dyes are in close proximity, the emitted energy excites the LC Red 640 or LC Red 705 attached to the second hybridization probe that subsequently emits red fluorescent light at an even longer wavelength. This energy transfer, referred to as FRET (Forster Resonance Energy Transfer or Fluorescence Resonance Energy Transfer) is highly dependent on the spacing between the two dye molecules. Only if the molecules are in close proximity (a distance between 1-5 nucleotides) is the energy transferred at high efficiency. Choosing the appropriate detection channel, the intensity of the light emitted by the LC Red 640 or LC Red 705 is filtered and measured by optics in the thermocycler. The increasing amount of measured fluorescence is proportional to the increasing amount of DNA generated during the ongoing PCR process. Since LC Red 604 and LC Red 705 only emit a detectable signal when both oligonucleotides are hybridized, the fluorescence measurement is performed after the annealing step. Using hybridization probes can also be beneficial if samples containing very few template molecules are to be examined. DNA quantification with hybridization probes is not only sensitive but also highly specific. It can be compared with agarose gel electrophoresis combined with Southern blot analysis but without all the time consuming steps which are required for the conventional analysis.

The “Taq Man” fluorescence energy transfer assay uses a nucleic acid probe complementary to an internal segment of the target DNA. The probe is labeled with two fluorescent moieties with the property that the emission spectrum of one overlaps the excitation spectrum of the other; as a result, the emission of the first fluorophore is largely quenched by the second. The probe, if present during PCR and if PCR product is made, becomes susceptible to degradation via a 5′-nuclease activity of Taq polymerase that is specific for DNA hybridized to template. Nucleolytic degradation of the probe allows the two fluorophores to separate in solution which reduces the quenching and increases the intensity of emitted light.

Probes used as molecular beacons are based on the principle of single-stranded nucleic acid molecules that possess a stem-and-loop structure. The loop portion of the molecule is a probe sequence that is complementary to a predetermined sequence in a target nucleic acid. The stem is formed by the annealing of two complementary arm sequences that are on either side of the probe sequence. The arm sequences are unrelated to the target sequence. A fluorescent moiety is attached to the end of one arm and a non-fluorescent quenching moiety is attached to the end of the other arm. The stem keeps these two moieties in close proximity to each other causing the fluorescence of the fluorophore to be quenched by fluorescence resonance energy transfer. The nature of the fluorophore-quencher pair that is preferred is such that energy received by the fluorophore is transferred to the quencher and dissipated as heat rather than being emitted as light. As a result, the fluorophore is unable to fluoresce. When the probe encounters a target SNP, it forms a hybrid that is longer and more stable than the hybrid formed by the arm sequences. Since nucleic acid double helices are relatively rigid, formation of a probe-target hybrid precludes the simultaneous existence of a hybrid formed by the arm sequences. Thus, the probe undergoes a spontaneous conformiational change that forces the arm sequences apart and causes the fluorophore and quencher to move away from each other. Since the fluorophore is no longer in close proximity to the quencher, it fluoresces when illuminated by an appropriate light source. The probes are termed “molecular beacons” because they emit a fluorescent signal only when hybridized to target SNP molecules.

SYBR (registered trademark) is also useful. SYBR is a fluorescent dye which may be used in ABI sequence detection systems such as ABI PRISM 770 (registered trademark), Rotorgene 2000 (Corbett Research), Mx4000 (Stratagene), GeneAmp 5700, LightCycler (registered trademark) and iCycler (trademark).

A number of real-time fluorescent detection thermocyclers are currently available with the chemistries being interchangeable with those discussed above as the final product is emitted fluorescence. Such thermocyclers include the Perkin Elmer Biosystems 7700, Corbett Research's Rotorgene, the Hoffman La Roche LightCycler, the Stratagene Mx4000 and the Bio-Rad iCycler. It is envisaged that any of the above thermocyclers could be adapted to accommodate the method of the present invention.

Exemplary fluorophores include but are not limited to 4-acetamido-4′-isothiocyanatostilbene-2,2′disulfonic acid acridine and derivatives including acridine, acridine isothiocyanate, 5-(2′-aminoethyl)aminonaphthalene-1-sulfonic acid (EDANS), 4-amino-N-[3-vinylsulfonyl)-phenyl]naphthalimide-3,5 disulfonate (Lucifer Yellow VS) anthranilamide, Brilliant Yellow, coumarin and derivatives including coumarin, 7-amino-4-methylcoumarin (AMC, Coumarin 120), 7-amino-4-trifluoromethylcoumarin (Coumarin 151), Cy3, Cy5, cyanosine, 4′,6-diaminidino-2-phenylindole (DAPI), 5′,5″-dibromopyrogallol-sulfonaphthalein (Bromopyrogallol Red), 7-diethylamino-3-(4′-isothiocyanatophenyl)-4-methylcoumarin, diethylenetriamine pentaacetate, 4,4′-diisothiocyanatodihydro-stilbene-2,2′-disulfonic acid, 4,4′-diisothiocyanatostilbene-2,2′-disulfonic acid, 5-[dimethylamino]naphthalene-1-sulfonyl chloride (DNS, dansyl chloride), 4-(4′-dimethylaminophenylazo)benzoic acid (DABCYL) 4-dimethylaminophenyl-azophenyl-4′-isothiocyanate (DABITC), eosin and derivatives including eosin, eosin isothiocyanate, erythrosin and derivatives including erythrosin B, erythrosin isothiocyanate, ethidium, fluorescein and derivatives including 5-carboxyfluorescein (FAM), 5-(4,6-dichlorotriazin-2-yl)aminofluorescein (DTAF), 2′7′-dimethoxy-4′5′-dichloro-6-carboxyfluorescein (JOE), fluorescein, fluorescein isothiocyanate, QFITC (XRITC), fluorescamine, IR144, IR1446, Malachite Green isothiocyanate, 4-methylumbelliferone, ortho-cresolphthalein, nitrotyrosine, pararosaniline, Phenol Red, B-phycoerythrin, o-phthaldialdehyde, pyrene and derivatives including, pyrene, pyrene butyrate, succinimidyl 1-pyrene butyrate, Reactive Red 4 (Cibacron [registered trademark] Brilliant Red 3B-A), rhodamine and derivatives, 6-carboxy-X-rhodamine (ROX), 6-carboxyrhodamine (R6G), lissamine rhodamine B sulfonyl chloride, rhodamine (Rhod), rhodamine B, rhodamine 110, rhodamine 123, rhodamine X isothiocyanate, sulforhodamine B, sulforhodamine 101, sulfonyl chloride derivative of sulforhodamine 101 (Texas Red), N,N,N′N′-tetramethyl-6-carboxyrhodamine (TAMRA), tetramethyl rhodamine, tetramethyl rhodamine isothiocyanate (TRITC), riboflavin, rosolic acid, terbium chelate derivatives.

Real-time PCR methods for SNP interrogation include allele specific real-time PCR, otherwise known as kinetic PCR (Germer et al., Genome Research 10: 258-266, 2000), competitive hybridization of hydrolysable fluorescent probes (Morin et al., Biotechniques 27: 538-540, 542, 544 [Passim], 1999), hybridization of fluorescence transfer probes followed by melt curve analysis (Livak et al., PCR Methods Appl. 4: 357-362, 1995; Grosch et al., Br. J. Clin. Pharma. 52: 711-714, 2001), molecular beacons (Tyagi and Kramer, Nat. Biotechnol. 14: 303-308, 1996), scorpion primers (Thelwell et al., Nucleic Acids Research 28: 3752-3761, 2000) and self-quenched primers (Nazarenko et al., Nucleic Acids Research 30: e37, 2002).

Those skilled in the art will appreciate that there are many variations of and developments from these approaches.

There is also an allied method called the “Invader assay” which, although not involving real-time PCR, is carried out in a real-time PCR machine (Hessner et al., Clin. Chem. 46: 1051-1056, 2000).

The present invention permits the use of a range of capture and immobilization methodologies to capture target molecules. Dynabead (registered trademark) technology is the most convenient up to the present time. In one example, biotin or a related molecule is incorporated into a target molecule and this permits immobilization to a bead coated with a biotin ligand. Examples of such ligands include streptavidin, avidin and anti-biotin antibodies.

A “nucleic acid” as used herein, is a covalently linked sequence of nucleotides in which the 3′ position of the pentose of one nucleotide is joined by a phosphodiester group to the 5′ position of the pentose of the next nucleotide and in which the nucleotide residues (bases) are linked in specific sequence; i.e. a linear order of nucleotides. A “polynucleotide” as used herein, is a nucleic acid containing a sequence that is greater than about 100 nucleotides in length. An “oligonucleotide” as used herein, is a short polynucleotide or a portion of a polynucleotide. An oligonucleotide typically contains a sequence of about two to about one hundred bases. The word “oligo” is sometimes used in place of the word “oligonucleotide”.

“Nucleoside”, as used herein, refers to a compound consisting of a purine (guanine (G) or adenine (A)] or pyrimidine [thymine (T), uridine (U) or cytidine (C)] base covalently linked to a pentose, whereas “nucleotide” refers to a nucleoside phosphorylated at one of its pentose hydroxyl groups. “XTP”, “XDP” and “XMP” are generic designations for ribonucleotides and deoxyribonucleotides, wherein the “TP” stands for triphosphate, “DP” stands for diphosphate, and “IMP” stands for monophosphate, in conformity with standard usage in the art. Subgeneric designations for ribonucleotides are “NMP”, “NDP” or “NTP”, and subgeneric designations for deoxyribonucleotides are “dNMP”, “dNMP” or “dNTP”. Also included as “nucleoside”, as used herein, are materials that are commonly used as substitutes for the nucleosides above such as modified forms of these bases (e.g. methyl guanine) or synthetic materials well known in such uses in the art, such as inosine.

As used herein, the term “nucleic acid probe” refers to an oligonucleotide or polynucleotide that is capable of hybridizing to another nucleic acid of interest under low stringency conditions. A nucleic acid probe may occur naturally as in a purified restriction digest or be produced synthetically, by recombinant means or by PCR amplification. As used herein, the term “nucleic acid probe” refers to the oligonucleotide or polynucleotide used in a method of the present invention. That same oligonucleotide could also be used, for example, in a PCR method as a primer for polymerization, but as used herein, that oligonucleotide would then be referred to as a “primer”. In some embodiments herein, oligonucleotides or polynucleotides contain a modified linkage such as a phosphorothioate bond.

As used herein, the terms “complementary” or “complementarity” are used in reference to nucleic acids (i.e. a sequence of nucleotides) related by the well-known base-pairing rules that A pairs with T and C pairs with G. For example, the sequence 5′-A-G-T-3′, is complementary to the sequence 3′-T-C-A-5′. Complementarity can be “partial” in which only some of the nucleic acid bases are matched according to the base pairing rules. On the other hand, there may be “complete” or “total” complementarity between the nucleic acid strands when all of the bases are matched according to base pairing rules. The degree of complementarity between nucleic acid strands has significant effects on the efficiency and strength of hybridization between nucleic acid strands as known well in the art. This is of particular importance in detection methods that depend upon binding between nucleic acids, such as those of the invention. The term “substantially complementary” refers to any probe that can hybridize to either or both strands of the target nucleic acid sequence under conditions of low stringency as described below or, preferably, in polymerase reaction buffer (Promega, M195A) heated to 95° C. and then cooled to room temperature. As used herein, when the nucleic acid probe is referred to as partially or totally complementary to the target nucleic acid, that refers to the 3′-terminal region of the probe (i.e. within about 10 nucleotides of the 3′-terminal nucleotide position).

Reference herein to a low stringency includes and encompasses from at least about 0 to at least about 15% v/v formamide and from at least about 1 M to at least about 2 M salt for hybridization, and at least about 1 M to at least about 2 M salt for washing conditions. Generally, low stringency is at from about 25-30° C. to about 42° C. The temperature may be altered and higher temperatures used to replace formamide and/or to give alternative stringency conditions. Alternative stringency conditions may be applied where necessary, such as medium stringency, which includes and encompasses from at least about 16% v/v to at least about 30% v/v formamide and from at least about 0.5 M to at least about 0.9 M salt for hybridization, and at least about 0.5 M to at least about 0.9 M salt for washing conditions, or high stringency, which includes and encompasses from at least about 31% v/v to at least about 50% v/v formamide and from at least about 0.01 M to at least about 0.15 M salt for hybridization, and at least about 0.01 M to at least about 0.15 M salt for washing conditions. In general, washing is carried out Tₘ=69.3+0.41 (G+C)% (Marmur and Doty, J. Mol. Biol. 5: 109 1962). However, the Tₘ of a duplex DNA decreases by 1° C. with every increase of 1% in the number of mismatch base pairs (Bonner and Laskey, Eur. J. Biochem. 46: 83, 1974). Formamide is optional in these hybridization conditions. Accordingly, particularly preferred levels of stringency are defined as follows: low stringency is 6×SSC buffer, 0.1% w/v SDS at 25-42° C.; a moderate stringency is 2×SSC buffer, 0.1% w/v SDS at a temperature in the range 20° C. to 65° C.; high stringency is 0.1×SSC buffer, 0.1% w/v SDS at a temperature of at least 65° C.

Alteration of gene expression can also be used to indicate the presence of a SNM which affects expression levels. Methods include Northern blot analysis, PCR amplification, RNase protection and microchip technology.

The present invention further enables continual monitoring of known sequence diversity so as to identify highly informative polymorphisms, routine interrogation of these polymorphisms at the point of diagnosis, digitization of the results and retention and analysis of these data by public health authorities. Generally, the routine interrogation is by a rapid, cost-effective means which can be readily adopted to new polymorphisms. Real-time PCR is one such useful method.

Biological entities contemplated by the present invention include bacteria, viruses, prions, unicellular organisms, prokaryotes and eukaryotes. Particular microorganisms contemplated include Salmonella, Escherichia, Klebsiella, Pasteurella, Bacillus (including Bacillus anthracis), Clostridium, Corynebacterium, Mycoplasma, Ureaplasma, Actinomyces, Mycobacterium, Chlamydia, Chlamydophila, Leptospira, Spirochaeta, Borrelia, Treponema, Pseudomonas, Burkholderia, Dichelobacter, Haemophilus, Ralsionia, Xanthomonas, Moraxella, Acinetobacter, Branhamella, Kingella, Erwinia, Enterobacter, Arozona, Citrobacter, Proteus, Providencia, Yersinia, Shigella, Edwardsiella, Vibrio, Rickettsia, Coxiella, Ehrlichia, Arcobacteria, Peptostreptococcus, Candida, Aspergillus, Trichomonas, Bacterioides, Coccidiomyces, Pneumocystis, Cryptosporidium, Porphyromonas, Actinobacillus, Lactococcus, Lactobacillua, Zymononas, Saccharomyces, Propionibacterium, Streptomyces, Penicillum, Neisseria, Staphylococcus, Campylobacter, Streptococcus, Enterococcus and Helicobacter.

The methods of the present invention also apply to the use of ribosomal RNA or DNA encoding ribosomal RNA in order to identify SNPs diagnostic for particular species or genera., as opposed to SNPs diagnostic for particular variants within species.

In yet another method, highly discriminatory SNPs are used in conjunction with the interrogation of another variable site such as a hypervariable locus.

The presence of a SNP can also be detected by screening for an amino acid change in the corresponding protein, when the SNP causes a codon change. For example, monoclonal antibodies immunoreactive with a protein encoded by a gene having a particular SNP can be used to screen cells or viruses. Antibodies specific for products of SNP alleles could also be used to detect particular gene products. Such immunological assays can be done in any convenient format known in the art. These include Western blots, immunohistochemical assays and ELISA assays. Any means for detecting an altered protein can be used to detect alteration of a corresponding gene.

The use of monoclonal antibodies in an immunoassay is particularly preferred because of the ability to produce them in large quantities and the homogeneity of the product. The preparation of hybridoma cell lines for monoclonal antibody production is derived by fusing an immortal cell line and lymphocytes sensitized against the immunogenic preparation (i.e. comprising the protein with a particular amino acid profile defined by one or more SNPs) or can be done by techniques which are well known to those who are skilled in the art. (See, for example, Douillard and Hoffman, Basic Facts about Hybridomas, in Compendium of Immunology Vol. II, ed. by Schwartz, 1981; Kohler and Milstein, Nature 256: 495-499, 1975; Kohler and Milstein, European Journal of Immunology 6: 511-519, 1976).

The presence of a protein may be accomplished in a number of ways such as by Western blotting, histochemistry and ELISA procedures. A wide range of immunoassay techniques are available as can be seen by reference to U.S. Pat. Nos. 4,016,043, 4,424,279 and 4,018,653. These include both single-site and two-site or “sandwich” assays of the non-competitive types, as well as in the traditional competitive binding assays. These assays also include direct binding of a labeled antibody to a target.

Sandwich assays are among the most useful and commonly used assays and are favoured for use in the present invention. A number of variations of the sandwich assay technique exist, and all are intended to be encompassed by the present invention. Briefly, in a typical forward assay, an unlabeled antibody is immobilized on a solid substrate and the sample to be tested brought into contact with the bound molecule. After a suitable period of incubation, for a period of time sufficient to allow formation of an antibody-antigen complex, a second antibody specific to the antigen, labeled with a reporter molecule capable of producing a detectable signal is then added and incubated, allowing time sufficient for the formation of another complex of antibody-antigen-labeled antibody. As stated above, the antigen is generally a protein or peptide or a fragment thereof. Any unreacted material is washed away, and the presence of the antigen is determined by observation of a signal produced by the reporter molecule. The results may either be qualitative, by simple observation of the visible signal, or may be quantitated by comparing with a control ample containing known amounts of hapten. Variations on the forward assay include a simultaneous assay, in which both sample and labeled antibody are added simultaneously to the bound antibody. These techniques are well known to those skilled in the art, including any minor variations as will be readily apparent.

In a typical forward sandwich assay, a first antibody having specificity for the protein or antigenic parts thereof, is either covalently or passively bound to a solid surface. The solid surface is typically glass or a polymer, the most commonly used polymers being cellulose, polyacrylamide, nylon, polystyrene, polyvinyl chloride or polypropylene. The solid supports may be in the form of tubes, beads, discs or microplates, or any other surface suitable for conducting an immunoassay. The binding processes are well-known in the art and generally consist of cross-linking covalently binding or physically adsorbing, the polymer-antibody complex to the solid surface which is then washed in preparation for the test sample. An aliquot of the sample to be tested is then added to the solid phase complex and incubated for a period of time sufficient (e.g. 2-40 minutes or overnight if more convenient) and under suitable conditions (e.g. from room temperature to about 37° C. including 25° C.) to allow binding of any subunit present in the antibody. Following the incubation period, the antibody subunit solid phase is washed and dried and incubated with a second antibody specific for a portion of the antigen. The second antibody is linked to a reporter molecule which is used to indicate the binding of the second antibody to the antigen.

An alternative method involves immobilizing the target molecules in the biological sample and then exposing the immobilized target to specific antibody which may or may not be labeled with a reporter molecule. Depending on the amount of target and the strength of the reporter molecule signal, a bound target may be detectable by direct labelling with the antibody.

Alternatively, a second labeled antibody, specific to the first antibody is exposed to the target-first antibody complex to form a target-first antibody-second antibody tertiary complex. The complex is detected by the signal emitted by the reporter molecule.

By “reporter molecule”, as used in the present specification, is meant a molecule which, by its chemical nature, provides an analytically identifiable signal which allows the detection of antigen-bound antibody. Detection may be either qualitative or quantitative. The most commonly used reporter molecules in this type of assay are either enzymes, fluorophores or radionuclide containing molecules (i.e. radioisotopes) and chemiluminescent molecules.

In the case of an enzyme immunoassay, an enzyme is conjugated to the second antibody, generally by means of glutaraldehyde or periodate. As will be readily recognized, however, a wide variety of different conjugation techniques exist, which are readily available to the skilled artisan. Commonly used enzymes include horseradish peroxidase, glucose oxidase, β-galactosidase and alkaline phosphatase, amongst others. The substrates to be used with the specific enzymes are generally chosen for the production, upon hydrolysis by the corresponding enzyme, of a detectable color change. Examples of suitable enzymes include alkaline phosphatase and peroxidase. It is also possible to employ fluorogenic substrates, which yield a fluorescent product rather than the chromogenic substrates noted above. In all cases, the enzyme-labeled antibody is added to the first antibody hapten complex, allowed to bind, and then the excess reagent is washed away. A solution containing the appropriate substrate is then added to the complex of antibody-antigen-antibody. The substrate will react with the enzyme linked to the second antibody, giving a qualitative visual signal, which may be further quantitated, usually spectrophotometrically, to give an indication of the amount of hapten which was present in the sample. “Reporter molecule” also extends to use of cell agglutination or inhibition of agglutination, such as red blood cells on latex beads, and the like.

Alternately, fluorescent compounds, such as fluorescein and rhodamine, may be chemically coupled to antibodies without altering their binding capacity. When activated by illumination with light of a particular wavelength, the fluorochrome-labeled antibody absorbs the light energy, inducing a state to excitability in the molecule, followed by emission of the light at a characteristic color visually detectable with a light microscope. As in the EIA, the fluorescent labeled antibody is allowed to bind to the first antibody-hapten complex. After washing off the unbound reagent, the remaining tertiary complex is then exposed to the light of the appropriate wavelength, the fluorescence observed indicates the presence of the hapten of interest. Immunofluorescene and EIA techniques are both very well established in the art and are particularly preferred for the present method. However, other reporter molecules, such as radioisotope, chemiluminescent or bioluminescent molecules, may also be employed.

The present invention further provides kits comprising the diagnostic reagents defined above. These kits are generally in compartmental form and may be packaged for sale with instructions for use. The diagnostic kits may also be adapted to interfere with computer software.

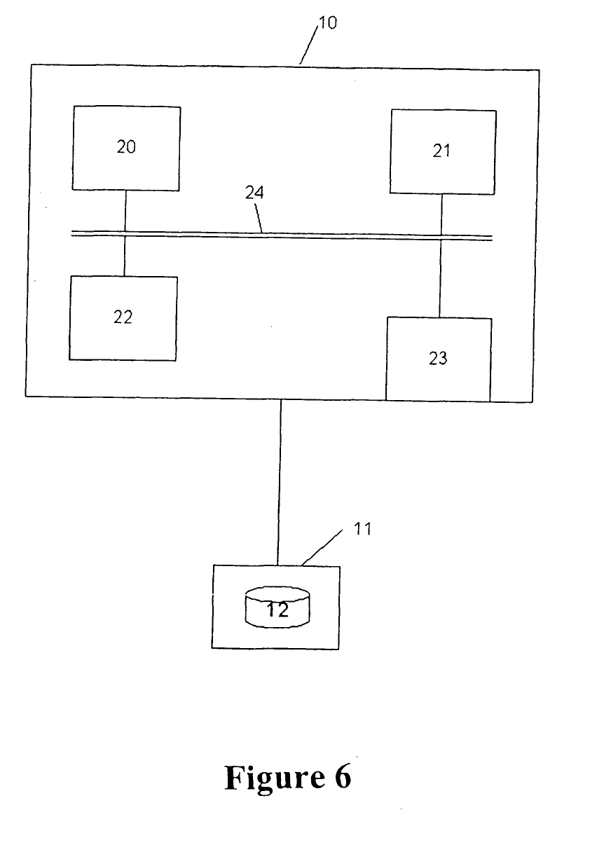

An example of a preferred embodiment of the present invention is described below with reference to FIG. 6, which shows a system suitable for implementing the present invention.

The system is formed from a processing system 10 coupled to a data store 11, the data store 11 usually including a database 12.

The processing system is adapted to receive data sets formed from a sequence of elements, each element having any one of a number of values. The system then compares similar data sets to discriminate and quantify similarities or differences between the data sets. This is achieved by comparing the values of corresponding elements in different sequences, the corresponding elements being located at the same position within the sequences being compared, to determine those elements that are different between the sequences.

The ability of the identity or value of these elements to uniquely identify the sequences is then quantified in the form of a discriminatory power. This information can then be used in a number of manners, such as in identifying unknown sequences, in distinguishing sequences, or the like, as will be appreciated by those skilled in the art.

In order to achieve this, the processing system 10 must be adapted to receive and process data sets, as will be described in more detail below. Accordingly, the processing system may be any form of processing system but typically includes a processor 20, a memory 21, an input/output (I/O) device 22, such as a keyboard and display coupled together via a bus 24, as shown in FIG. 6. It will, therefore, be appreciated that the processing system 10 may be formed from any suitable processing system, which is capable of operating applications software to enable the process the data sets, such as a suitably programmed personal computer.

However, in general the processing system 10 will be formed from a server, such as a network server, web-server, or the like allowing the analysis to performed from remote locations as will be described in more detail below. In this case, the processing system includes an interface 23, such as a network interface card, allowing the processing system to be connected to remote processing systems, such as via the Internet as will be described in more detail below.

In the following example, the data sets are sequence alignments, such as nucleic acids, proteins, amino acids, nucleic acid sequences, amino acids sequences, microorganisms including bacteria, viruses, prions, unicellular organisms, prokaryotes and eukaryotes. However, the techniques have wide applicability, not only in biotechnology and bioinformatics, but also in business or in any situation requiring the comparative analysis of data sets.

In any event, in this example, the system operates to examine sequence alignments formed from a number of nucleotides. The system operates to determine polymorphic sites within the different sequences in the alignment, the polymorphic sites being respective locations within the different sequences that have different nucleotides. The usefulness of these polymorphic sites in discriminating the sequences is then determined as a discriminatory power.

This allows the system to perform two main tasks, including determining:—
the best polymorphic sites for discriminating one or more sequences in the alignment from all other sequences in the alignment (known as “defined allele” programs); and
the best polymorphic sites for testing two or more sequences in the alignment to determine if they are the same or different (known as “generalized” programs).

The manner in which this is achieved will now be outlined.

First, the processing system 10 is adapted to obtain the nucleotide sequences to be analyzed. The nucleotide sequences may be obtained from a number of sources, such as:—
manual input via the I/O device 22;
received from an external processing system via the interface 23; or
by accessing nucleotide sequences stored in the database 12.

The nucleotide sequences may be provided in any form but are generally in the form of an alignment.

In any event, the processor 20 then operates to determine the polymorphic sites for a selected nucleotide sequence of interest. This is achieved by comparing the selected nucleotide sequence to each other nucleotide sequence in turn. For each comparison, the nucleotide at each position in the nucleotide sequence is compared to the nucleotide at an identical position in the other nucleotide sequence. Any positions that have different nucleotides will then be determined to be polymorphic sites.

It will be appreciated that if there was no correspondence between the nucleotide sequences then it is possible that each nucleotide in the sequence could be determined to be a polymorphic site. This would not generally be particularly useful. Accordingly, the system is, therefore, typically used to quantify how similar the selected nucleotide sequence to other similar nucleotide sequences, as well as to allow the nucleotide sequences to be discriminated.

This can, therefore, be used, for example, to identify new strains of bacteria, or the like. In order to do this, the nucleotide sequence of the bacteria would be compared to the nucleotide sequences of other strains of the bacteria. Furthermore, the system will not determine any match between the nucleotide sequence of interest and any of the other nucleotide sequences, but will also operate to determine any difference therebetween.

This allows for differences in the nucleotide sequences to be readily identified which is useful in monitoring variations between the nucleotide sequences and determining the effect this has on the bacteria, such as any impact on the virulence. This in turn allows researchers to observe variations between strains and not only identify new strains, but also predict the existence of new strains before they occur, which is of major benefit in treatment. Importantly, the method of the present invention allows epidemiological tracking based on known sequences and the emergence of particular virulent strains can be identified quickly.

In any event, it will, therefore, be appreciated there is usually a high degree of correlation between the nucleotide sequences being compared.

As mentioned above, the processor 20 compares the nucleotide sequences to determine the polymorphic sites for the selected nucleotide sequence. The processor then determines a discriminatory power for each polymorphic site.

This can generally be achieved using two ways depending on the type of analysis being performed:—
for defined allele programs, the discriminatory power is simply the proportion (or percentage) of the sequences in the alignment that are not discriminated from the sequence of interest by the polymorphism(s) that are being examined; or
for generalized programs, Simpson's Index of Diversity (D), which indicates the probability that two sequences in the alignment, chosen at random, will be discriminated by the polymorphisms being tested, is calculated.

Once the discriminatory powers have been determined, the processor 20 uses the discriminatory powers to determine the polymorphic sites of most interest. This is achieved using one of two types of algorithm.

The first type of algorithm searches the alignment and determines the polymorphic site that provides the greatest discriminatory power. This is then fixed as a polymorphic site of interest. The processor then determines a next polymorphic site that, in combination with the previous fixed polymorphic sites, provides the next discriminatory power. This process is repeated until either a pre-set number of polymorphic sites or a pre-set level of discrimination is reached. This type of algorithm is known as an “anchored method” algorithm because once a polymorphic site has been determined, it is anchored as a polymorphic site of interest.

The second type of algorithm uses an initial screening process to define a pool of potentially useful polymorphic sites, then screens every possible sub-set of a pre-set size to find the most useful combination of sites. There are various methods for carrying out the pre-screening step. In some cases it may not be necessary—given a short enough alignment or sufficient computer power it may be feasible to include every polymorphic site in the analysis. This type of algorithm is known as a “complete search” algorithm.

In addition to the above, the system can also perform a number of additional procedures, as will now be outlined in more detail.

The system can also operate using allele programs to define groups of nucleotide sequences within the alignment. This may be used, for example, to determine particularly various virulent clones within a bacterial species and is requires substantially more complex techniques than are required for simple allele or generalized programs that operate on a single selected nucleotide sequence of interest.

In the present example, this is achieved by constructing a consensus sequence representing the group of nucleotide sequences of interest and then find polymorphisms that define this consensus sequence. This can be achieved using two different techniques depending on the circumstances.

The first technique involves eliminating all positions from the alignment at which the sequences in the group of interest are not identical. This automatically reduces the group of interest to a single sequence.

The advantage of this is that any genetic test that makes use of this sort of consensus sequence will give exactly the same result for every member of the group of interest. However, the polymorphic sites can be informative even when they are not identical in every member of the group of interest. Thus, for example, if the nucleotide sequences in the group of interest include a G, A or T nucleotide at a particular polymorphic site and the rest of the sequences are always C at that site, then the position is perfectly discriminatory for the group of interest, despite lack of identity within the group of interest. As a result, purging the consensus sequence of all polymorphic sites where the nucleotide sequences in the group of interest are not identical can lose valuable polymorphic sites.

To overcome this, a second technique can be used in which the polymorphic sites are retained in the consensus sequence if the polymorphic sites in the sequences of interest are missing at least one base that is not completely missing at that site in the rest of the sequences. In this case, the nucleotide sequences in the group of interest are then re-coded to reflect what they are missing in comparison to the rest of the sequences.

Examples of this include:—
(1) Group of interest: G, A, C; The rest: T: Coded as “not T”;
(2) Group of interest: G, A, C; The rest: G, A, C, T: Coded as “not T”.
   Although these two examples are coded the same, the difference between them is apparent when the discriminatory powers are calculated for the respective polymorphic sites.
(3) Group of interest: G, A, C: The rest: G, A: Deleted from alignment.
   In this case, the presence of the nucleotide C in the group of interest can also be informative, even though it will not be identified in the consensus sequence. This is because the technique operates to simplify the consensus sequence at the possible expense of useful sites.
   This is performed for an important reason. In particular, the defined allele programs can be used to generate a fingerprint of the nucleotide sequences in the group. In this case, it is important that the fingerprint does not give false negatives when used in comparisons with other nucleotide sequences. Thus, for example, if an organism does not provide a fingerprint matching a group of interest then it is 100% certain it is not in the group of interest.
   The reason for doing this is the likely use of our methods in surveillance—it is much better to have the occasional false positive that can be subject to more detailed examination, than it is to have a false negative which results in something dangerous being missed.
   Thus, if the group of interest is G, A, C and the rest of the nucleotide sequences are G, A at a polymorphic site, then there is no way to avoid false negatives. Therefore, the polymorphic sites of this form are avoided.
(4) Group of interest: GA: The rest GT: Coded as “not T”;
(5) Group of interest: G; The rest: GAC” Coded as “not AC”.

Using this system, it is extremely easy to calculate the discriminatory power of any site or combinations of sites. Thus, for example, if a site is coded “not GA”, then the discriminatory power is a function of the proportion of sequences outside the group of interest that have a G or an A at that site.

A major application of the programs described above is to make use of multi-locus sequence typing databases, which may be used, for example, for bacterial typing.

In order to function in this manner, it is assumed that recombination with bacterial species occurs frequently enough to re-assort alleles more quickly than new alleles evolve through mutation. Therefore, obtaining sequence information at multiple widely spaced loci is necessary to obtain reliable typing information that can be used to track clones or clonal complexes within species.

In this case, the system operates to determine SNPs that discriminate sequence types. This entails merging information from multiple loci and this may be achieved in two main ways.

The first is by constructing a mega-alignment. The mega-alignment merges the information from multiple sequence alignments at the program input stage. Each nucleotide sequence type is converted to a single sequence composed of all the allele sequences (individual nucleotide sequences) arranged end to end. The sequences derived from all the sequence types are then aligned.

These techniques yield an alignment that has as many members as there are sequence types and is as long as all the nucleotide sequences added together. The mega-alignment can be used as input into any program designed to extract informative SNPs from sequence alignments and the SNPs that emerge will discriminate sequence types rather than individual alleles.

The second technique is to use output stage methods. In this case, the data from multiple sequence alignments can be merged at the output stage. This is not as straightforward as the mega-alignment method and entails making use of SNPs defined at each separate allele.

The steps involved in testing a combination of SNPs for their power to discriminate a particular sequence type are:
(1) determine the total number of individual alleles defined by the SNPs (if the SNPs are perfectly discriminatory, that will only be the alleles of interest.);
(2) assemble a complete list of the sequence types that can be defined by these alleles (i.e. every possible combination of these alleles);
(3) determine which of these sequence types is listed in the database, and removal of the other “virtual” sequence types from consideration. The discriminatory power is a function of the ratio of number of sequence types that remain and the total number of sequence types.

A variant of this approach that allows the determination of the discriminatory power of a collection of SNPs for a number of different sequence types is described in more detail below and in the Examples.

Another variant of this approach can be used to find SNPs that have a generalized ability to discriminate sequence types. Thus SNPs of this form are not designed to find a specified sequence type but simply determine if the target material is of the same or different sequence type.

The steps involved in assessing the power of SNPs to do this are:—
(1) converting of each allele in the database to a SNP-allele: an allele defined only by interrogating the SNPs;
(2) converting all the sequence types in the database to SNP-types using the SNP alleles;
(3) calculating the index of discrimination from the list of SNP types. (Since the sequence types are normally stated only once in the database, the index of discrimination on the sequence types list is 1.0, i.e. it is certain that two different sequence types will be different).

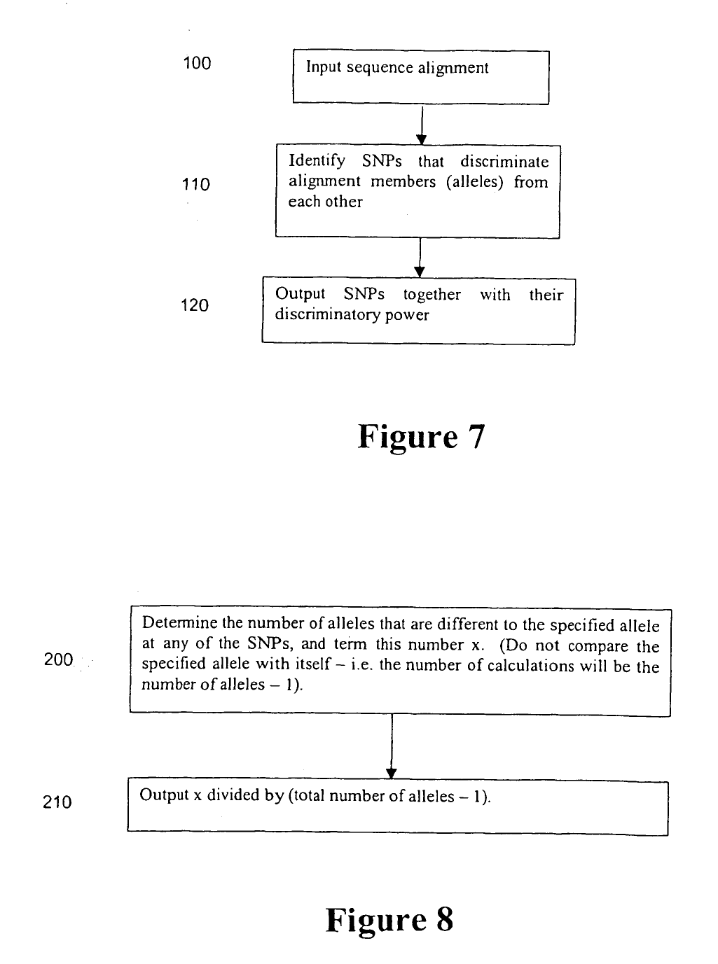

The manner in which the processing system 10 performs the above-described functionality is described with reference to the flow charts in FIGS. 7 to 18.

The present invention is further described by the following non-limiting Examples. Example 1 provides the source codes.

### EXAMPLE 2

### General Processing

As shown in FIG. 7, the general process of comparing nucleotide sequences contained in a sequence alignment to obtain informative SNPs. This is achieved by first inputting the nucleotide sequence alignment of interest into the processing system 10 at step 100. As mentioned briefly above, this may be achieved by manual input using the I/O device 22, or via the interface 23.

The processing system then operates to determine SNPs that discriminate the nucleotide sequences with the sequence alignment at step 110. This step will also involve determining the discriminatory power of each located SNP, as will be described in more detail below. In any event, the manner in which this is achieved will vary depending on the type of analysis of interest and in particular depending on whether the processor 20 of the processing system 10 is executing an allele program or a generalized program, as outlined above.

However, in general the processor will operate to compare the allele of interest to all other alleles in the alignment one at a time. An example of this is set out below. In this case, the alleles in the sequence alignment are shown in Table 34, with the allele in row 1 being the allele of interest.

TABLE 34

| | Position | | | | | | | | | | |
|---|---|---|---|---|---|---|---|---|---|---|---|
| Allele | 1 | 2 | 3 | 4 | 5 | 6 | 7 | 8 | 9 | 10 | SEQ ID NO: |
| 1 | G | A | T | C | G | T | T | C | G | C | 7 |
| 2 | G | A | T | G | A | T | A | G | G | C | 8 |
| 3 | G | A | T | A | A | T | A | C | G | A | 9 |
| 4 | G | A | T | G | C | A | T | G | G | T | 10 |

Thus at a first pass the processor 20 compares the nucleotide at the first position of the allele of interest with the nucleotide in the corresponding position of the allele in row 2. Thus, the nucleotide in row 1, column 1, is compared with the nucleotide in row 2, column 1. In this case, the nucleotides are identical, and this is therefore not an SNP. This is repeated for each position in the allele, with the respective SNPs being as shown in Table 35.

TABLE 35

| | | | | | | | | | | | SEQ |
|---|---|---|---|---|---|---|---|---|---|---|---|
| | Position | | | | | | | | | | ID |
| Allele | 1 | 2 | 3 | 4 | 5 | 6 | 7 | 8 | 9 | 10 | NO: |
| 1 | G | A | T | C | G | T | T | C | G | C | 11 |
| 2 | G | A | T | G | A | T | A | G | G | D | 12 |
| | | | | SNP | SNP | | SNP | SNP | | | |

Accordingly, the SNPs that distinguish alleles 1 and 2 occur at positions-4, 5, 7 and 8 respectively.

Similarly, the results for alleles 3 and 4 are as shown in Table 36.

TABLE 36

| | Position | | | | | | | | | | |
|---|---|---|---|---|---|---|---|---|---|---|---|
| Allele | 1 | 2 | 3 | 4 | 5 | 6 | 7 | 8 | 9 | 10 | SEQ ID NO: |
| 1 | G | A | T | C | G | T | T | C | G | C | 13 |
| 2 | G | A | T | G | A | T | A | G | G | C | 14 |
| | | | | SNP | SNP | | SNP | SNP | | | |
| 3 | G | A | T | A | A | T | A | C | G | A | 15 |
| | | | | SNP | SNP | | SNP | | | SNP | SNP |
| 4 | G | A | T | G | C | A | T | G | G | T | 16 |
| | | | | SNP | SNP | SNP | | SNP | | SNP | SNP |

Accordingly, the overall SNPs for the allele 1 with respect to the alignment consisting of alleles 1, 2, 3, 4 occur at the positions 4, 5, 6, 7 and 10, as shown in Table 37.

TABLE 37

| | Position | | | | | | | | | | |
|---|---|---|---|---|---|---|---|---|---|---|---|
| Allele | 1 | 2 | 3 | 4 | 5 | 6 | 7 | 8 | 9 | 10 | SEQ ID NO: |
| 1 | G | A | T | C | G | T | T | C | G | C | 17 |
| | | | | SNP | SNP | SNP | SNP | SNP | | SNP | |

The discriminatory power of the SNPs can then be determined. To highlight this it can be seen that the SNPs for allele 1 will be able to distinguish the allele from different ones of the alleles 2, 3, 4. Thus, for example, the SNP at position 4 uniquely distinguishes the allele 1. This means that examining the fourth nucleotide of the allele of interest allows a determination to be made that the allele is not allele 2, 3 or 4.

In contrast, the SNP at position 6 only allows the allele 1 to be distinguished from the allele 4. Thus, examining the sixth nucleotide in the allele will only allow a determination to be made that the allele is not allele 4 (although it could still be either allele 2 or allele 3).

Accordingly, the SNP at location 4 has a higher discriminatory power than the SNP at location 6, as it allows the allele of interest to be distinguished from a greater number of alleles. The actual calculation of discriminatory power will be described in more detail below.

In any event, an indication of the SNPs, together with an indication of their discriminatory power is then output by the processing system at step 120. The output may be via either the I/O device 22, or via the interface 23, depending on the implementation. This allows the user of the processing system 10 to use the determined SNPs and their discriminatory power in subsequent analysis, as will be appreciated by those skilled in the art.

### EXAMPLE 3

### Discriminatory Power

The manner of determining the discriminatory power of single SNPs or groups of SNPs in “specified allele” programs (i.e. to determine if an allele of interest is different from each of the other alleles in the sequence alignment) is described with reference to FIG. 8.

First, as shown at step 200, the processing system operates to determine the number of alleles that are different to the allele of interest, based on the one or more SNPs. This determined value is hereinafter referred to as “x”.

The processing system then generates an output based on:—

$$\frac{x}{( total number of alleles - 1 )}$$

Thus, for the example, outlined above the discriminatory power of the SNPs is as shown in Table 38.

TABLE 38

| | Position | | | | | | | | | | SEQ ID |
|---|---|---|---|---|---|---|---|---|---|---|---|
| | 1 | 2 | 3 | 4 | 5 | 6 | 7 | 8 | 9 | 10 | NO: |
| Allele 1 | G | A | T | C | G | T | T | C | G | C | 18 |
| Discriminatory | | | | 1 | 1 | 1/3 | 2/3 | 2/3 | | 2/3 | |
| power | | | | | | | | | | | |

Thus, in this example, the SNPs at positions 4, 5 have the highest discriminatory power.

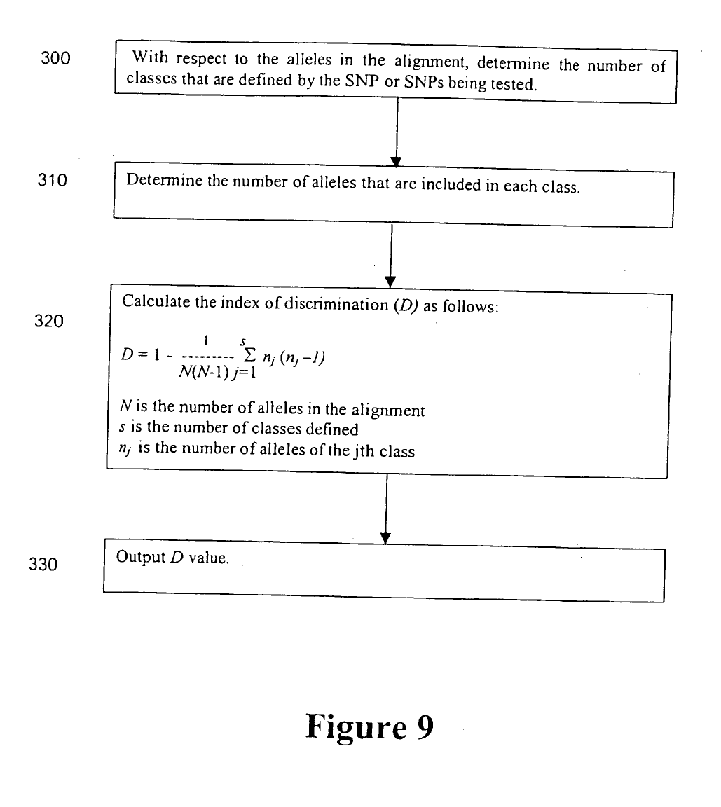

The manner in which the discriminatory power of single SNPs or groups of SNPs in “generalised” programs is determined will now be described with reference to FIG. 9.

In this example, the processor operates to determine the number of classes that are defined by the SNP being tested, at step 300. Thus, for example, in the above described example, the SNP in position 10 defines three classes, namely a first class for which the nucleotide is “C”, a second class for which the nucleotide is “A” and a third class for which the nucleotide is “T”.

At step 310, the processor determines the number of alleles in each class. Thus, the first class includes alleles 1 and 2, whilst the second and third classes contain alleles 3 and 4 respectively.

The index of discrimination is then determined at step 320 using the following equation:—

$$D = 1 - \frac{1}{N ( N - 1 )} {\sum }_{j = 1}^{s} {n}_{j} ( {n}_{j} - 1 )$$

where:
N is the number of alleles in the alignment;
s is the number of classes defined;
nⱼ is the number of sequences of the jth class.

Thus, the index of discrimination in this example is determined by:
D=1−1/(4×3)×[2(1)+1(0)+1(0)]
D=1−1/12×2
D=5/6

Thus, the value of D is 5/6.

The processor 20 outputs the value of D, which represents the discriminatory power of the respective SNP, at step 330. In fact, the value of D represents the probability that any two different alleles chosen at random will be identical for the SNP being tested.

In any event, the actual equation used may be subject to variation. Thus, for example, another suitable equation is as follows:—

$$D = 1 - \frac{1}{{N}^{2}} {\sum }_{j = 1}^{s} {n}_{j}^{2}$$

### EXAMPLE 4

### Identification of SNPs

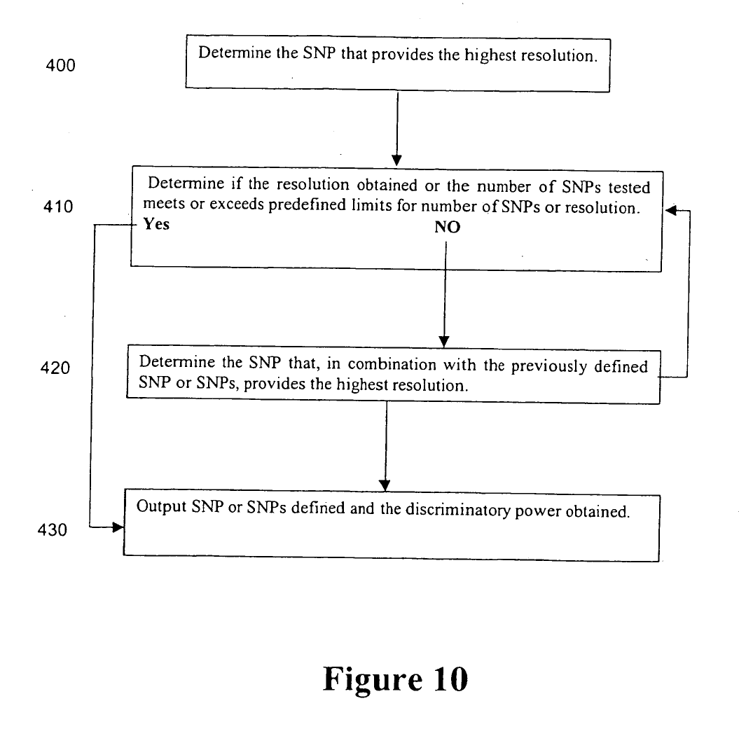

The method by which useful SNPs are found using the anchored method is described with reference to FIG. 10.

At step 400, the processor 20 determines the SNP that provides the highest resolution, i.e. the SNP with the highest discriminatory power.

At step 410, the discriminatory power of the SNP, or the number of SNPs tested, is compared to a predetermined threshold, typically stored either in the memory 21, or the database 12. In any event, the threshold is used to indicate whether the allele is sufficiently resolved, or whether a suitable number of SNPs are now included.

If the threshold is not exceeded, the processor 20 proceeds to step 420 to determine the SNP that, in combination with the previously defined SNP or SNPs, provides the next highest resolution. The processor then returns to step 410 to perform the comparison step again. Once the comparison is successful, the processor proceeds to step 430 to output the SNP or SNPs together with the determined discriminatory power.

### EXAMPLE 5

### Identification of SNPs

It will be realised that the technique described in this Example can be applied to both specified and non-specified allele programs.

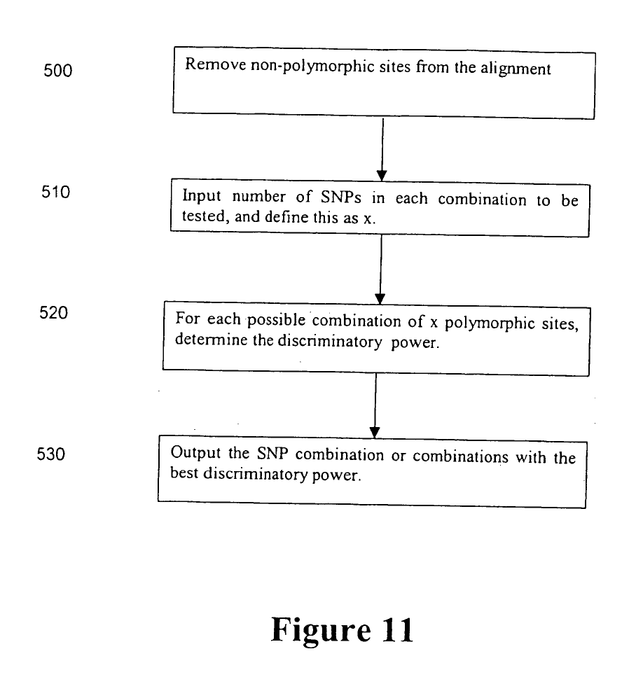

FIG. 11 is a flow diagram showing the procedure for finding useful SNPs by the complete method. In this example, the processor 20 first operates to eliminate non-polymorphic sites from the alignment. Accordingly, the processor only examines the polymorphic sites in this portion of the method.

Once this has been completed, the user of the end station provides an indication of the number of SNPs to be considered in each group, at step 510. Thus, in the above example, the total number of SNPs for the allele 1 is 6. Accordingly, the user may enter a value of two or three, causing the processor to determine either three or two sub-sets of SNPs, respectively.

Thus, for example, if the value of “x” is 2, the processor may determine sub-sets of SNPs as follows:

Sub-set 1-SNPs from positions 4 and 5

Sub-set 2-SNPs from positions 6 and 7

Sub-set 3-SNPs from positions 8 and 10

The processor then determines the discriminatory power of each sub-set at step 520, and this can be achieved in a number of ways. First, the techniques outlined above for determining the discriminatory power of a single SNP can also be applied to each sub-set. Alternatively, the discriminatory power of the sub-set can be based on the discriminatory power of each SNP in the sub-set.

In any event, the processor 20 then generates an output indicating the sub-set having the highest discriminatory power, together with an indication of the discriminatory power, at step 530.

Whilst this is the simplest method of generating combinations of SNPs for testing, with large alignments that computation required can become prohibitive. Accordingly, it is sometimes preferable to perform an initial screening process to eliminate some of the SNPs.

This can be performed by simply comparing the discriminatory power of each SNP to a threshold and then eliminating each SNP whose discriminatory power falls below the threshold.

### EXAMPLE 6

### Sequence Alignment

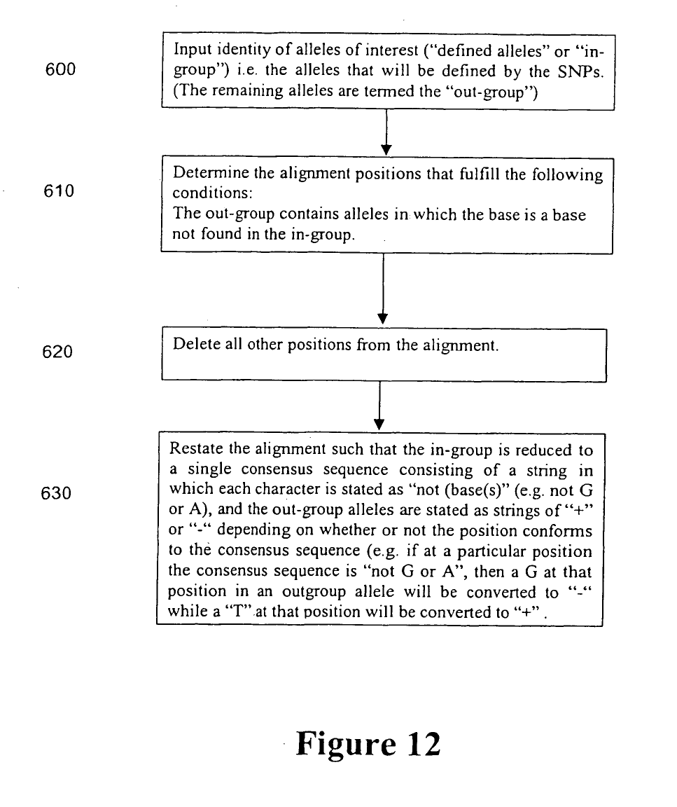

The manner in which the a sequence alignment may be transformed for the purpose of defining SNPs that define a group of alleles rather than a single allele is described with reference to FIG. 12.

First, the user provides an indication of the alleles of interest to the processor 20 at step 600. At step 610 the processor examines each nucleotide position in turn to determine any positions for which a nucleotide in the out-group is not present in the in group.

Thus, in the case of the example described above, if it desired to define a group containing alleles 1 and 3, then the out-group contains alleles 2 and 4. In this case, for example, at position 4, alleles 1 and 3 have “C” and “A” nucleotides, respectively. In contrast, alleles 2 and 4 have nucleotides “G”. Accordingly, the position can be defined as not “G”.

Any other positions are deleted from the alignment at step 620 resulting in the SNP group shown in Table 39 below.

TABLE 39

| | | | | | | | | | | | SEQ |
|---|---|---|---|---|---|---|---|---|---|---|---|
| | Position | | | | | | | | | | ID |
| Allele | 1 | 2 | 3 | 4 | 5 | 6 | 7 | 8 | 9 | 10 | NO: |
| 1 | G | A | T | C | G | T | T | C | G | C | 19 |
| 2 | G | A | T | G | A | T | A | G | G | C | 20 |
| 3 | G | A | T | A | A | T | A | C | G | A | 21 |
| 4 | G | A | T | G | C | A | T | G | G | T | 22 |
| SNPs | | | | not G | not C | not A | | not G | | not | |
| | | | | | | | | | | T | |

The alignment is then restated at step 630, resulting in an alignment of the form shown.

A transformed alignment is shown in Table 40.

TABLE 40

Pos. No.

| out-group | 4 | 5 | 6 | 10 |
|---|---|---|---|---|
| alleles | Not G | Not C | Not A | Not T |
| 2 | − | + | + | + |
| 4 | − | − | − | − |

The symbol “−” denotes a mis-match between the consensus sequence and the member of the out-group—it is a base that the consensus sequence is not. The symbol “+” denotes a match between the consensus sequence and the member of the out-group.

Positions 1-3 and 7-9 have been deleted from the alignment because they do not meet the condition that a base is present in the out-group that is not present in the in-group.

The discriminatory power of a SNP or group of SNPs will be the number of out-group alleles that have a “−” at at least one of the SNPs divided by the total number of out-group alleles.

It can be seen here that the discriminatory power of position 4 is 1 (2/2) while the discriminatory power of positions 5, 6 and 10 is 0.5 (1/2).

The output from this procedure can be used as input to “defined allele” programs. The consensus sequence is the defined allele and the out-group sequences are identical at “+” positions and not identical at “−” positions.

In certain circumstances, an alignment might be so diverse that the procedure will be unable to identify SNPs. In this situation, the out-group is divided into subsets such that all positions are not detected and then the procedure is repeated a number of times. This yields several different subsets of SNPs, each of which discriminates the in-group from a subset of the out-group.

### EXAMPLE 7

### Identification of SNPs

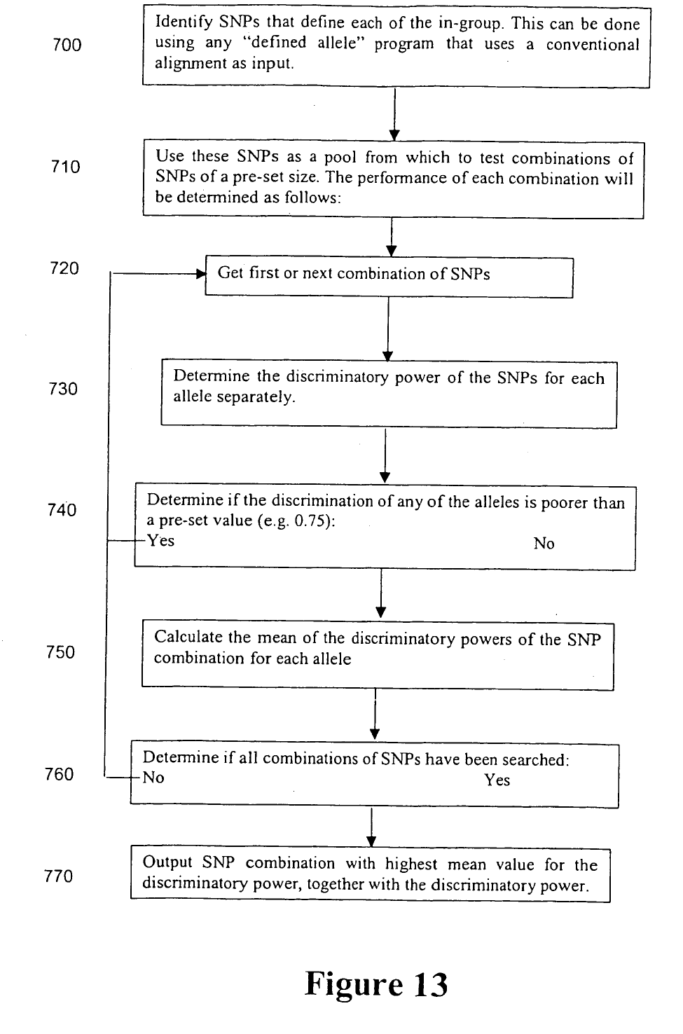

The procedure identifying SNPs that both define a group of interest and discriminate the members of the group of interest from each other is described with reference to FIG. 13.

As shown, at step 700, the processor identifies SNPs that define each of the alleles to be included in the in-group, and this is typically achieved using a defined allele program.

These determined SNPs are then used as a pool from which sub-sets of SNPs can be selected, at step 710. This is, therefore, similar to the technique outlined above with respect to FIG. 11 above. Once the sub-set has been determined, the discriminatory performance of each combination is determined.

In order to do this, the processor 20 selects a first combination of SNPs at step 720, before determining the discriminatory power of the set of SNPs for each allele separately at step 730. This is performed using the techniques outlined above with respect to FIG. 3 or 4.

If the discrimination power of any of the alleles is determined to be poorer than a pre-set value, such as 0.75, at step 740, the processor returns to step 720 and selects a different set of SNPs. Otherwise, the processor calculates the mean discriminatory power of the SNP combination for each allele at step 750.

The processor determines if all the sets of SNPs have been considered at step 760 and if not returns to step 720 to consider the next SNP set. Otherwise, the processor moves on to step 770 to output the SNP set having the highest mean value for the discriminatory power, together with an indication of the discriminatory power.

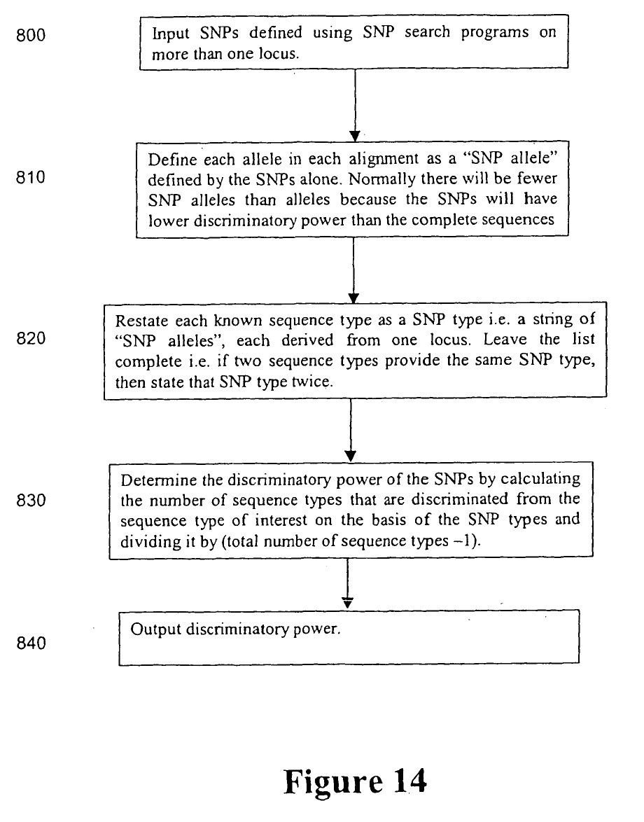

The “Defined sequence type/SNP-type” procedure for combining the results of SNP search procedures from several different loci is shown in FIG. 14.

In this mode of operation, the processor 20 is adapted to receive SNPs defined using SNP search programs operating on more than one locus, at step 800. At step 810, the processor defines each allele in each alignment as a “SNP allele” defined by the SNPs alone. Normally, there will be fewer SNP alleles than alleles because the SNPs will have lower discriminatory power than the complete sequences.

In any event, the processor 20 then restates each known sequence type as a SNP type i.e. a string of “SNP alleles”, each derived from one locus, at step 820. It should be noted that at this stage, it is important that the list is complete such that if two sequence types provide the same SNP type, then state the SNP type is included twice in the list.

Once the list has been defined, the processor determines the discriminatory power of the SNPs at step 830. This is determined by calculating the number of sequence types that are discriminated from the sequence type of interest on the basis of the SNP types. The resulting value is then divided by the total number of sequence types—1 (i.e. the total number of sequence types excluding the sequence under consideration).

The processor 20 then outputs the discriminatory power.

It will be noted that this technique provides the power of a set of SNPs derived from more than one locus to discriminate a pre-defined sequence type from all other sequence types. This can be used as a stand-alone program to test SNPs derived from single locus programs, or ideally, incorporated into a program that deals with several alignments simultaneously and tests SNPs as they emerge from single locus programs.

### EXAMPLE 8

### Generalized/SNP-Type Procedure

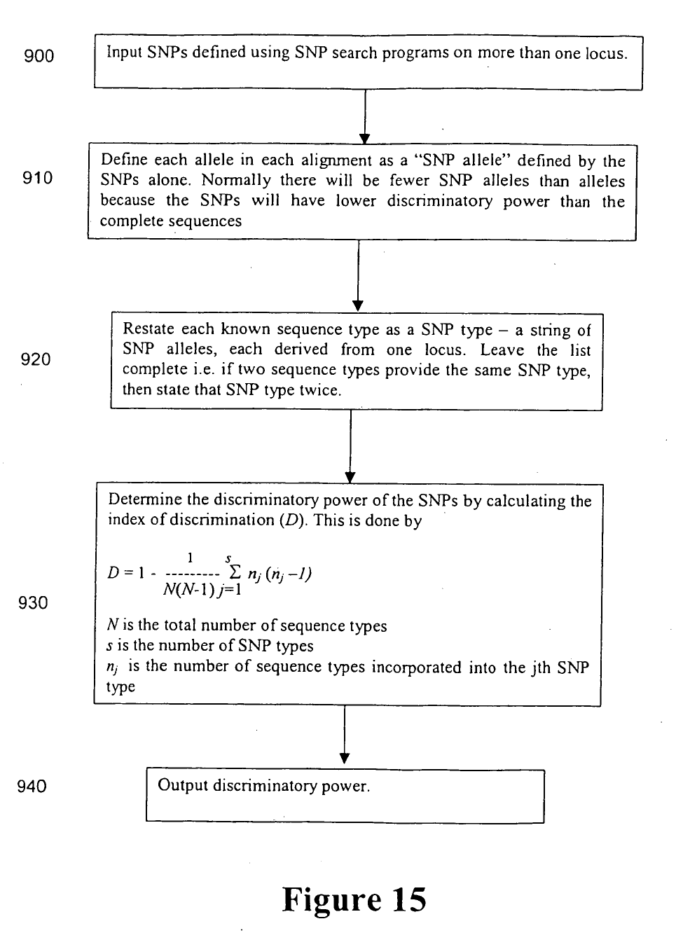

The “Generalized/SNP-type” procedure for combining the results of SNP search procedures from several different loci is shown in FIG. 15. This is similar to the generalized technique for determining the discriminatory power of individual SNPs, as described above with respect to FIG. 9.

Accordingly, in this example, processor is adapted to receive input SNPs defined using SNP search programs on more than one locus at step 900. The processor 20 then operates to define each allele in each alignment as a “SNP allele” defined by the SNPs alone. Again, as in the example of FIG. 14, there will normally be fewer SNP alleles than alleles because the SNPs will have lower discriminatory power than the complete sequences.

At step 920, the processor restates each known sequence type as a SNP type—a string of SNP alleles, each derived from one locus. Again, the list is retained in a complete form with duplicate SNP types being included on the list multiple times.

At step 930, the processor 20 determines the discriminatory power of the SNPs by calculating the index of discrimination (D) using the equation:

$$D = 1 - \frac{1}{N ( N - 1 )} {\sum }_{j = 1}^{s} {n}_{j} ( {n}_{j} - 1 )$$

where:
N is the total number of sequence types;
s is the number of SNP types; and
nⱼ is the number of sequence types incorporated into the jth SNP type

It will be noted that this technique provides the discriminatory power of a set of SNPs derived from more than one locus to discriminate sequence types from each other (i.e. there is no pre-defined SNP type of interest). This can be used as a stand-alone program to test SNPs derived from single locus programs, or ideally, incorporated into a program that deals with several alignments simultaneously and tests SNPs as they emerge from single locus programs.

### EXAMPLE 9

### Mega-Alignment

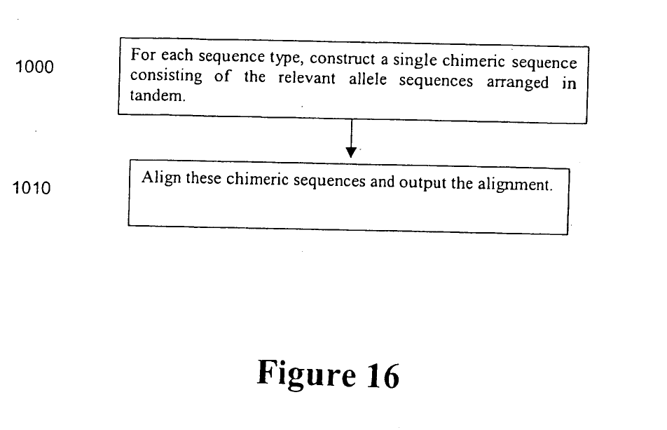

The procedure for converting allele and sequence type data into a single alignment (known as a mega-alignment) is shown in FIG. 16.

In this case, at step 1000, the processor operates to construct a single chimeric sequence consisting of all the relevant allele sequences arranged in tandem. The processor aligns the chimeric sequences, at step 1010, to allow a single sequence to be output.

It will be noted that the generated alignment will have as many members as there are sequence types. This alignment may therefore be used as input into any “single locus” program and the result will be SNPs that can discriminate one or more sequence types. If this procedure is used, there is no need to need to use any “SNP-type” programs to merge data from several loci, as the information from multiple loci is merged at the input rather than the output stage.

An example is shown in Tables 41 and 42 where comparisons are made between known locus 1 alleles and known locus II alleles.

TABLE 41

| | Position | | | | | |
|---|---|---|---|---|---|---|
| Allele | 1 | 2 | 3 | 4 | 5 | SEQ ID NO: |
| 1 | G | T | A | T | C | 23 |
| 2 | G | T | C | T | C | 24 |
| 3 | A | T | C | T | A | 25 |

TABLE 42

| | Position | | | | | |
|---|---|---|---|---|---|---|
| Allele | 1 | 2 | 3 | 4 | 5 | SEQ ID NO: |
| 1 | A | A | A | G | G | 26 |
| 2 | A | T | A | G | G | 27 |

A mega-alignment is shown in Table 43. In practice, there would usually be more than two loci and the length of sequence and the number of alleles from each locus would be much greater.

TABLE 43

| Position | | | | | | | | | | |
|---|---|---|---|---|---|---|---|---|---|---|
| 1 | 2 | 3 | 4 | 5 | 6 | 7 | 8 | 9 | 10 | SEQ ID NO: |
| G | T | A | T | C | A | A | A | G | G | 28 |
| G | T | C | T | C | A | A | A | G | G | 29 |
| G | T | C | T | C | A | T | A | G | G | 30 |
| A | T | C | T | A | A | T | A | G | G | 31 |

### EXAMPLE 44

### Highly Discriminatory Alleles

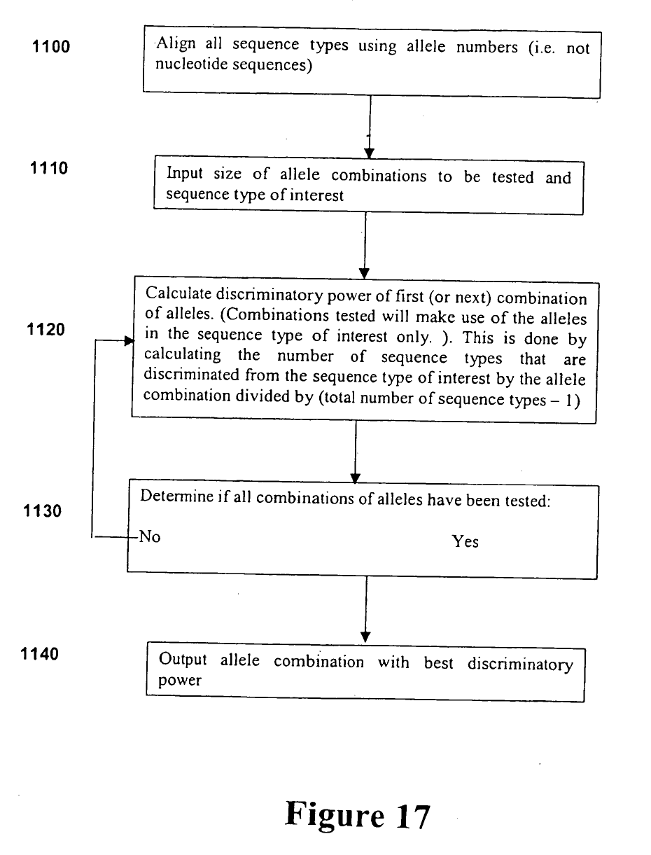

The procedure for extracting highly discriminatory alleles from sequence types is shown in FIG. 17.

At step 1100, the processor 20 operates to align all sequence types using allele numbers, as opposed to using the nucleotide sequences themselves. At step 1110, the user provides the processor 20 with an indication of size of allele combinations to be tested and the sequence type of interest.

The next stage is for the processor to calculate the discriminatory power of the next combination of alleles, at step 1120. Thus, the alleles are effectively divided into sub-sets, allowing the discriminatory power of each sub-set to be determined in a similar fashion to the dividing of the SNPs into sub-sets in FIG. 11.

The allele combinations tested will make use of the alleles in the sequence type of interest only. This is done by calculating the number of sequence types that are discriminated from the sequence type of interest by the allele combination divided by (total number of sequence types-1).

At step 1130 the processor determines if all the allele combinations have been tested and if not returns to step 1120. Otherwise, the processor compares the determined discriminatory power for each allele combination and outputs an indication of the allele combination having the best discriminatory power, at step 1140.

It may be that excellent resolving power can be obtained using a subset of loci in a multilocus database. The method outlined in FIG. 17 enables the determination of the “best” subset of loci to use. The alleles that emerge from this can then be used as input for single locus SNP search programs. This is unnecessary if a mega-alignment is constructed; if a mega-alignment is used as input into a single-locus SNP search program, then data as to the power of using a subset of loci is, in most cases, generated automatically. There is no point using an anchored method version of this program, because the number of subsets to be tested is very small compared with subsets of sequence alignments.

### EXAMPLE 11

### Power of Defined SNPs

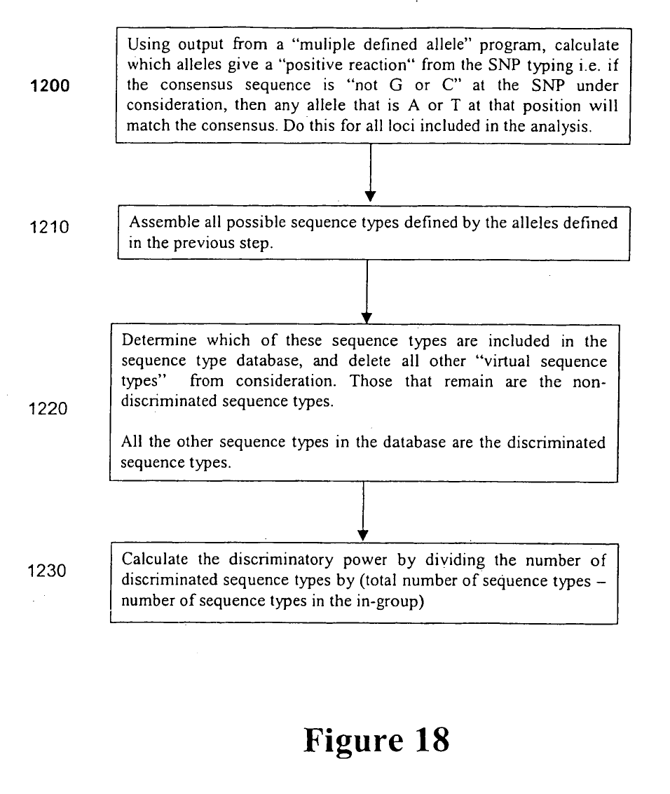

The procedure for determining the power of defined SNPs to discriminate multiple defined sequence types is shown in FIG. 18.

In this example, the processor 20 uses the output from a “multiple defined allele” program, the operation of which is described in FIG. 12, to calculate which alleles give a “positive reaction” from the SNP typing, at step 1200. Thus, if the consensus sequence is “not G or C” at the SNP under consideration, then any allele that is A or T at that position will match the consensus. This is repeated for all loci included in the analysis.

Once completed, the processor 20 operates to assemble all possible sequence types defined by the alleles determined in the previous step, at step 1210.

At step 1220, the processor determines which of these sequence types are included in the sequence type database, and deletes all other “virtual sequence types” from consideration. The remaining sequences are non-discriminated sequence types.

At step 1230, the processor 30 calculates the discriminatory power by dividing the number of discriminated sequence types by (total number of sequence types—number of sequence types in the in-group).

Accordingly, this allows the calculation of discriminatory power with respect to groups of sequence types.

It will be noted that this operation assumes that the alleles of interest at each locus have been extracted from an alignment of sequence types, and then discriminatory SNPs for these groups of alleles determined using the consensus sequence method.

This program is unnecessary if the mega-alignment is used, since in that case the data from multiple loci are combined at the input stage, rather than at the output stage as described here.

### EXAMPLE 12

### Distributed Architecture

It will be appreciated that a number of variations on the system outlined herein exist. Thus, for example, the techniques described could be implemented using a distributed architecture to allowing individuals to use the services provided by the processing system 10 from remote end stations or the like.

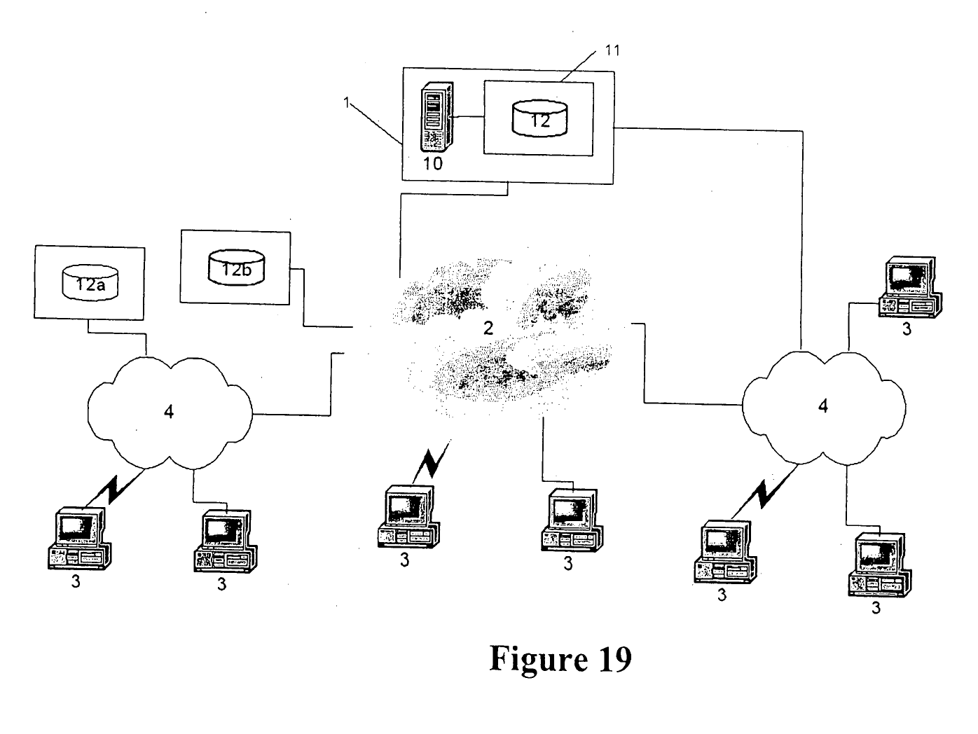

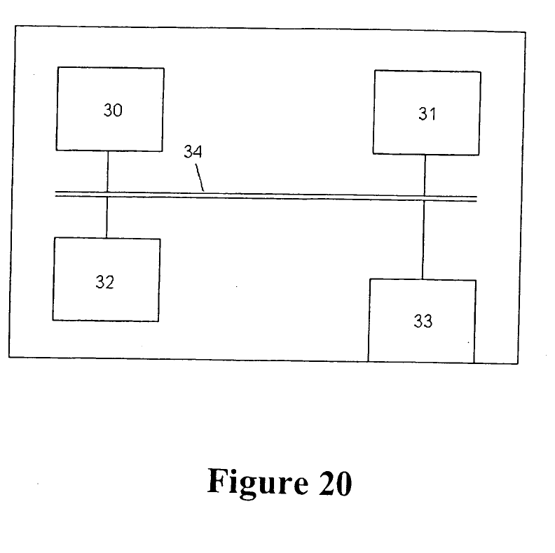

An example of a system suitable for doing this is shown in FIG. 19. As shown, the system includes a base station 1 coupled to a number of end stations 3 via a communications network 2 and/or via a number of local area networks (LANs) 4. The base station 1 is generally formed from one or more of the processing systems 10, as shown.

In use, users of the end stations 3 can access services provided by the processing system 10, which are described above. It will, therefore, be appreciated that the system may be implemented using a number of different architectures. However, in this example, the communications network 2 is the Internet 2, with the LANs 4 representing private LANs, such internal LANs within a company or the like.

In this case, the services provided by the base station 1 are generally made accessible via the Internet 2 and accordingly, the processing systems 10 may be capable of generating web-pages or like that can be viewed by the users of the end stations 3. Although, additionally information can be transferred between the end station 3 and the base station 1 using other techniques as represented by the dotted line. These other techniques may include transferring data in a hard, or printed format, as well as transferring the data electronically on a physical medium, such as a floppy disk, CD-ROM, or the like, as will be explained in more detail below.

In this case, the processing system 10 will generally be formed from a server, such as a network server, web-server, or the like.

Similarly, the end stations 3 must generally be capable of co-operating with the base station 1 to allow browsing of web-pages, or the transfer of data in other manners. Accordingly, in this example, as shown in FIG. 15, the end station 3 is formed from a processing system including a processor 30, a memory 31, an input/output (I/O) device 32 and an interface 33 coupled together via a bus 34. The interface 33, which may be a network interface card, or the like, is used to couple the end station 3 to the Internet 2.

It will, therefore, be appreciated that the end station 3 may be formed from any suitable processing system, such as a suitably programmed PC, Internet terminal, lap-top, hand-held PC, or the like, which is typically operating applications software to enable web-browsing or the like.

Alternatively, the end station 3 may be formed from specialised hardware, such as an electronic touch sensitive screen coupled to a suitable processor and memory. In addition to this, the end station 3 may be adapted to connect to the Internet 2, or the LANs 4 via wired or wireless connections. It is also feasible to provide a direct connection between the base stations 1 and the end stations 3, for example, if the system is implemented as a peer-2-peer network.

In any event, in use the end stations 3 can be adapted to submit sequence alignments or the like to the base station 1 via the Internet 2, the LAN 4, or the like. The processing system 10 will then process the sequence alignment in a manner specified by the user of the end station 3, returning the result of the processing to the user. This, therefore, allows the user to submit alignments and obtain results of the processing using the end station 3.

A further possibility is for the processing system 10 to be able to access external databases, such as the databases 12A, 12B and obtain alignments or other sequences from these databases as required.

Accordingly, the above described techniques allow the system to:
use comparative sequence databases as surrogates for populations allowing the sequences can be analysed by statistical methods normally used on populations;
use alignments as surrogates of populations by including the frequency of isolation data in the alignment, i.e. if an allele x is isolated three times more often than allele y, then have three copies of allele x in the alignment for every copy of allele y,
use the application of the “index of discrimination” calculation to the mining of sequence alignments;
use an anchored method for finding informative SNPs;
use an algorithm for developing a consensus sequence out of multiple sequences of interest;
merge mulilocus information;
analyze comparative sequence data from higher organisms such as homosapiens and reveal, for example, new targets for genetic fingerprinting, and the mutations responsible for multi-gene genetic diseases and pre-dispositions;
use the techniques with amino-acid sequences as well as DNA sequences. This in turn allows typing by reverse translation back to the DNA sequence, as well as clarification of the relationships between structure and function of proteins and the identification of the key sequence differences that mediate function differences.

Persons skilled in the art will appreciate that numerous variations and modifications will become apparent. All such variations and modifications which become apparent to persons skilled in the art, should be considered to fall within the spirit and scope that the invention broadly appearing before described.

Thus, for example, the techniques can be used to mine the key differences of any multi-parametric data set (i.e. a data set in which the in which each object is described using multiple parameters and a large number of objects are compared) and not just biological sequences.

This allows the techniques to be used for multi-parametric statistical analysis. An example of this would be text analysis or cryptography in which word, letter or character frequencies from a large number of examples could be compared—and this could provide a fingerprint, based on the polymorphic sites, for a particular author or particular subject matter.

As the fingerprints can be used to identify documents, for example, form a respective source, the fingerprints can be used to monitor large numbers of transmissions and obtain information as the source and subject matter.

Similarly, the techniques can be used in the analysis of large numbers of parameters of large numbers of businesses to determine the key difference between e.g. successful and unsuccessful businesses. This information could be used to assess the value of a business, assess how close it is to best practice and predict movements in share value.

### EXAMPLE 13

### Identification of SNPs Diagnostic for Neisseria meningitidis Sequence Types 11 (ST-11) and 42 (ST-42)

The aims of this Example are two-fold:—
1. Identify SNPs that will allow the determination whether or not an unknown isolated N. meningitidis is sequence type 11; and
2. Identify SNPs that will allow the determination whether or not an unknown isolate of N. meningitidis is sequence type 42.

SNPs were identified using the following strategies:
A. Identification of SNPs specific for the alleles that make up the ST of interest, and then determination of the discriminatory power of these SNPs at the sequence type level. This method is semi-empirical, as it requires the testing of SNPs combinations at the sequence type level using the “identity check” function of the program.
B. The direct and single step identification of SNPs using a mega-alignment. In this strategy, the entire MLST database is converted into a single alignment, and discriminatory SNPs directly identified.
1. ST-11
A. Identification of SNPs specific for the alleles that make up the ST of interest, and then determination of the discriminatory power of these SNPs at the sequence type level.

Two highly discriminatory SNPs were identified using Strategy A. These SNPs are fumC435 and pdhC12.

The program output for these SNPs is as follows:

Discriminatory power: 98.1%

Alleles that share the same profile at each selected locus are as follows:

435: T,

>fumC3, >fumC22, >fumC23, >fumC28, >fumC29, >fumC33, >fumC43, >fumC63, >fumC73, >fumC78, >fumC86, >fumC94, >fumC111, >fumC120, >fumC125, >fumC132, >fumC141, >fumC142, >fumC146, >fumC150, >fumC155, >fumC156, >fumC157, >fumC158, >fumC189, >fumC190, >fumC191, >fumC195, >fumC200, >fumC211, >fumC224, >fumC228: of confidence 86.3%

12: C,

>pdhC4, >pdhC13, >pdhC14, >pdhC38, >pdhC45, >pdhC49, >pdhC58, >pdhC60, >pdhC74, >pdhC77, >pdhC94, >pdhC107, >pdhC118, >pdhC128, >pdhC134, >pdhC139, >pdhC141, >pdhC149, >pdhC150: of confidence 91.1%

Indistinguishable STs based on the above loci are as follows:

ST11, ST50, ST52, ST166, ST214, ST222, ST339, ST473, ST475, ST490, ST491, ST655, ST672, ST733, ST761, ST1025, ST1026, ST1160, ST1189, ST1190, ST1254, ST1270, ST1277, ST1278, ST1279, ST1333, ST1390, ST1605, ST1628, ST1639, ST1789, ST1860, ST1884, ST1936, ST1939, ST1966, ST1988, ST2001, ST2025, ST2031, ST2058, ST2140, ST2238, ST2274, ST2326.

STs in bold do not belong to ST-11 complex (3/45=6.7%).
B. The direct and single step identification of SNPs using a mega-alignment.

Twenty-five highly discriminatory SNPs were identified using Strategy B. These are:

pgm124: A, 95.2%; pdhC12: C, 97.9%; fumC435: T, 98.4%; gdh132: T, 98.7%; adk135: A, 98.8%; aroE352: A, 99.0%; abcZ27: T, 99.1%; gdh: G, 99.2%; abcZ366: C, 99.3%; abcZ375: G, 99.3%; adk29: G, 99.4%; adk189: C, 99.4%; adk371: A, 99.4%; aroE43: C, 99.5%; aroE126: C, 99.5%; aroE169: A, 99.6%; aroE207: C, 99.6%; gdh290: G, 99.7%; gdh339: T, 99.7%; pdhC201: C, 99.7%; pgm106: A, 99.8%; pgm276: C, 99.8%; pgm373: G, 99.9%; pgm430: G, 99.9%; pgm433: G, 100.0%.

The discriminatory power of the first three SNPs in combination was analyzed in more detail. The output from the program is as follows:

Alleles that share the same profile at each selected locus are as follows:

124: A,

>pgm_{—}6, >pgm_{—}19, >pgm_{—}23, >pgm_{—}24, >pgm_{—}52, >pgm_{—}53, >pgm_{—}71, >pgm_{—}72, >pgm_{—}73, >pgm_{—}89, >pgm_{—}100, >pgm_{—}101, >pgm_{—}102, >pgm_{—}103, >pgm_{—}163, >pgm_{—}181, >pgm_{—}195, >pgm_{—}198: of confidence 91.6%

12: C,

>pdhC4, >pdhC13, >pdhC14, >pdhC38, >pdhC45, >pdhC49, >pdhC58, >pdhC60, >pdhC74, >pdhC77, >pdhC94, >pdhC107, >pdhC118, >pdhC128, >pdhC134, >pdhC139, >pdhC141, >pdhC149, >pdhC150: of confidence 91.1%

435: T,

>fumC3, >fumC22, >fumC23, >fumC28, >fumC29, >fumC33, >fumC43, >fumC63, >fumC73, >fumC78, >fumC86, >fumC94, >fumC111, >fumC120, >fumC125, >fumC132, >fumC141, >fumC142, >fumC146, >fumC150, >fumC155, >fumC156, >fumC157, >fumC158, >fumC189, >fumC190, >fumC191, >fumC195, >fumC200, >fumC211, >fumC224, >fumC228: of confidence 86.3%

Indistinguishable group of STs based on the above loci are as follows:

ST11, ST50, ST52, ST166, ST214, ST339, ST473, ST475, ST491, ST655, ST672, ST733, ST761, ST1160, ST1189, ST1254, ST1277, ST1278, ST1279, ST1333, ST1390, ST1605, ST1628, ST1789, ST1860, ST1884, ST1936, ST1939, ST1966, ST1988, ST2001, ST2025, ST2031, ST2058, ST2238, ST2274, ST2326.

STs in bold do not belong to ST-11 complex (0/37=0%). By possessing the ST-11 specific nucleotide at these three SNPs, an isolate can be positively determined as belonging to the ST-11 complex with 100% specificity.

2. ST-42

A. Identification of SNPs specific for the alleles that make up the ST of interest, and then determination of the discriminatory power of these SNPs at the sequence type level.

Four highly discriminatory SNPs were identified using Strategy A. These are:

SNP 1: abcZ411

SNP 2: aroE455

SNP 3: fumC201

SNP 4: pdhC274

The program output is as follows:

Discriminatory power: 97.7%

Alleles that share the same profile at each selected locus are as follows:

411: T,

,abcZ3, >abcZ10, >abcZ22, >abcZ25, >abcZ26, >abcZ37, >abcZ44, >abcZ47, >abcZ48, >abcZ64, >abcZ85, >abcZ87, >abcZ100, >abcZ117, >abcZ141, >abcZ142, >abcZ145, >abcZ158, >abcZ171, >abcZ178, >abcZ182: of confidence 89.0%

455: A,

>aroE9, >aroE19, >aroE37, >aroE46, >aroE49, >aroE50, >aroE61, >aroE63, >aroE70, >aroE74, >aroE85, >aroE86, >aroE88, >aroE95, >aroE111, >aroE134, >aroE140, >aroE145, >aroE147, >aroE152, >aroE154, >aroE155, >aroE180, >aroE184, >aroE187, >aroE188, >aroE191, >aroE198, >aroE199, >aroE201, >aroE210, >aroE212, >aroE219, >aroE224: of confidence 85.3%

201: A,

>fumC4, >fumC5, >fumC6, >fumC7, >fumC8, >fumC9, >fumC10, >fumC11, >fumC20, >fumC25, >fumC28, >fumC29, >fumC31, >fumC32, >fumC33, >fumC37, >fumC45, >fumC47, >fumC50, >fumC53, >fumC56, >fumC57, >fumC59, >fumC64, >fumC65, >fumC69, >fumC72, >fumC79, >fumC87, >fumC89, >fumC91, >fumC93, >fumC94, >fumC96, >fumC102, >fumC106, >fumC108, >fumC110, >fumC121, >fumC122, >fumC125, >fumC131, >fumC132, >fumC134, >fumC137, >fumC138, >fumC139, >fumC142, >fumC143, >fumC144, >fumC145, >fumC153, >fumC154, >fumC162, >fumC170, >fumC171, >fumC177, >fumC178, >fumC180, >fumC181, >fumC184, >fumC186, >fumC188, >fumC192, >fumC193, >fumC194, >fumC195, >fumC197, >fumC198, >fumC201, >fumC202, >fumC203, >fumC204, >fumC210, >fumC212, >fumC216, >fumC217, >fumC219, >fumC226, >fumC227: of confidence 65.1%

274: T,

>pdhC4, >pdhC5, >pdhC6, >pdhC7, >pdhC8, >pdhC9, >pdhC10, >pdhC12, >pdhC28, >pdhC36, >pdhC58, >pdhC64, >pdhC72, >pdhC74, >pdhC75, >pdhC81, >pdhC94, >pdhC97, >pdhC103, >pdhC106, >pdhC110, >pdhC114, >pdhC116, >pdhC119, >pdhC125, >pdhC126, >pdhC127, >pdhC129, >pdhC132, >pdhC133, >pdhC135, >pdhC136, >pdhC138, >pdhC142, >pdhC156, >pdhC164, >pdhC166, >pdhC167, >pdhC172, >pdhC174, >pdhC177, >pdhC180, >pdhC181, >pdhC183, >pdhC193, >pdhC196, >pdhC198, >pdhC200, >pdhC201, >pdhC202, >pdhC203: of confidence 75.3%

Indistinguishable group of STs based on the above loci are as follows:

ST41, ST42, ST45, ST46, ST154, ST155, ST159, ST224, ST274, ST303, ST340, ST414, ST485, ST493, ST568, ST714, ST782, ST788, ST957, ST1091, ST1145, ST1153, ST1168, ST1200, ST1255, ST1285, ST1341, ST1351, ST1394, ST1403, ST1460, ST1467, ST1469, ST1480, ST1481, ST1732, ST1778, ST1823, ST1944, ST1957, ST1992, ST2078, ST2079, ST2081, ST2082, ST2083, ST2113, ST2136, ST2159, ST2162, ST2203, ST2211, ST2288, ST2314, ST2343.

STs in bold do not belong to ST-44 complex (13/55=23.6%)
B. The direct and single step identification of SNPs using a mega-alignment.

Eight highly discriminatory SNPs were identified using Strategy B. These are:

abcZ411: T, 88.4%; gdh129: T, 95.6%; abcZ423: C, 98.9%; aroE82: T, 99.5%; fumC9: G, 99.7%; pdhC129: A, 99.9%; adk21: T, 99.9%; gdh492: C, 100.0%.

The discriminatory power of the first four SNPs was analyszd in more detail:

The program output is as follows:

Indistinguishable group of STs based on the above loci are as follows:

ST42, ST280, ST412, ST657, ST1126, ST1168, ST1200, ST1238, ST2113, ST2136, ST2162, ST2288.

STs in bold do not belong to ST-44 complex (1/12=8.3%)

Both strategies for identifying SNPs specific for defined STs are useful However, the mega-alignment method is more direct, and in the case of the ST-42, gave superior results.

Only a small number of SNPs are needed to identify defined sequence types with a high degree of reliability.

These analyses were carried out using the entire N. meningitidis MLST database. Modified databases that reflect locality specific patterns of diversity could be used if desired.

Similar procedures can be used to identify SNPs diagnostic for any sequence type for any species for which there is comparative sequence data.

SNPs identified can be interrogated by any of a large number of methods. A real time PCR-based method is described in Example 14.

### EXAMPLE 14

### Development of an Allele-Specific Real-Time PCR Based Method for Interrogating SNPs Diagnostic for Neisseria meningitidis Sequence Types 11 (ST-11) and 42 (ST-42)

The aim is to develop an allele-specific real-time PCR based method for interrogating SNPs diagnostic for N. meningitidis ST-11 and ST-42. The rationale is that an efficient strategy to utilize SNPs identified by the data analysis methods enables development of single step methods for interrogating these SNPs. Therefore, in this example, a colony on a primary isolation plate could be subject to a rapid DNA extraction procedure, and the DNA then interrogated in a real-time PCR machine to determine the bases present at the SNPs of interest.

Allele specific PCR (sometimes known as kinetic PCR) has the advantage that there is no requirement for fluorescent probes. This method relies upon the reduction in initial amplification efficiency (and consequent increased Ct) when a primer is mismatched from its template at the 3′ end. The allele specific signal is represented as ΔCt, which is the different between the Ct values for the two allele specific reactions.

Four N. meningitis isolates known to be ST-8, ST-11, ST-32 and ST-42 were used.

All reactions were carried out in an Applied Biosystems ABI7000 using the manufacturer's SYBR Green master mix.

A loop-full of cells were suspended in ˜400 μL of TE and boiled for 6 mins to attenuate. The samples were spun at 13,200 rpm for 5 min and supernatant transferred to fresh Eppendorf tubes for use in subsequent assays.

TABLE 44
1X reaction

| Component | Volume | Final Concentration |
|---|---|---|
| 2X SYBR Green I MasterMix | 10 μL | 1X |
| Allele-specific primer | 1 μL | 0.25 μM |
| Consensus primer | 1 μL | 0.25 μM |
| Crude extract (template)^{a} | (1 μL) | |
| ddH₂O | 7 μL | |
| TOTAL | 20 μL | |

^{a}Template is added after 19 μL aliquots are made into each relevant well.

A minimum of two mastermix solutions (for a biallelic SNP) needs to be prepared. A minimum of one known ST is included as a positive control; H₂O is used in all negative template control (NTC) wells. If <55 reactions are needed, 8-well tubes are used; otherwise the 96-well plate is used.

Cycle Conditions:

A two-step PCR protocol was used as in Table 45, followed by dissociation from 60 to 95° C. for 20 mins.

TABLE 45

| Stage | Temperature | Time | Repeat |
|---|---|---|---|
| 1 | 50° C. | 2:00 | 1 |
| 2 | 95° C. | 10:00 | 1 |
| 3 | 95° C. | 0:15 | 40 |
| | 59° C. | 0:30 | |

Primer Sequences

TABLE 46

ST-11

| | | Primer | |
|---|---|---|---|
| Locus | Primer name | type | Primer sequence (5′ → 3′) |
| fumC | fumC435-T | AS | ACCATTCCCTGATGCTGGTTACT |
| | | | [SEQ ID NO: 32] |
| | fumC435-C | AS | CCATTCCCTGATGCTGGTTACC |
| | | | [SEQ ID NO: 33] |
| | fumC435-Rev | con- | CAGCAAGCCCAACTCAACG |
| | | sensus | [SEQ ID NO: 34] |
| pdhC | pdhC12-T | AS | CCTTTCAAGATGTCTTGTTCCGCA |
| | | | [SEQ ID NO: 35] |
| | pdhC12-C | AS | CTTTCAAGATGTCTTGTTCTGCG |
| | | | [SEQ ID NO: 36] |
| | pdhC12-For | con- | CGTGTTCTACTACATCACCCTGATG |
| | | sensus | [SEQ ID NO: 37] |

TABLE 47

ST-42

| | | Primer | |
|---|---|---|---|
| Locus | Primer name | type | Primer sequence (5′ → 3′) |
| abcZ | abcZ411-T | AS | CAAGTTCGACAATCCGCGTA |
| | | | [SEQ ID NO: 38] |
| | abcZ411-C | AS | CGAGTTCGACAATCCGCGTG |
| | | | [SEQ ID NO: 39] |
| | abcZ411-For | con- | CTTGGTCGTCATTACCCACGA |
| | | sensus | [SEQ ID NO: 40] |
| aroE | aroE455-A | AS | TGTATTCGATAACAGGGCGGATATT |
| | | | [SEQ ID NO: |
| | | | [SEQ ID NO: 41] |
| | aroE455-G | AS | TGTATTCGATAACGGGGCGGATATC |
| | | | [SEQ ID NO: 42] |
| | aroE455-For | con- | TGGGTATGCTGGTCGGTCA |
| | | sensus | [SEQ ID NO: 43] |
| fumC | fumC201-A | AS | CGACCCAATGCGAAGCA |
| | | | [SEQ ID NO: 44] |
| | fumC201-G | AS | CGACCCAATGCGAAGCG |
| | | | [SEQ ID NO: 45] |
| | fumC201-Rev | con- | GTAACGTCGTTGCCGAACACT |
| | | sensus | [SEQ ID NO: 46] |
| pdhC | pdhC274-C | AS | GGACCGTCATGACCTTGCAG |
| | | | [SEQ ID NO: 47] |
| | pdhC274-T | AS | GGACCGTCATGACCTTGCAA |
| | | | [SEQ ID NO: 48] |
| | pdhC274-For | con- | GAACGCTTCAACCGCCTG |
| | | sensus | [SEQ ID NO: 49] |

In all cases, the sign (i.e. whether it is positive or negative) of the ΔCt values was as expected.

TABLE 48
ΔCt values obtained from ST-11 specific reactions

| SNP | ST-11 isolates | Non ST-11^{a} isolates |
|---|---|---|
| fumC435 | +8.37 | −8.14 |
| pdhC12 | +10.88 | −18.35 |

^{a}Includes STs 8, 32 and 42.
+refers to ST-11 specific nucleotide.
−refers to any other nucleotide at SNP position.

The values listed are the means of at least three replicates of each reaction. In the case of the non-ST-11 data, each of ST-8, ST-32 and ST-42 were tested at least three times.

TABLE 49
ΔCt values obtained from ST-42 specific reactions

| SNP | ST-42 isolate | Non ST-42^{a} isolates |
|---|---|---|
| abcZ411 | +9.16 | −13.94 |
| aroE455 | +3.78 | −4.88 |
| fumC201 | +9.91 | −17.58 |
| pdhC274 | +16.06 | −10.11 |

^{a}Includes STs 8, 11 and 32.
+Refers to ST-42 specific nucleotide.
−Refers to any other nucleotide at SNP position.

The values listed are the means of at least three replicates of each reaction. In the case of the non-ST-42 data, each of ST-8, ST-32 and ST-42 were tested at least three times.

It can be seen from the ΔCt values that the SNP signal is very strong, with the ΔΔCt's ranging from approximately eight cycles to approximately 28 cycles. This experiment demonstrate it is possible to determine in a single step and with high degree of reliability 1. whether or not an unknown N. meningitidis isolate is ST-11 and ST-2. whether or not an unknown isolate is ST-42.

Similar procedures can be used to interrogate SNPs diagnostic for any sequence type of any species for which there is comparative sequence data.

### EXAMPLE 15

### Identification of SNPs with a Generalized Typing Ability in a Number of Bacterial Species

A useful application of SNP-based genotyping is to provide a genetic fingerprint that efficiently addresses the question: “are these two unknown isolates the same sequence type or different sequence types?” The best SNPs for carrying out this task are those that provide a high Simpson's Index of Discrimination. These are known as generalized SNPs.

The subject software package is able to identify groups of SNPs that provide a high index of discrimination with respect to sequence alignments.

In this example, MLST databases from a number of bacterial species were converted into mega-alignments, and then searched by the anchored method for groups of SNPs with high Simpson's Index of Discrimination values. Several alternate groups were identified for each species.

Using the subject software package, MLST data-bases from Helicobacter pylori, Campylobacter jejuni, Streptococcus pneumoniae, Streptococcus pyogenes, Enterococcus faecium, and Staphylococcus aureus were converted to mega-alignments. These mega-alignments were then searched for groups of SNPs that provided a high Simpson's Index of Discrimination.

In all cases, the limiting Simpson's Index of Discrimination was set to between 0.995 and 0.999, and the program asked to display 10 alternate sets of SNPs.

In the case of the Helicobacter pylori database, there appeared to several sequence ambiguities. This was addressed as follows.

Due to gaps/incorrect nucleotide lettering, some alterations were made to alleles belonging to Vac, Ppa and YphC loci before entering allele sequences into the Mega-alignment program.

Vac 27—extra C at base 21 removed.

Vac 76—extra T at base 75 removed.

Vac 97—extra T at base 82 removed.

A large section of allele Vac196 contains gaps. As the program cannot calculate D value SNPs with alleles of the wrong length, the consensus sequence determined from other alleles at this locus was inserted.

Ppa288 and 313 alleles—all N's were replaced with consensus sequence.

For 288: nts 35, 131, 230, 332.

For 313: nts 86, 179, 320.

None of these bases were resultant D value SNPs, and so the change of N to the most conserved base did not affect the output.

YphC alleles 286, 288, 310-315 contained 6 bases of missing sequence (whether gaps were deliberate or not is unknown) and these were filled in manually using the consensus sequence for this region.

The output from the program is as follows Helicobacter pylori

>atpA COMMENCES AT:1; >efp COMMENCES AT:628; >mutY COMMENCES AT:1038; >ppa COMMENCES AT:1458; >trpC COMMENCES AT:1856; >urei COMMENCES AT:2312; >vacA.COMMENCES AT:2897.

Diversity Measure Results:

<Identification Constraints>

Time Out: 1000 seconds.

Simpson Index: 0.999.

Maximum Number of Results: 10.

Excluded SNP's: None.

(1) 2221>>>trpC>>366: Index=0.71; 1316>>>mutY>>279: Index=0.8; 75>>>atpA>>75: Index=0.95; 1232>>>mutY>>195: Index=0.98; 12>>>atpA>>1; Index=0.98; 696>>>efp>>69: Index=0.99; 3124>>>vacA>>228: Index=0.9; 561>>>atpA>>561: Index=0.99; 576,>>atpA>>576: Index=0.99;

(2) 2221>>>trpC>>366: Index=0.71; 1316>>>mutY>>279: Index=0.89; 75>>>atpA>>75: Index=0.95; 1232>>>mutY>>195: Index=0.98; 12>>>atpA>>12: Index=0.98; 696>>>efp>>69: Index=0.99; 3124>>>vacA>>228: Index=0.99; 561>>>atpA>>561: Index=0.99; 834>>>efp>>207: Index=0.99;

(3) 2221>>>trpC>>366: Index=0.71; 1316>>>mutY>>279: Index=0.89; 75>>>atpA>>75: Index=0.95; 1232>>>mutY>>195: Index=0.98; 12>>>atpA>>12: Index=0.98; 696>>>efp>>69: Index=0.99; 3124>>>vacA>>228: Index=0.99; 561>>>atpA>>561: Index=0.99; 1220>>>mutY>>183: Index=0.99;

(4) 2221,>>trpC>>366: Index=0.71; 1316>>>mutY>>279: Index=0.89; 75>>>atpA>>75: Index=0.95; 1232>>>mutY>195: Index=0.98; 12>>>atpA>>12: Index=0.98; 696>>>efp>>69: Index=0.99; 3124>>>vacA>>228: Index=0.99; 561>>>atpA>>561: Index=0.99; 1241>>>mutY>>204: Index=0.99;

(5) 2221>>>trpC>>366: Index=0.71; 1316>>>mutY>>279: Index=0.89; 75>>>atpA>>75: Index=0.95; 1232>>>mutY>>195: Index=0.98; 12>>>atpA>>12: Index 0.98; 696>>>efp>>69: Index=0.99; 3124>>>vacA>>228: Index=0.99; 561>>>atpA>>561: Index=0.99; 2920>>>vacA>>24: Index=0.99;

(6) 2221>>>trpC>>366: Index=0.71; 1316>>>mutY>,279: Index=0.89; 75>>>atpA>>75: Index=0.95; 1232>>>mutY>>195: Index=0.98; 12>>>atpA>>12: Index=0.98; 696>>>efp>>69: Index=0.99; 3124>>>vacA>>228: Index=0.99; 561>>>atpA>>561: Index=0.99; 2959>>>vacA>>63: Index=0.99;

(7) 2221>>>trpC>>366: Index=0.71; 1316>>>mutY>,279: Index=0.89; 75,>>atpA>>75: Index=0.95; 1232>>>mutY>>195: Index=0.98; 12>>>atpA>>12: Index=0.98; 696>>>efp>>69: Index=0.99; 3124>>>vacA>>228: Index=0.99; 564>>>atpA>>564: Index=0.99; 576>>>atpA>>576: Index=0.99;

(8) 2221>>>trpC>>366: Index=0.71; 1316>>>mutY>>279: Index=0.89; 75>>>atpA>>75: Index=0.95; 1232>>>mutY>>195: Index=0.98; 12,>>atpA>>12: Index=0.98; 696>>>efp>>69: Index=0.99; 3124>>>vacA>>228: Index=0.99; 564>>>atpA>>564: Index=0.99; 11001>>mutY>,63: Index=0.99;

(9) 2221>>>trpC>>366: Index=0.71; 1316>>>mutY>>279: Index=0.89; 75>>>atpA>>75: Index=0.95; 1232>>>mutY>>195: Index=0.98; 12>>>atpA>>12: Index=0.98; 696>>>efp>>69: Index=0.99; 3124>>>vacA>>228: Index=0.99; 564>>>atpA>>564: Index=0.99; 1220>>>mutY>>183: Index=0.99;

(10) 2221>>>trpC>>366: Index=0.71; 1316>>>mutY>>279: Index=0.89; 75>>>atpA>>75: Index=0.95; 1232>>>mutY>>195: Index=0.98; 12>>>atpA>,12: Index=0.98; 696>>>efp>>69: Index=0.99; 3124>>>vacA>>228: Index=0.99; 564>>>atpA>>564: Index=0.99; 2920>>>vacA>>24: Index=0.99;

Campylobacter jejuni

>aspA COMMENCES AT:1; >glnA COMMENCES AT:478; >gltA COMMENCES AT:955; >glyA COMMENCES AT:1357; >pgm_COMMENCES AT:1864; >tkt_COMMENCES AT:2362; >uncA COMMENCES AT:2821; >aspA COMMENCES AT:1; >glnA COMMENCES AT:478; >gltA COMMENCES AT:955; >glyA COMMENCES AT:1357; >pgm_. COMMENCES AT:1864; >tkt_COMMENCES AT:2362; >uncA COMMENCES AT:2821.

Diversity Measure Results:

<Identification Constraints>

Time Out: 1000 seconds.

Simpson Index: 0.995.

Maximum Number of Results: 10.

Excluded SNP's: None.

(1) 2028>>>pgm_{—}>>165: Index=0.72; 174>>>aspA>>174: Index=0.85; 489>>>glnA>>12: Index=0.92; 1668>>>glyA>>312: Index=0.95; 2433>>>tkt_{—}>>72: Index=0.97; 966>>>gltA>>12: Index=0.98; 2823>>>uncA>>3: Index=0.98; 414>>>aspA>>414: Index=0.99; 1274>>>gltA>>320: Index=0.99; 2357>>>pgm_{—}>>494: Index=0.99;

(2) 2028>>>pgm_{—}>>165: Index=0.72; 174>>>aspA>>174: Index=0.85; 489>>>glnA>>12: Index=0.92; 1668>>>glyA>>312: Index=0.95; 2433>>>tkt_{—}>>72: Index=0.97; 966>>>gltA>>12: Index=0.98; 2823>>>uncA>>3: Index=0.98; 414>>>aspA>>414: Index=0.99; 2357>>>pgm_{—}>>494: Index=0.99; 1274>>>gltA>>320: Index=0.99;

(3) 2028>>>pgm_{—}>>165: Index=0.72; 174>>>aspA>>174: Index=0.85; 489>>>glnA>>12: Index=0.92; 1668>>>glyA>>312: Index=0.95; 2433)>>tkt_{—}>>72: Index=0.97; 966>>>gltA>>12: Index=0.98; 2823>>>uncA>>3: Index=0.98; 414>>>aspA>>414: Index=0.99; 3009>>>uncA>>189: Index=0.99; 510>>>glnA>>33: Index=0.99; 1274>>>gltA>>320: Index=0.99;

(4) 2028>>>pgm_{—}>>165: Index=0.72; 174>>>aspA>>174: Index=0.85; 489>>>glnA>>12: Index=0.92; 1668>>>glyA>>312: Index=0.95; 2433>>>tkt>>72: Index=0.97; 966>>>gltA>>12: Index=0.98; 2823>>>uncA>>3: Index=0.98; 414>>>aspA>>414: Index=0.99; 3009>>>uncA>>189: Index=0.99; 510>>>glnA>>33: Index=0.99; 1350>>>gltA>>396: Index=0.99;

(5) 2028>>>pgm_{—}>>165: Index=0.72; 174>>>aspA>>174: Index=0.85; 489>>>glnA>>12: Index=0.92; 1668>>>glyA>>312: Index=0.95; 2433>>>tkt_{—}>>72: Index=0.97; 966>>>gltA>>12: Index=0.98; 2823>,>uncA>>3: Index=0.98; 414>>>aspA>>414: Index=0.99; 3009)>>uncA>>189: Index=0.99; 510>>>glnA>>33: Index=0.99; 1860>>>glyA>>504: Index=0.99;

(6) 2028>>>pgm_{—}>>165: Index=0.72; 174>>>aspA>>174: Index=0.85; 489>>>glnA>>12: Index=0.92; 1668>>>glyA>>312: Index=0.95; 2433>>>tkt_{—}>>72: Index=0.97; 966>>>gltA>>12: Index=0.98; 2823>>>uncA>>3: Index=0.98; 414>>>aspA>>414: Index=0.99; 3009>>>uncA>>189: Index=0.99; 510>>>glnA>>33: Index=0.99; 2357>>>pgm_{—}>>494: Index=0.99;

(7) 2028>>>pgm_{—}>>165: Index=0.72; 174>>>aspA>>174: Index=0.85; 489>>>glnA>>12: Index=0.92; 1668>>>glyA>>312: Index=0.95; 2433>>>tkt_{—}>>72: Index=0.97; 966>>>gltA>>12: Index=0.98; 2823>>>uncA>>3: Index=0.98; 414>>>aspA>>414: Index=0.99; 3009>>>uncA>>189: Index=0.99; 585>>>glnA>>108: Index=0.99; 589>>>glnA>>112: Index=0.99;

(8) 2028>>>pgm_{—}>>165: Index=0.72; 174>>>aspA>>174: Index=0.85; 489>>>glnA>>12: Index=0.92; 1668>>>glyA>>312: Index=0.95; 2433>>>tkt_{—}>>72: Index=0.97; 966>>>gltA>>12: Index=0.98; 2823>>>uncA>>3: Index=0.98; 414>>>aspA>>414: Index=0.99; 3009>>>uncA>>189: Index=0.99; 585>>>glnA>>108: Index=0.99; 679>>>glnA>>202: Index=0.99;

(9) 2028>>>pgm_{—}>>165: Index=0.72; 174>>>aspA>>174: Index=0.85; 489>>>glnA>>12: Index=0.92; 1668>>>glyA>>312: Index=0.95; 2433>>>tkt_{—}>>72: Index=0.97; 966>>>gltA>>12: Index=0.98; 2823>>>uncA>>3: Index=0.98; 414>>>aspA>>414: Index=0.99; 3009>>>uncA>>189: Index=0.99; 585>>>glnA>>108: Index=0.99; 1274>>>gltA>>320: Index=0.99;

(10) 2028>>>pgm_{—}>>165: Index=0.72; 174>>>aspA>>174: Index=0.85; 489>>>glnA>>12: Index=0.92; 1668>>>glyA>>312: Index=0.95; 2433>>>tkt_{—}>>72: Index=0.97; 966>>>gltA>>12: Index=0.98; 2823>>>uncA>>3: Index=0.98; 414>>>aspA>>414: Index=0.99; 3009>>>uncA>>189: Index=0.99; 585>>>glnA>>108: Index=0.99; 1350>>>gltA>>396: Index=0.99.

Streptococcus pneumoneae

>aroE COMMENCES AT:1; >gdh_COMMENCES AT:406; >gki_COMMENCES AT:866; >recP COMMENCES AT:1349; >spi_COMMENCES AT:1799; >xpt_COMMENCES AT:2273; >aroE COMMENCES AT:1; >gdh_COMMENCES AT:406; >gki_COMMENCES AT:866; >recP COMMENCES AT:1349; >spi_COMMENCES AT:1799; >xpt_COMMENCES AT:2273.

Diversity Measure Results:

<Identification Constraints>

Time Out: 1000 seconds.

Simpson Index: 0.995.

Maximum Number of Results: 10.

Excluded SNP's: None.

(1) 2545>>>xpt_{—}>>273: Index=0.5; 1024>>>gki_{—}>>159: Index=0.74; 811>>>gdh_{—}>>406: Index=0.87; 1716>>>recP>>368: Index=0.93; 1890>>>spi_{—}>>92: Index=0.96; 2372>,>xpt_{—}>>100: Index=0.98; 17>>>aroE>>17: Index=0.98; 1115>>>gki_{—}>>250: Index=0.99; 387>>,aroE>>387: Index=0.99; 554>>>gdh_{—}>>149: Index=0.99;

(2) 2545>>>xpt_{—}>>273: Index=0.5; 1024>>>gki_{—}>>159: Index=0.74; 811>>>gdh_{—}>>406: Index=0.87; 1716>>>recP>>368: Index=0.93; 1890>>>spi_{—}>>92: Index=0.96; 2372>>>xpt_{—}>>100: Index=0.98; 17>>>aroE>>17: Index=0.98; 1115>>>gki_{—}>>250: Index=0.99; 387>>>aroE>>387: Index=0.99; 766>>>gdh_{—}>>361: Index=0.99;

(3) 2545)>>xpt_{—}>>273: Index=0.5; 1024>>>gki_{—}>>159: Index=0.74; 811,>>gdh_{—}>>406: Index=0.87; 1716)>>recP>>368: Index=0.93; 1890>>>spi_{—}>>92: Index=0.96; 2372>>>xpt_{—}>>100: Index=0.98; 17>>>aroE>>17: Index=0.98; 1115>>>gki_{—}>>250: Index=0.99; 387>>>aroE>>387: Index=0.99; 775>>>gdh_{—}>>370: Index=0.99;

(4) 2545,>>xpt_{—}>>273: Index=0.5; 1024>>>gki_{—}>>159: Index=0.74; 811>>>gdh_{—}>>406: Index=0.87; 1716>>>recP>>368: Index=0.93; 1890>>>spi_{—}>>92: Index=0.96; 2372>>>xpt_{—}>>100: Index=0.98; 17>>>aroE>>17: Index=0.98; 1115>>>gki_{—}>>250: Index=0.99; 387>>>aroE>>387: Index=0.99; 1359,>>recP>>11: Index=0.99;

(5) 2545,>>xpt_{—}>>273: Index=0.5; 1024>>>gki_{—}>>159: Index=0.74; 811>>>gdh_{—}>>406: Index=0.87; 1716>>>recP>>368: Index=0.93; 1890>>>spi_{—}>>92: Index=0.96; 2372>>>xpt_{—}>>100: Index=0.98; 17>>>aroE>>17: Index=0.98; 1115>>>gki_{—}>>250: Index=0.99; 387>>>aroE>>387: Index=0.99; 1470>>>recP>>122: Index=0.99;

(6) 2545>>>xpt_{—}>>273: Index=0.5; 1024>>>gki_{—}>159: Index=0.74; 811>>>gdh_{—}>>406: Index=0.87; 1716>>>recP>>368: Index=0.93; 1890>>>spi_{—}>>92: Index=0.96; 2372>>>xpt_{—}>>100: Index=0.98; 17>>>aroE>>17: Index=0.98; 1115>>>gki_{—}>>250: Index=0.99; 387>>>aroE>>387: Index=0.99; 2004,>>spi_{—}>>206: Index=0.99;

(7) 2545>>>xpt_{—}>>273: Index=0.5; 1024)>>gki_{—}>>159: Index=0.74; 811>>>gdh_{—}>>406: Index=0.87; 1716>>>recP)>368: Index=0.93; 1890>>>spi_{—}>>92: Index=0.96; 2372>>>xpt_{—}>>100: Index=0.98; 17>>>aroE>>17: Index=0.98; 1115>>>gki_{—}>>250: Index=0.99; 1470,>>recP>>122: Index=0.99; 106>>>aroE>>106: Index=0.99;

(8) 2545>;>xpt_{—}>>273: Index=0.5; 1024>>>gki_{—}>>159: Index=0.74; 811>>>gdh_{—}>>406: Index=0.87; 1716>>>recP>>368: Index=0.93; 1890>>>spi_{—}>>92: Index=0.96; 2372>>>xpt_{—}>>100: Index=0.98; 17,>>aroE>>17: Index=0.98; 1115>>>gki_{—}>>250: Index=0.99; 1470>>>recP>>122: Index=0.99; 387>>>aroE>>387: Index=0.99;

(9) 2545>>>xpt_{—}>>273: Index=0.5; 1024>>>gki_{—}>>159: Index=0.74; 811>>>gdh_{—}>>406: Index=0.87; 1716>>>recP>>368: Index=0.93; 1890>>>spi_{—}>>92: Index=0.96; 2372>>>xpt_{—}>>100: Index=0.98; 17>>>aroE>>17: Index=0.98; 1115>>>gki_{—}>>250: Index=0.99; 1470>>>recP>>122: Index=0.99; 554>>>gdh_{—}>>149: Index=0.99;

(10) 2545>>>xpt_{—}>>273: Index=0.5; 1024>>>gki_{—}>>159: Index=0.74; 811>>>gdh_{—}>>406: Index=0.87; 1716>>>recP>>368: Index=0.93; 1890,>>spi_{—}>>92: Index=0.96; 2372>>>xpt_{—}>>100: Index=0.98; 17>>>aroE>>17: Index=0.98; 1115>>>gki_{—}>>250: Index=0.99; 1470>>>recP>>122: Index=0.99; 766>>>gdh >>361: Index=0.99;

Streptococcus pyogenes

>gki_COMMENCES AT:1; >gtr_COMMENCES AT:499; >muri COMMENCES AT:949; >muts COMMENCES AT:1387; >recp COMMENCES AT:1792; >xpt_COMMENCES AT:2251; >gki_COMMENCES AT:1; >gtr_COMMENCES AT:499; >muri COMMENCES AT:949; >muts COMMENCES AT:1387; >recp COMMENCES AT:1792; >xpt_COMMENCES AT:2251.

Diversity Measure Results:

<Identification Constraints>

Time Out: 1000 seconds.

Simpson Index: 0.995.

Maximum Number of Results: 10.

Excluded SNP's: None.

(1) 408>>>gki_{—}>>408: Index=0.50; 426>>gki_{—}>>426: Index 0.75; 1917>>>recp>>126: Index=0.87; 1243>>>muri>>295: Index=0.93; 1421)>>muts>>35: Index=0.96; 513>>>gtr_{—}>>15: Index=0.97; 1144>>>muri>>196: Index=0.98; 1710>>>muts>>324: Index=0.98; 340>>>gki_{—}>>340: Index=0.98; 2088>>>recp>>297: Index=0.99; 30>>>gki_{—}>>30: Index=0.99; 2514>>xpt_{—}>>264: Index=0.99; 2350>>xpt_{—}>>100: Index=0.99; 1>>>gki_{—}>>1: Index=0.99;

(2) 408>>>gki_{—}>>408; Index=0.50; 426>>>gki_{—}>>426: Index=0.75; 1917>>>recp>>126: Index=0.87; 1243>>>muri>>295: Index=0.93; 1421>>>muts>>35: Index=0.96; 513>>>gtr_{—}>>15: Index=0.97; 1144>>>muri>>196: Index=0.98; 1710>>muts >>324: Index=0.98; 340>>>gki_{—}>>340: Index=0.98; 2088>>>recp>>297: Index=0.99; 30>>>gki_{—}>>30: Index=0.99; 2514>>>xpt_{—}>>264: Index=0.99; 2350>>>xpt_{—}>>100: Index=0.99; 2>>>gki_{—}>>2: Index=0.99;

(3) 408>>>gki_{—}>>408: Index=0.50; 426>>>gki_{—}>>426: Index=0.75; 1917>>>recp>>126: Index=0.87; 1243>>>muri>>295: Index=0.93; 1421>>>muts>>35: Index=0.96; 513>>gtr_{—}>>15: Index=0.97; 1144>>>muri>>196: Index=0.98; 1710>>>muts>>324: Index=0.98; 340>>>gki_{—}>>340: Index=0.98; 2088>>>recp>>297: Index=0.99; 30>>>gki_{—}>>30: Index=0.99; 2514>>>xpt_{—}>>264: Index=0.99; 2350>>>xpt_{—}>>100: Index=0.99; 3>>>gki_{—}>>3: Index=0.99;

(4) 408>>>gki_{—}>>408: Index=0.50; 426>>>gki_{—}>>426: Index=0.75; 1917>>>recp>>126: Index=0.87; 1243>>>muri>>295: Index=0.93; 1421>>>muts>>35: Index=0.96; 513>>>gtr_{—}>>15: Index=0.97; 1144>>>muri>>196: Index=0.98; 1710)>>muts>>324: Index=0.98; 340>>>gki_{—}>>340: Index=0.98; 2088>>>recp>>297: Index=0.99; 30>>>gki_{—}>>30: Index=0.99; 2514>>>xpt_{—}>>264: Index=0.99; 2350>>xpt_{—}>>100: Index=0.99; 4>>>gki_{—}>>4: Index=0.99;

(5) 408>>>gki_{—}>408: Index=0.50; 426>>>gki_{—}>>426: Index=0.75; 1917>>>recp>>26: Index=0.87; 1243>>>muri>>295: Index=0.93; 1421>>>Muts>>35: Index=0.96; 513>>>gtr_{—}>>15. Index=0.97; 1144>>>muri>>196: Index=0.98; 1710>>>muts>>324: Index=0.98; 340>>>gki_{—}>>340: Index=0.98; 2088>>>recp>>297: Index=0.99; 30>>>gki_{—}>>30: Index=0.99; 2514>>>xpt_{—}>>264: Index=0.99; 2350>>>xpt_{—}>>100: Index=0.99; 5>>>gki_{—}>>5: Index=0.99;

(6) 408>>gki_{—}>>408: Index=0.50; 426>>>gki_{—}>>426: Index=0.75; 1917>>>recp>>126: Index=0.87; 1243>>>muri>>295: Index=0.93; 1421>>>muts>>35: Index=0.96; 513>>>gtr_>)>15: Index=0.97; 1144>>>muri>>196: Index=0.98; 1710>>>muts>>324: Index=0.98; 340>>>gki_{—}>>340: Index=0.98; 2088>>recp>>297: Index=0.99; 30>>gki_{—}>>30: Index=0.99; 2514>>>xpt_{—}>>264: Index=0.99; 2350>xpt_{—}>>100: Index=0.99; 6>>>gki_{—}>>6: Index=0.99;

(7) 408>>gki_{—}>>408: Index=0.50; 426>>>gki_>)>426: Index=0.75; 1917>>recp>>126: Index=0.87; 1243>>>muri>>295: Index=0.93; 1421>>>muts>>35: Index=0.96; 513>>>gtr_{—}>>15: Index=0.97; 1144>>>muri>>196: Index 0.96; 1710>>>muts>>324: Index=0.98; 340>>>gki_{—}>>340: Index=0.98; 2088>>>recp>>297: Index=0.99; 30>>>gki_{—}>>30: Index=0.99; 2514>>>xpt_{—}>>264: Index=0.99; 2350>>>xpt_{—}>>100: Index=0.99; 7>>>gki_{—}>>7: Index=0.99;

(8) 408>>>gki_{—}>>408: Index=0.50; 426>>>gki_{—}>>426: Index=0.75; 1917>>>recp>>126: Index=0.87; 1243>>>muri>>295: Index=0.93; 1421>>>muts>>35: Index=0.96; 513>>>gtr_{—}>>15: Index=0.97; 1144>>>muri>>196: Index=0.98; 1710>>>muts>>324: Index=0.98; 340>>>gki_{—}>>340: Index=0.98; 2088>>>recp>>297: Index=0.99; 30,>>gki_{—}>>30: Index=0.99; 2514>>>xpt_{—}>>264: Index=0.99; 2350>>>xpt_{—}>>100: Index=0.99; 8>>>gki_{—}>>8: Index=0.99;

(9) 408,>>gki_{—}>>408: Index=0.50; 426>>>gki_{—}>>426: Index=0.75; 1917>>>recp>>126: Index=0.87; 1243>>>muri>>295: Index=0.93; 1421>>>muts>>35: Index=0.96; 513>>>gtr_{—}>>15: Index=0.97; 1144>>>muri>>196: Index=0.98; 1710>>>muts>>324: Index=0.98; 340>>>gki_{—}>>340: Index=0.98; 2088>>>recp>>297: Index=0.99; 30>>>gki_{—}>>30: Index=0.99; 2514>>>xpt_{—}>>264: Index=0.99; 2350>>>xpt_{—}>>100: Index=0.99; 9>>>gki_{—}>>9: Index=0.99;

(10) 408>>>gki_{—}>>408: Index=0.50; 426>>>gki_{—}>>426: Index=0.75; 1917>>>recp>>126: Index=0.87; 1243>>>muri>>295: Index=0.93; 1421>>>muts>>35: Index=0.96; 513>>>gtr_{—}>>15: Index=0.97; 1144>>>muri>>196: Index=0.98; 1710>>>muts>>324: Index=0.98; 340>>>gki_{—}>>340: Index=0.98; 2088>>>recp>>297: Index=0.99; 30>>>gki_{—}>>30: Index=0.99; 2514>>>xpt_{—}>>264: Index=0.99; 2350>>,xpt_{—}>>100: Index=0.99; 10>>>gki_{—}>>10: Index=0.99.

Enterococcus faecium

>AtpA COMMENCES AT:1; >Ddl COMMENCES AT:557; >Gdh COMMENCES AT:1022; >PurK COMMENCES AT:1552; >Gyd COMMENCES AT:2044; >PstS COMMENCES AT:2439; >AtpA COMMENCES AT:1; >Ddl COMMENCES AT:557; >Gdh COMMENCES AT:1022; >PurK COMMENCES AT:1552; >Gyd COMMENCES AT:2044; >PstS COMMENCES AT:2439.

Diversity Measure Results:

<Identification Constraints>

Time Out: 1000 seconds.

Simpson Index: 0.995.

Maximum Number of Results: 10.

Excluded SNP's: None.

(1) 188>>>AtpA>>188: Index=0.50; 1012>>>Ddl>>456: Index=0.74; 760>>>Ddl>>204: Index=0.84; 1990>>>PurK>>439: Index=0.89; 485>>>AtpA>>485: Index=0.93; 1552>>>PurK>>1: Index=0.95; 1243>>>Gdh>>222: Index=0.96; 314>>>AtpA>>314: Index=0.97; 2890>>>PstS>>452: Index=0.98; 107>>>AtpA>>107: Index=0.98; 2200>>>Gyd>>157: Index=0.98; 95>>>AtpA>>95: Index=0.99; 1381>>>Gdh>>360: Index=0.99; 2525>>>PstS>>87: Index=0.99; 1489>>>Gdh>>468: Index=0.99;

(2) 188>>>AtpA>>188: Index=0.50; 1012>>>Ddl>>456: Index=0.74; 760>>>Ddl>>204: Index=0.84; 1990>>>PurK>>439: Index=0.89; 485,>>AtpA>>485: Index 0.93; 1552>>>PurK>>1: Index=0.95; 1243,>>Gdh>>222: Index=0.96; 314>>>AtpA>>314: Index 0.97; 2890>>>PstS>>452: Index=0.98; 107>>>AtpA>>107: Index=0.98; 2200>,>Gyd>>157: Index=0.98; 95>>>AtpA>>95: Index=0.99; 1381,>,Gdh>>360: Index=0.99; 2525>>>PstS>>87: Index=0.99; 2075>>>Gyd>>32: Index=0.99;

(3) 188>>>AtpA>>188: Index=0.50; 1012>>>Ddl>>456: Index=0.74; 760>>>Ddl>204: Index=0.84; 1990>>>PurK>>439: Index=0.89; 485>>>AtpA>>485: Index=0.93; 1552>>>PurK>>1: Index=0.95; 1243>>>Gdh>>222: Index=0.96; 314>>>AtpA>>314: Index=0.97; 2890,>>PstS>>452: Index=0.98; 107>>>AtpA>>107: Index 0.98; 2200>>>Gyd>>157: Index=0.98; 95>>>AtpA>>95: Index=0.99; 1381>>>Gdh>>360: Index=0.99; 2525>>>PstS>>87: Index=0.99; 2811>>>PstS>>373: Index=0.99;

(4) 188>>>AtpA>>188: Index=0.50; 1012>>>Ddl>>456: Index=0.74; 760,>>Ddl>>204: Index=0.84; 1990>>>PurK>>439: Index=0.89; 485>>>AtpA>>485: Index=0.93; 1552>>>PurK>>>: Index=0.95; 1243>>>Gdh>>222: Index=0.96; 314>>>AtpA>>314: Index=0.97; 2890>>>PstS>>452: Index=0.98; 107>>>AtpA>>107: Index=0.98; 2200>>>Gyd>>157: Index=0.98; 95>>>AtpA>>95: Index=0.99; 1381>>>Gdh>>360: Index=0.99; 2525>>>PstS>>87: Index=0.99; 2835>>>PstS>>397: Index=0.99;

(5) 188>>>AtpA>>188: Index=0.50; 1012>>>Ddl>>456: Index=0.74; 760>>>Ddl>>204: Index=0.84; 1990>>>PurK>>439: Index=0.89; 485>>AtpA>>485: Index=0.93; 1552>>>PurK>>1: Index=0.95; 1243>>>Gdh>>222: Index=0.96; 314>>>AtpA>>314: Index=0.97; 2890>>>PstS>>452: Index=0.98; 107>>>AtpA>>107: Index=0.98; 2200>>>Gyd>>157: Index=0.98; 95>>>AtpA>>95: Index=0.99; 1489>>>Gdh>>468: Index=0.99; 1381>>>Gdh>>360: Index=0.99; 2525>>>PstS>>87: Index=0.99;

(6) 188>>>AtpA>>188: Index=0.50; 1012>>>Ddl>>456: Index=0.74; 760>>>Ddl>>204: Index=0.84; 1990>>>PurK>>439: Index=0.89; 485>>>AtpA>>485: Index=0.93; 1552>>>PurK>>1: Index=0.95; 1243>>>Gdh>>222: Index=0.96; 314>>>AtpA>>314: Index=0.97; 2890>>>PstS>>452: Index=0.98; 107>>>AtpA>>107: Index=0.98; 2200>>>Gyd>>157: Index=0.98; 95>>>AtpA>>95: Index=0.99; 1489>>>Gdh>>468: Index=0.99; 1735>>>PurK>>184: Index=0.99; 1381,>,Gdh>>360: Index=0.99; 323>>>AtpA>>323: Index=0.99;

(7) 188>>>AtpA>>188: Index=0.50; 1012>>>Ddl>>456: Index=074; 760>>>Ddl>>204: Index=0.84; 1990>>>PurK>>439: Index=0.89; 485>>>AtpA>>485: Index=0.93; 1552>>>PurK>>1: Index=0.95; 1243>>>Gdh>>222: Index=0.96; 314>>>AtpA>>314: Index=0.97; 2890>>>PstS>>452: Index=0.98; 107>>>AtpA>>107: Index=0.98; 2200>>>Gyd>>157: Index=0.98; 95>>>AtpA>,95: Index=0.99; 1489>>>Gdh>>468: Index=0.99; 1735>>>PurK>>184: Index=0.99; 1381,>>Gdh>>360: Index=0.99; 542>>>AtpA>>542: Index=0.99;

(8) 188>>>AtpA>>188: Index=0.50; 1012>>>Ddl>>456: Index=0.74; 760>>>Ddl>>204: Index=0.84; 1990>>>PurK>>439: Index=0.89; 485>>>AtpA>>485: Index=0.93; 1552>>>PurK>>1: Index=0.95; 1243>>>Gdh>>222: Index=0.96; 314>>>AtpA>>314: Index=0.97; 2890>>>PstS>>452: Index=0.98; 107>>>AtpA>>107: Index=0.98; 2200>>>Gyd>>157: Index=0.98; 95>>>AtpA>>95: Index=0.99; 1489>>>Gdh>>468: Index=0.99; 1735>>>PurK>>184: Index=0.99; 1381>>>Gdh>>360: Index=0.99; 1513>>>Gdh>>492: Index=0.99;

(9) 188>>>AtpA>>188: Index=0.50; 1012>>>Ddl>>456: Index=0.74; 760>>>Ddl>>204: Index=0.84; 1990>>>PurK>>439: Index=0.89; 485>>>AtpA>>485: Index=0.93; 1552>>>PurK>>1: Index=0.95; 1243>>>Gdh>>222: Index=0.96; 314>>>AtpA>>314: Index=0.97; 2890>>>PstS>>452: Index=0.98; 107>>>AtpA>>107: Index=0.98; 2200>>>Gyd>>157: Index=0.98; 95>>>AtpA>>95: Index=0.99; 1489>>>Gdh>>468: Index=0.99; 1735>>>PurK>>184: Index=0.99; 1381>>>Gdh>>360: Index=0.99; 2011>>>PurK>>460: Index=0.99;

(10) 188>>>AtpA>>188: Index=0.50; 1012>>>Ddl>>456: Index=0.74; 760>>>Ddl>>204: Index=0.84; 1990>>>PurK>>439: Index=0.89; 485>>>AtpA>>485: Index=0.93; 1552>>>PurK>>1: Index=0.95; 1243>>>Gdh>>222: Index=0.96; 314>>>AtpA>>314: Index=0.97; 2890>>>PstS>>452: Index=0.98; 107>>>AtpA>>107: Index=0.98; 2200>>>Gyd>>157: Index=0.98; 95>>>AtpA>>95: Index=0.99; 1489>>>Gdh>>468: Index=0.99; 1735>>>PurK>>184: Index=0.99; 1381>>>Gdh>>360: Index=0.99; 2014>>>PurK>>463: Index=0.99.

Staphylococcus Aureus

>arcC COMMENCES AT:1; >aroE COMMENCES AT:457; >glpF COMMENCES AT:913; >gmk_COMMENCES AT:1378; >pta_COMMENCES AT:1807; >tpi_COMMENCES AT:2281; >arcC COMMENCES AT:1; >aroE COMMENCES AT:457; >glpF COMMENCES AT:913; >gmk_COMMENCES AT:1378; >pta_COMMENCES AT:1807; >tpi_COMMENCES AT:2281.

Diversity Measure Results:

<Identification Constraints>

Time Out: 1000 seconds.

Simpson Index: 0.995.

Maximum Number of Results: 10.

Excluded SNP's: None.

(1) 210>>>arcC>>210: Index=0.51; 543>>>aroE>>87: Index=0.75; 1506>>>gmk_{—}>>129: Index=0.84; 162>>>arcC>>162: Index=0.89; 588)>>aroE>>132: Index=0.92; 2100>>>pta_{—}>>294: Index=0.93; 1827>>>pta_{—}>>21: Index=0.94; 2349>>>tpi_{—}>>69: Index=0.95; 2071>>>pta_{—}>>265: Index=0.96; 78>>>arcC>>78: Index=0.96; 1779>>>gmk_{—}>>402: Index=0.96; 610>>>aroE>>154: Index=0.96; 971>>>glpF>>59: Index=0.97; 1987>>>pta_{—}>>181: Index=0.97; 146>>>arcC>>146: Index=0.97; 165>>>arcC>>165: Index=0.97; 2367>>>tpi_{—}>>87: Index=0.97; 1>>>arcC>>1: Index=0.97;

(2) 210>>>arcC>>210: Index=0.51; 543>>>aroE>>87: Index=0.75; 1506>>>gmk_{—}>>129: Index=0.84; 162>>>arcC>>162: Index=0.89; 588>>>aroE>>132: Index=0.92; 2100>>>pta_{—}>>294: Index=0.93; 1827>>>pta_{—}>>21: Index=0.94; 2349>>>tpi_{—}>>69: Index=0.95; 2071>>>pta_{—}>>265: Index=0.96; 78>>>arcC>>78: Index=0.96; 1779>>>gmk_{—}>>402: Index=0.96; 610>>>aroE>>154: Index=0.96; 971>>>glpF>>59: Index=0.97; 1987>>>pta_{—}>>181: Index=0.97; 146>>>arcC>>146: Index=0.97; 165>>>arcC>>165: Index=0.97; 2367>>>tpi_{—}>>87: Index=0.97; 2>>>arcC>>2: Index=0.97;

(3) 210>>>arcC>>210: Index=0.51; 543>>>aroE>>87: Index=0.75; 1506>>>gmk_{—}>>129: Index 0.84; 162,>>arcC>>162: Index=0.89; 588,>>aroE>>132: Index=0.92; 2100>>>pta_{—}>>294: Index=0.93; 1827>>>pta_{—}>>21: Index=0.94; 2349>>>tpi_{—}>>69: Index=0.95; 2071>>>pta_{—}>>265: Index=0.96; 78>>>arcC>>78: Index=0.96; 1779>>>gmk_{—}>>402: Index=0.96; 610>>>aroE>>154: Index=0.96; 971>>>glpF>>59: Index=0.97; 1987>>>pta_{—}>>181: Index=0.97; 146>>>arcC>>146: Index=0.97; 165>>>arcC>>165: Index=0.97; 2367>>>tpi_{—}>>87: Index=0.97; 3>>>arcC>>3: Index=0.97;

(4) 210>>>arcC>>210: Index=0.51; 543>>>aroE>>87: Index=0.75; 1506>>>gmk_{—}>>129: Index=0.84; 162>>>arcC>>162: Index=0.89; 588>>>aroE>>132: Index=0.92; 2100>>>pta_{—}>>294: Index=0.93; 1827>>>pta_{—}>>21: Index=0.94; 2349,>,tpi_{—}>>69: Index=0.95; 2071>>>pta_{—}>>265: Index=0.96; 78>>>arcC>,78: Index=0.96; 1779>>>gmk_{—}>>402: Index=0.96; 610>>>aroE>>154: Index=0.96; 971>>>glpF>>59: Index=0.97; 1987>>>pta_{—}>>181: Index=0.97; 146>>>arcC>>146: Index=0.97; 165>>>arcC>>165: Index=0.97; 2367,>>tpi_{—}>>87: Index=0.97; 4>>>arcC>>4: Index=0.97;

(5) 210>>>arcC>>210: Index=0.51; 543>>>aroE>>87: Index=0.75; 25-1506>>>gmk_{—}>>129: Index=0.84; 162>>>arcC>>162: Index=0.89; 588>>>aroE>>132: Index=0.92; 2100>>>pta_{—}>>294: Index=0.93; 1827>>>pta_{—}>>21: Index=0.94; 2349>>>tpi_{—}>>69: Index=0.95; 2071>>>pta_{—}>>265: Index=0.96; 78>>>arcC>>78: Index=0.96; 1779>>>gmk_{—}>>402: Index=0.96; 610>>aroE>>154: Index=0.96; 971>>>glpF>>59: Index=0.97; 1987>>>pta_{—}>>181: Index=0.97; 146>>>arcC>>146: Index=0.97; 165>>>arcC>>165: Index=0.97; 2367>>>tpi_{—}>>87: Index=0.97; 5>>>arcC>>5: Index=0.97;

(6) 210>>>arcC>>210: Index=0.51; 543>>>aroE>>87: Index=0.75; 1506>>>gmk_{—}>>129: Index=0.84; 162>>>arcC>>162: Index=0.89; 588>>>aroE>>132: Index=0.92; 2100>>>pta_{—}>>294: Index=0.93; 1827>>>pta_{—}>>21: Index=0.94; 2349>>>tpi_{—}>>69: Index=0.95; 2071>>>pta_{—}>>265: Index=0.96; 78>>>arcC>>78: Index=0.96; 1779>>>gmk_{—}>>402: Index=0.96; 610>>>aroE>>154: Index=0.96; 971>>>glpF>>59: Index=0.97; 1987>>>pta_{—}>>181: Index=0.97; 146>>>arcC>>146: Index=0.97; 165>>>arcC>>165: Index=0.97; 2367>>>tpi_{—}>>87: Index=0.97; 6>>>arcC>>6: Index=0.97;

(7) 210>>>arcC>>210: Index=0.51; 543>>>aroE>>87: Index=0.75; 1506>>>gmk_{—}>>129: Index=0.84; 162>>>arcC>>162: Index=0.89; 588>>,aroE>>132: Index=0.92; 2100>>>pta->>294: Index=0.93; 1827>>>pta_{—}>>21: Index=0.94; 2349>>>tpi_{—}>>69: Index=0.95; 2071>>>pta_{—}>>265: Index=0.96; 78>>>arcC>>78: Index=0.96; 1779>>>gmk_{—}>>402: Index=0.96; 610>>,aroE>>154: Index=0.96; 971>>>glpF>>59: Index=0.97; 1987>>>pta_{—}>>181: Index=0.97; 146>>>arcC>>146: Index=0.97; 165>>>arcC>>165: Index=0.97; 2367>>>tpi_{—}>>87: Index=0.97; 7>>>arcC>>7: Index=0.97.

These results demonstrate for all the species of bacteria tested it is possible to identify multiple sets of SNPs that a provide high Simpson's index of diversity. This analysis can be applied to any comparative sequence data that can be aligned.

This analysis allows the rapid and facile design of high resolution genotyping assays.

In this instance, entire MLST databases were used as input. However, it would possible to more accurately simulate the population structure in a particular area omitting some sequence types and entering others more than once.

### EXAMPLE 16

### Development of a Real-Time PCR-Based Method for Generalized SNP-Based Typing of Neisseria meningitidis

This example demonstrates a single step real-time PCR procedure for interrogating a group of N. meningitidis SNPs with a high Simpson's Index of Diversity. This is a generalized genotyping procedure—it is applicable to all Neisseria meningitidis.

Seven SNPs identified using the anchored generalized procedure on a mega-alignment of the entire N. meningitidis database were used. These seven SNPs were: pgm93, aroE283, fumC114, abz183, abz54, gdh60 and pdhC103.

Six N. meningitis isolates were used. These were ST-8, ST-11, ST-32 and ST-42, and two unknowns (02M5007 and 02M5044).

All reactions were carried out in an Applied Biosystems ABI7000 using the manufacturer's SYBR Green master mix.

A loop-full of cells were suspended in ˜400 μL of TE and boiled for 6 mins to attenuate. The samples were spun at 13,200 rpm for 5 mins and supernatant transferred to fresh Eppendorf tubes for use in subsequent assays.

TABLE 50
For 1X reaction

| Component | Volume | Final Concentration |
|---|---|---|
| 2X SYBR Green I MasterMix | 10 μL | 1X |
| Allele-specific primer | 1 μL | 0.25 μM |
| Consensus primer | 1 μL | 0.25 μM |
| Crude extract (template)^{a} | (1 μL) | |
| ddH₂O | 7 μL | |
| TOTAL | 20 μL | |

^{a}Template is added after 19 μL aliquots are made into each relevant well.

For aroE283, two allele-specific oligonucleotides have been designed for the T polymorph to account for the two consensus allelic sequences for interrogation of this SNP. The schedule, therefore, is shown in Table 51:—

TABLE 51
For 1X reaction

| Component | Volume | Final Concentration |
|---|---|---|
| 2X SYBR Green I MasterMix | 10 μL | 1X |
| AS primer aroE283A-T | 0.5 μL | 0.125 μM |
| AS primer aroE283G-T | 0.5 μL | 0.125 μM |
| Consensus primer | 1 μL | 0.25 μM |
| Crude extract (template) | (1 μL) | Unknown |
| ddH₂O | 7 μL | |
| TOTAL | 20 μL | |

Primer design: all of the SNPs exist in more than two states, so it was necessary to design 3-4 allele specific primers per SNP.

TABLE 52

| | D | | |
|---|---|---|---|
| Locus | value | Primer name | Primer sequence (5′ → 3′) |
| pgm93 | 0.65 | Mega- | CCGCAATCCTAAAGCCAAAGTA |
| | | pgm93-A | [SEQ ID NO: 50] |
| | | Mega- | CCCGGCGCGAAAGTC |
| | | pgm93-C | [SEQ ID NO: 51] |
| | | Mega- | CCGCAATCCTAAAGCAAAAGTG |
| | | pgm93-G | [SEQ ID NO: 52] |
| | | Mega- | CCGCCGTGTTCTTTAATCCA |
| | | pgm93-Rev | [SEQ ID NO: 53] |
| aroE283 | 0.87 | Mega- | GGTCAGATTCCCGGTATTCCA |
| | | aroE283-A | [SEQ ID NO: 54] |
| | | Mega- | CAGCTTCCTGCCGTCAGC |
| | | aroE283-C | [SEQ ID NO: 55] |
| | | Mega- | GGTCAGATTCCCGATATTCCG |
| | | aroE283-G | [SEQ ID NO: 56] |
| | | Mega- | AGCTTCCGGCCGTCAAT |
| | | aroE283A-T | [SEQ ID NO: 57] |
| | | Mega- | GTCAGCTTCCTGCCGTCAGT |
| | | aroE283G-T | [SEQ ID NO: 58] |
| | | Mega- | CCGTACACCATATCGTAGGCAAG |
| | | aroE283-Rev | [SEQ ID NO: 59] |
| fumC114 | 0.93 | Mega- | TTCGCCCAAACCGCAG |
| | | fumC114-C | [SEQ ID NO: 60] |
| | | Mega- | TTCGCCCAAACCGCAA |
| | | fumC114-T | [SEQ ID NO: 61] |
| | | Mega- | AATCGCCAACGACATCCG |
| | | fumC114-For | [SEQ ID NO: 62] |
| abcZ183 | 0.96 | Mega- | GTTTTCTGGCAAACCAAGTTCA |
| | | abcZ183-T | [SEQ ID NO: 63] |
| | | Mega- | CCGGCAAACCGAGTTCG |
| | | abcZ183-C | [SEQ ID NO: 64] |
| | | Mega- | CCGGCAAACCGAGTTCC |
| | | abcZ183-G | [SEQ ID NO: 65] |
| | | Mega- | GAAGCGAAGGACGGCTGG |
| | | abcZ183-For | [SEQ ID NO: 66] |
| abcZ54 | 0.97 | Mega- | GCGATTTATTGCGCCGTTAC |
| | | abcZ54-C | [SEQ ID NO: 67] |
| | | Mega- | GCGATTTATTGCGCCGTTAT |
| | | abcZ54-T | [SEQ ID NO: 68] |
| gdh60 | 0.98 | Mega- | GCCGTCCTTCGCTTCGAT |
| | | abcZ54-Rev | [SEQ ID NO: 69] |
| pdhC103 | 0.99 | Mega- | CAGCTGACCATCGCCGAA |
| | | gdh60-A | [SEQ ID NO: 70] |
| | | Mega- | CAGCTGACCATCGCCGAG |
| | | gdh60-G | [SEQ ID NO: 71] |
| | | Mega- | TTTGCACCATATCGCGCA |
| | | gdh60-Rev | [SEQ ID NO: 72] |
| | | Mega- | CCGGCAATGACTTCTTGCAG |
| | | pdhC103-C | [SEQ ID NO: 73] |
| | | Mega- | CCGGCAATCACTTCTTGCAA |
| | | pdhC103-T | [SEQ ID NO: 74] |
| | | Mega- | AAAGGTATGTACCTGCTGAAAGCC |
| | | pdhC103-For | [SEQ ID NO: 75] |

Cycle Conditions

A two-step PCR protocol was used (Table 53), followed by dissociation from 60 to 95° C. for 20 mins.

TABLE 53

| Stage | Temperature | Time | Repeat |
|---|---|---|---|
| 1 | 50° C. | 2:00 | 1 |
| 2 | 95° C. | 10:00 | 1 |
| 3 | 95° C. | 0:15 | 40 |
| | 59° C. | 0:30 | |

For all the isolates of known genotype, the Ct for the perfectly matched primer was lower than for the mismatched, so the correct base was called. The ΔCt values are shown in the tables below. Because the majority of SNPs used were tri or tetra-allelic, each of the ΔCt values shown is the difference between the Ct for the matched primer reaction, and the Ct for mis-matched primer reaction that gave the lowest Ct, i.e. the least discriminatory mis-matched primer.

TABLE 54
pgm93

| ST | Nucleotide at SNP | ΔCt |
|---|---|---|
| ST-11 | G | 16.71 |
| ST-42 | A | 16.32 |
| ST-32 | G | 11.76 |
| ST-8 | C | 15.55 |
| 02M5007* | G | 15.16 |
| 02M5044* | G | 12.25 |

TABLE 55
aroE283

| ST | Nucleotide at SNP | ΔCt |
|---|---|---|
| ST-11 | G | 9.67 |
| ST-42 | T | 15.28 |
| ST-32 | G | 9.77 |
| ST-8 | T | 8.57 |
| 02M5007* | G | 11.7 |
| 02M5044* | C | 4.71 |

TABLE 56
fumC114

| ST | Nucleotide at SNP | ΔCt |
|---|---|---|
| ST-11 | C | 17.8 |
| ST-42 | T | 12.19 |
| ST-32 | T | 7.74 |
| ST-8 | C | 15.79 |
| 02M5007* | C | 17.55 |
| 02M5044* | T | 11.04 |

TABLE 57
abcZ183

| ST | Nucleotide at SNP | ΔCt |
|---|---|---|
| ST-11 | G | 14.66 |
| ST-42 | C | 17.96 |
| ST-32 | G | 12.31 |
| ST-8 | G | 16.12 |
| 02M5007* | G | 16.15 |
| 02M5044* | C | 11.75 |

TABLE 58
abcZ54

| ST | Nucleotide at SNP | ΔCt |
|---|---|---|
| ST-11 | C | 12.03 |
| ST-42 | C | 15.93 |
| ST-32 | T | 5.86 |
| ST-8 | C | 12.73 |
| 02M5007* | C | 5.97 |
| 02M5044* | C | 4.49 |

TABLE 59
gdh60

| ST | Nucleotide at SNP | ΔCt |
|---|---|---|
| ST-11 | G | 14.6 |
| ST-42 | G | 11.9 |
| ST-32 | G | 11.91 |
| ST-8 | G | 13.35 |
| 02M5007* | G | 10.53 |
| 02M5044* | A | 11.99 |

TABLE 60
pdhC60

| ST | Nucleotide at SNP | ΔCt |
|---|---|---|
| ST-11 | C | 12.72 |
| ST-42 | T | 14.06 |
| ST-32 | C | 12.42 |
| ST-8 | C | 12.46 |
| 02M5007* | C | 12.19 |
| 02M5044* | T | 12.1 |

These data provide the following SNP profiles (Table 61):

TABLE 61

| | pgm93 | aroE283 | fumC114 | abz183 | abz54 | gdh60 | pdh103 |
|---|---|---|---|---|---|---|---|
| ST-11 | G | G | C | G | C | G | C |
| ST-42 | A | T | T | C | C | G | T |
| ST-32 | G | G | T | G | T | G | C |
| ST-8 | C | T | C | G | C | G | C |
| 02M5007 | G | G | C | G | C | G | C |
| 02M5044 | G | C | T | C | C | A | T |

The profiles of the isolates of known sequence type are consistent with the MLST database. It can be seen that the profiles of the known sequence types are all different, thus illustrating the discriminatory power of these SNPs. With respect to the unknowns, the profile of 02M5007 is the same as the ST-11 isolate, while the profile of 02M5044 does not match the profiles ST-11, ST-42, ST-32 or ST-8.

The “identity check function” in our program was used to determine which STs have a profile identical to that of 02M5044. They are:

ST23, ST183, ST405, ST439, ST569, ST741, ST893, ST1062, ST1063, ST1187, ST1244, ST1264, ST1294, ST1317, ST1379, ST1488, ST1625, ST1652, ST1655, ST1657, ST1664, ST1686, ST1690, ST1703, ST1716, ST1736, ST1749, ST1756, ST1794, ST2053, ST2235,

This represents 1.3% of known sequence types, so 98.7% of sequence types have a different profile. Isolate 02M5044 is either one of these sequence types, or is a sequence type no included in the N. meningitidis database at the time the analysis was carried out.

A similar analysis was carried out with the profiles matching ST-11, ST-42, ST-32 and ST-8. In this case, only the % of known sequence types that have a different profile is shown. The results are:

| | |
|---|---|
| ST-11 | 97.7% |
| ST-42 | 97.3% |
| ST-32 | 98.0% |
| ST-8 | 99.4% |

This experiment demonstrates the reduction to practice of a single step real-time PCR procedure for generalized SNP-based typing methodology for N. meningitidis. The 7 SNPs used provide a Simpson's Index of Diversity of 0.99 with respect to the N. meningitidis MLST database. This methodology can be used to type any N. meningitidis isolate.

A similar strategy of SNP selection and interrogation can be used to develop typing methodologies for any species for which there is comparative gene sequence data.

### EXAMPLE 17

### Identification of SNPs Specific for Staphylococcus aureus ST-30

S. aureus, and in particular methicillin resistance S. aureus (MRSA), are important agents of infection both in health care facilities and in the general community. Therefore, this species is of interest to epidemiologists, and an MLST scheme has been assembled. In this example, ST-30 was designated as a sequence type of interest, and the “specified allele” function of our program were used to identify sets of SNPs diagnostic for this sequence type.

ST-30 was chosen because it is a widespread clone that may possibly be associated with community acquired infections.

In this instance, a mega-alignment-based strategy was used. The entire S. aureus MLST database was converted into a mega-alignment and then searched in a single step for SNPs diagnostic for ST-30. The program was asked to provide 10 alternative pathways to 100% discrimination.

The output from the program is as follows:—

| >arcC COMMENCES AT: 1; | | |
|---|---|---|
| >aroE COMMENCES AT: 457; | | |
| >glpF COMMENCES AT: 913; | | |
| >gmk_ COMMENCES AT: 1378; | | |
| >pta_ COMMENCES AT: 1807; | | |
| >tpi_ COMMENCES AT: 2281; | | |
| ST 30 Results: | | |
| ST 30 [SEQ ID NO: 76] | | |
| TTATTAATCCAACAAGCTAAATCGAACAGTGACACAACGCCGGCAATGCCATTGGATACTTGTGGTGCAATGT | | |
| CACAAGGTATGATAGGCTATTGGTTGG | | |
| AAACTGAAATCAATCGCATTTTAACTGAAATGAATAGTGATAGAACTGTAGGCACAATCGTAACACGTGTGGA | | |
| AGTAGATAAAGATGATCCACGATTTGA | | |
| TAACCCAACTAAACCAATTGGTCCTTTTTATACGAAAGAAGAAGTTGAAGAATTACAAAAAGAACAGCCAGGC | | |
| TCAGTCTTTAAAGAAGATGCAGGACGT | | |
| GGTTATAGAAAAGTAGTTGCGTCACCACTACCTCAATCTATACTAGAACACCAGTTAATTCGAACTTTAGCAG | | |
| ACGGTAAAAATATTGTCATTGCATGCG | | |
| GTGGTGGCGGTATTCCAGTTATAAAAAAAGAAAATACCTATGAAGGTGTTGAAGCGAATTTTAATTCTTTAGG | | |
| ATTAGATGATACTTATGAAGCTTTAAA | | |
| TATTCCAATTGAAGATTTTCATTTAATTAAAGAAATTATTTCAAAAAAAGAATTAGATGGCTTTAATATCACA | | |
| ATTCCTCATAAAGAGCGTATCATACCG | | |
| TATTTAGATCATGTTGATGAACAAGCGATTAATGCAGGTGCAGTTAACACTGTTTTGATAAAAGATGGCAAGT | | |
| GGATAGGGTATAATACAGATGGTATTG | | |
| GTTATGTTAAAGGATTGCACAGCGTTTATCCAGATTTAGAAAATGCATACATTTTAATTTTGGGAGCAGGTGG | | |
| TGCAAGTAAAGGTATTGCTTATGAATT | | |
| AGCAAAATTTGTAAAGCCCAAATTAACTGTTGCGAATAGAACGATGGCTCGTTTTGAATCTTGGAATTTAAAT | | |
| ATAAACCAAATTTCATTGGCAGATGCT | | |
| GAAAAGTATTTAGGTGCTGATTGGATTGTCATCACAGCTGGATGGGGATTAGCGGTTACAATGGGTGTGTATG | | |
| CTGTTGGTCAATTCTCAGGTGCACATT | | |
| TAAACCCAGCGGTGTCTTTAGCTCTTGCATTAGACGGAAGTTTTGATTGGTCATTAGTTCCTGGTTATATTGT | | |
| TGCTCAAATGTTAGGTGCAATTGTCGG | | |
| AGCAACAATTGTATGGTTAATGTACTTGCCACATTGGAAAGCGACAGAAGAAGCTGGCGCGAAATTAGGTGTT | | |
| TTCTCTACAGCACCGGCTATTAAGAAT | | |
| TACTTTGCCAACTTTTTAAGTGAAATTATCGGAACAATGGCATTAACTTTAGGTATTTTATTTATCGGTGTAA | | |
| ACAAAATTGCTGATGGTTTAAATCCTT | | |
| TAATTGTCGGAGCATTAATTGTTGCAATCGGATTAAGTTTAGGCGGTGCTACTGGTTATGCAATCAACCCAGC | | |
| ACGTCGAATATTTGAAGATCCAAGTAC | | |
| ATCATATAAGTATTCTATTTCAATGACAACACGTCAAATGCGTGAAGGTGAAGTTGATGGCGTAGATTACTTT | | |
| TTTAAAACTAGGGATGCGTTTGAAGCT | | |
| TTAATTAAAGATGACCAATTTATAGAATATGCTGAATATGTAGGCAACTATTATGGTACACCAGTTCAATATG | | |
| TTAAAGATACAATGGACGAAGGTCATG | | |
| ATGTATTTTTAGAAATTGAAGTAGAAGGTGCAAAGCAAGTTAGAAAGAAATTTCCAGATGCGTTATTTATTTT | | |
| CTTAGCACCTCCAAGTTTAGATCACTT | | |
| GAGAGAGCGATTAGTAGGTAGAGGAACAGAATCTGATGAGAAAATACAAAGTCGTATTAACGAAGCACGTAAA | | |
| GAAGTCGAAATGATGAATTTATACGAT | | |
| TACGTTGCAACACAATTACAAGCAACAGATTATGTTACACCAATCGTGTTAGGTGATGAGACTAAGGTTCAAT | | |
| CTTTAGCGCAAAAACTTAATCTTGATA | | |
| TTTCTAATATTGAATTAATTAATCCTGCGACAAGTGAATTGAAAGCTGAATTAGTTCAATCATTTGTTGAACG | | |
| ACGTAAAGGTAAAGCGACTGAAGAACA | | |
| AGCACAAGAATTATTAAACAATGTGAACTACTTCGGTACAATGCTTGTTTATGCTGGTAAAGCAGATGGTTTA | | |
| GTTAGTGGTGCAGCACATTCAACAGGC | | |
| GACACTGTGCGTCCAGCTTTACAAATCATCAAAACGAAACCAGGTGTATCAAGAACATCAGGTATCTTCTTTA | | |
| TGATTAAAGGTGATGAACAGTACATCT | | |
| TTGGTGATTGTGCAATCAATCCAGAACTTGATTCACAAGGACTTGCAGAAATTGCAGTAGAAAGTGCAAAATC | | |
| AGCATTACACGAAACAGATGAAGAAAT | | |
| TAACAAAAAAGCGCACGCTATTTTCAAACATGGAATGACTCCAATTATTTGTGTTGGTGAAACAGACGAAGAG | | |
| CGTGAAAGTGGTAAAGCTAACGATGTT | | |
| GTAGGTGAGCAAGTTAAGAAAGCTGTTGCAGGTTTATCTGAAGATCAACTTAAATCAGTTGTAATTGCTTATG | | |
| AACCAATCTGGGCAATCGGAACTGGTA | | |
| AATCATCAACATCTGAAGATGCGAATGAAATGTGTGCATTTGTACGTCAAACTATTGCTGACTTATCAAGCAA | | |
| AGAAGTATCAGAAGCAACTCGTATTCA | | |
| ATATGGTGGTAGTGTTAAACCTAACAACATTAAAGAATACATGGCACAAACTGATATTGATGGGGCATTAGTA | | |
| GGTGGCGCA | | |
| <Identification Constraints> | | |
| Time Out: 1200 seconds. | | |
| Confidence: 100.0%. | | |
| Maximum Number of Results: 10. | | |
| Excluded SNP's: None. | | |
| (1) | 978==>glpF>>66: T, 83.7%; | 2521==>tpi_>>241: G, 88.3%; |
| | 78==>arcC>>78: A, 90.9%; | 2193==>pta_>>387: G, 92.8%; |
| | 1987==>pta_>>181: G, 94.1%; | 165==>arcC>>165: A, 94.8%; |
| | 577==>aroE>>121: C, 95.4%; | 766==>aroE>>310: G, 96.1%; |
| | 818==>aroE>>362: C, 96.7%; | 1036==>glpF>>124: G, 97.4%; |
| | 1708==>gmk_>>331: C, 98.0%; | 1767==>gmk_>>390: A, 98.7%; |
| | 1921==>pta_>>115: A, 99.3%; | 2438==>tpi_>>158: C, 100.0%; |
| (2) | 978==>glpF>>66: T, 83.7%; | 2521==>tpi_>>241: G, 88.3%; |
| | 78==>arcC>>78: A, 90.9%; | 2193==>pta_>>387: G, 92.8%; |
| | 1987==>pta_>>181: G, 94.1%; | 165==>arcC>>165: A, 94.8%; |
| | 577==>aroE>>121: C, 95.4%; | 766==>aroE>>310: G, 96.1%; |
| | 818==>aroE>>362: C, 96.7%; | 1036==>glpF>>124: G, 97.4%; |
| | 1708==>gmk_>>331: C, 98.0%; | 1767==>gmk_>>390: A, 98.7%; |
| | 2438==>tpi_>>158: C, 99.3%; | 1921==>pta_>>115: A, 100.0%; |
| (3) | 978==>glpF>>66: T, 83.7%; | 2521==>tpi_>>241: G, 88.3%; |
| | 78==>arcC>>78: A, 90.9%; | 2193==>pta_>>387: G, 92.8%; |
| | 1987==>pta_>>181: G, 94.1%; | 165==>arcC>>165: A, 94.8%; |
| | 577==>aroE>>121: C, 95.4%; | 766==>aroE>>310: G, 96.1%; |
| | 818==>aroE>>362: C, 96.7%; | 1036==>glpF>>124: G, 97.4%; |
| | 1708==>gmk_>>331: C, 98.0%; | 1779==>gmk_>>402: C, 98.7%; |
| | 1921==>pta_>>115: A, 99.3%; | 2438==>tpi_>>158: C, 100.0%; |
| (4) | 978==>glpF>>66: T, 83.7%; | 2521==>tpi_>>241: G, 88.3%; |
| | 78==>arcC>>78: A, 90.9%; | 2193==>pta_>>387: G, 92.8%; |
| | 1987==>pta_>>181: G, 94.1%; | 165==>arcC>>165: A, 94.8%; |
| | 577==>aroE>>121: C, 95.4%; | 766==>aroE>>310: G, 96.1%; |
| | 818==>aroE>>362: C, 96.7%; | 1036==>glpF>>124: G, 97.4%; |
| | 1708==>gmk_>>331: C, 98.0%; | 1779==>gmk_>>402: C, 98.7%; |
| | 2438==>tpi_>>158: C, 99.3%; | 1921==>pta_>>115: A, 100.0%; |
| (5) | 978==>glpF>>66: T, 83.7%; | 2521==>pti_>>241: G, 88.3%; |
| | 78==>arcC>>78: A, 90.9%; | 2193==>pta_>>387: G, 92.8%; |
| | 1987==>pta_>>181: G, 94.1%; | 165==>arcC>>165: A, 94.8%; |
| | 577==>aroE>>121: C, 95.4%; | 766==>aroE>>310: G, 96.1%; |
| | 818==>aroE>>362: C, 96.7%; | 1036==>glpF>>124: G, 97.4%; |
| | 1708==>gmk_>>331: C, 98.0%; | 1921==>pta_>>115: A, 98.7%; |
| | 1767==>gmk_>>390: A, 99.3%; | 2438==>tpi_>>158: C, 100.0%; |
| (6) | 978==>glpF>>66: T, 83.7%; | 2521==>tpi_>>241: G, 88.3%; |
| | 78==>arcC>>78: A, 90.9%; | 2193==>pta_>>387: G, 92.8%; |
| | 1987==>pta_>>181: G, 94.1%; | 165==>arcC>>165: A, 94.8%; |
| | 577==>aroE>>121: C, 95.4%; | 766==>aroE>>310: G, 96.1%; |
| | 818==>aroE>>362: C, 96.7%; | 1036==>glpF>>124: G, 97.4%; |
| | 1708==>gmk_>>331: C, 98.0%; | 1921==>pta_>>115: A, 98.7%; |
| | 1779==>gmk_>>402: C, 99.3%; | 2438==>tpi_>>158: C, 100.0%; |
| (7) | 978==>glpF>>66: T, 83.7%; | 2521==>tpi_>>241: G, 88.3%; |
| | 78==>arcC>>78: A, 90.9%; | 2193==>pta_>>387: G, 92.8%; |
| | 1987==>pta_>>181: G, 94.1%; | 165==>arcC>>165: A, 94.8%; |
| | 577==>aroE>>121: C, 95.4%; | 766==>aroE>>310: G, 96.1%; |
| | 818==>aroE>>362: C, 96.7%; | 1036==>glpF>>124: G, 97.4%; |
| | 1708==>gmk_>>331: C, 98.0%; | 1921==>pta_>>115: A, 98.7%; |
| | 2438==>tpi_>>158: C, 99.3%; | 1767==>gmk_>>390: A, 100.0%; |
| (8) | 978==>glpF>>66: T, 83.7%; | 2521==>tpi_>>241: G, 88.3%; |
| | 78==>arcC>>78: A, 90.9%; | 2193==>pta_>>387: G, 92.8%; |
| | 1987==>pta_>>181: G, 94.1%; | 165==>arcC>>165: A, 94.8%; |
| | 577==>aroE>>121: C, 95.4%; | 766==>aroE>>310: G, 96.1%; |
| | 818==>aroE>>362: C, 96.7%; | 1036==>glpF>>124: G, 97.4%; |
| | 1708==>gmk_>>331: C, 98.0%; | 1921==>pta_>>115: A, 98.7%; |
| | 2438==>tpi_>>158: C, 99.3%; | 1779==>gmk_>>402: C, 100.0%; |
| (9) | 978==>glpF>>66: T, 83.7%; | 2521==>tpi_>>241: G, 88.3%; |
| | 78==>arcC>>78: A, 90.9%; | 2193==>pta_>>387: G, 92.8%; |
| | 1987==>pta_>>181: G, 94.1%; | 165==>arcC>>165: A, 94.8%; |
| | 577==>aroE>>121: C, 95.4%; | 766==>aroE>>310: G, 96.1%; |
| | 818==>aroE>>362: C, 96.7%; | 1036==>glpF>>124: G, 97.4%; |
| | 1708==>gmk_>>331: C, 98.0%; | 2438==>tpi_>>158: C, 98.7%; |
| | 1767==>gmk_>>390: A, 99.3%; | 1921==>pta_>>115: A, 100.0%; |
| (10) | 978==>glpF>>266: T, 83.7%; | 2521==>tpi_>>241: G, 88.3%; |
| | 78==>arcC>>78: A, 90.9%; | 2193==>pta_>>387: 0, 92.8%; |
| | 1987==>pta_>>181: G, 94.1%; | 165==>arcC>>165: A, 94.8%; |
| | 577==>aroE>>121: C, 95.4%; | 766==>aroE>>310: 0, 96.1%; |
| | 818==>aroE>>362: C, 96.7%; | 1036==>glpF>>124: G, 97.4%; |
| | 1708==>gmk_>>331: C, 98.0%; | 2438==>tpi_>>158: C, 98.7%; |
| | 1779==>gmk_>>402: C, 99.3%; | 1921==>pta_>>115: A, 100.0%; |

It can be seen that 14 SNPs are required to give 100% discrimination, greater than 90% discrimination is achieved with four SNPs and that the pathways are all very similar. One strategy that may be used to explore more diverse pathways is to ask the program to ignore one or more of the highly discriminatory SNPs at the beginning of the pathways above, and then run the program again.

### EXAMPLE 18

### Development of a Combinatorial Method for Determining Whether or not an Unknown MRSA Isolate Belongs to the “Oceania” Clone

The Oceania clone of MRSA is of interest since it is a major cause of community acquired MRSA infections.

The aim was to develop a combinatorial method for rapidly and accurately determining whether or not an unknown MRSA isolate belonged to this clone. In this context “combinatorial method” means a method that interrogates (SNPs) order to type the genome “backbone”, and also interrogates a hypervariable region of the genome, in order to increase the resolution of the typing procedure. In this case, the hypervariable region used was immediately downstream of the methicillin resistance determinant mecA. This was interrogated using a conventional PCR/agararose gel method.

The Oceania clone has been shown to be ST-30. It also has a highly truncated variant of the mecA downstream region that is found in community acquired MRSA of diverse origin.

The aims of this Example are:—
1. to develop a single step real-time PCR based method for interrogating a SNP that is diagnostic for ST-30. The SNP chosen was arcC272; and
2. to develope a conventional PCR/agarose gel based procedure for determining whether or not an MRSA isolate possesses the truncated downstream mecA region that is characteristic of community acquired isolates.
   A. Allele Specific Real-Time PCR.
   Identification of arcC272

This arcC272 was identified by first identifying SNPs diagnostic for the alleles that make up ST-30, and then determining the discriminatory power of these SNPs at the sequence type level. This method is semi-empirical, as it requires the testing of SNPs combinations at the sequence type level using the “identity check” function of the program.

Bacterial Strains

The methods were tested against MRSA isolates from South East Queensland, Australia. Optimisation was carried out primarily with three isolates known to be ST-30 and two isolates known to be ST-88. ST-30 has a “G” at arcC272 while ST-88 has an “A”.

The allele-specific real-time PCR method for interrogating arcC272 is as follows:

TABLE 62
Reaction constituents

| Kinetic PCR conditions for arcC272 SNP | Single PCR reaction | |
|---|---|---|
| Magnesuim chloride (Roche Diagnostics) | 1 | μl |
| PCR Buffer (Roche Diagnostics) | 2.5 | μl |
| dNTPs (PCR Nucleotide Mix, Roche Diagnostics) | 0.5 | μl |
| Taq polymerase (Roche Diagnostics) | 0.1 | μl |
| Sybr Green Dye (1:1000 working solution; | 0.125 | μl |
| Molecular Probes) | | |
| Forward Primer (2 μM working solution; Proligo) | 2.5 | μl |
| Reverse Primer (2 μM working solution; Proligo) | 2.5 | μl |
| Water | 13.775 | μl |
| Template DNA (final DNA concentration of 2 ng/μl) | 2 | μl |
| Total Volume | 25 | μl |

TABLE 63

Primer sequences
Oligonucleotide primer sequences

| | |
|---|---|
| arcC272G (Forward 1) | GAAGAATTACAAAAAGAACAGCCAGG |
| (ST-30 specific) | [SEQ ID NO: 77] |
| arcC272A (Forward 2) | GAAGAATTACAAAAAGAACAGCCAGA |
| (non-ST-30 specific) | [SEQ ID NO: 78] |
| arcC272 (Reverse) | GGTAGTGGTGACGCAACTACTTTTCTA |
| | [SEQ ID NO: 79] |

Cycling conditions:

50° C. for 2 mins

95° C. for 10 mins

40 cycles of:
95° C. for 15 secs
56° C. for 10 secs
72° C. for 33 secs

Dissociation protocol: 60-95° C. over 20 minutes.

All reactions were carried out in an Applied Biosystems ABI7000 real time PCR machine.

B. Conventional PCR and Agarose Gel Electrophoresis

Primer Design

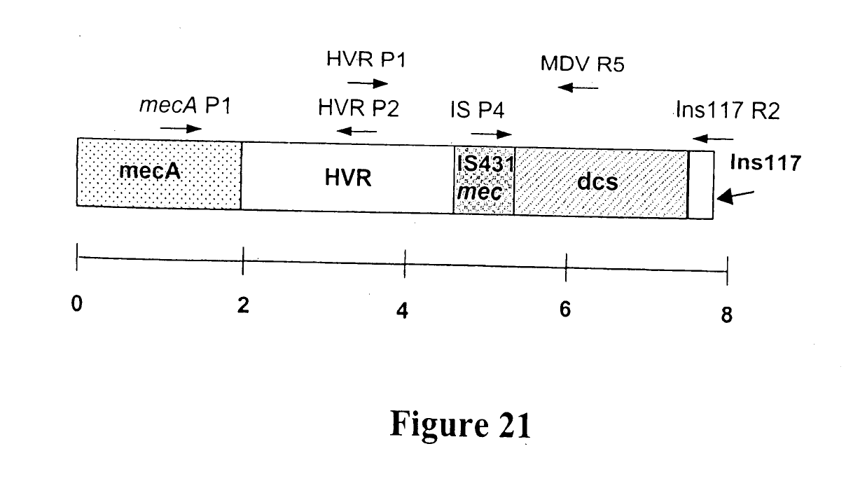

The truncated mecA downstream region characteristic of community acquired isolates is shown in FIG. 21. The primer sequences were designed to provide the following amplification products:

P1 and HVRP2: 2100 bp

HVR P1 and MDV R5: 2800 bp

IS P4 and Ins117 R2: 2300 bp

In health care facility acquired isolates, the mecA downstream region is typically much larger due to the integration of plasmids and insertion sequences including pT181, pI258 and IS257. In these isolates, primer pairs HVR P1/MDV R5 and IS P4/Ins117 R2 would be expected to produce either larger amplification products or no amplification product. Primer pair P1/HVRP2 is included as a positive control for the amplification.

Primer sequences

| | | |
|---|---|---|
| mecA P1: | ATC GAT GGT AAA GGT TGG C | [SEQ ID NO: 80] |
| HVR P1: | ATG TCC CAA GCT CCA TTT TG | [SEQ ID NO: 81] |
| HVR P2: | TGG AGC TTG GGA CAT AAA TG | [SEQ ID NO: 82] |
| IS P4: | CAG GTC TCT TCA GAT CTA CG | [SEQ ID NO: 83] |
| MDV R5: | CAT GGC TAT GAT TTA GTA GC | [SEQ ID NO: 84] |
| INS117 | GTT TTT TCA GCC GCT T | [SEQ ID NO: 85] |
| R2: | | |

PCR Reaction Conditions

PCR amplifications were performed using a MJ Research Thermocycler (GeneWorks, Adelaide, Australia) in 0.2 mL PCR tubes containing 20 mM Tris-HCl, 100 mM KCl, 1 mM dithiothreitol (DDT), 0.1 mM EDTA, 0.5% v/v Tween, 2.25 mM MgCl₂, 0.2 mM each dNTP (PCR Nucleotide Mix, Roche Diagnostics, Castle Hill, Australia), 0.5 μM of each forward and reverse primer, 0.7 U of polymerase enzyme mix (Roche Expand Long Template PCR System, Roche diagnostics) and 5 μL of 20 ng/μL purified DNA template solution in a 50 μL total volume. The amplifications were carried out at the following temperature profiles: 94° C. for 4 mins; 30 cycles of 94° C. for 30 secs, 50° C. for 30 secs, 72° C. for 2 mins 30 secs, 72° C. for 10 mins and 4° C. for the remainder of the reaction. For longer reactions (over 5 kb) the following temperature profiles were used: 94° C. for 4 mins; 10 cycles of 94° C. for 30 secs, 50° C. for 30 secs, 68° C. for 5 mins, 20 cycles of 94° C. for 30 secs, 50° C. for 30 secs, 68° C. for 5 mins+20 secs/cycle, 72° C. for 10 mins and 4° C. for the remainder of the reaction.

Agarose Gel Electrophoresis

PCR products were visualized on a 1.0% w/v garose gel, electrophoresed in TBE buffer (90 mM Tris-borate, 2 mM EDTA) at 110 volts for 30-40 mins in the presence of ethidium bromide. PCR products were sized against a molecular weight marker (Marker X, Roche Diagnostics). Eight microlitres of product was adequate to determine presence and quality of the PCR products.

Identification of arcC272

ArcC272 was identified using the semi-empirical strategy described above. It was found to be 82% discriminatory, i.e. 18% of known sequence types have a G at that position.

The program was also used to determine that sequence types that have a “G” at this position are:

ST2, ST17, ST19, ST24, ST30, ST31, ST32, ST33, ST36, ST37, ST38, ST39, ST40, ST41, ST43, ST57, ST74, ST77, ST86, ST196, ST200, ST210, ST238, ST239, ST240, ST241, ST243, ST246

Allele Specific Real Time PCR

The following table shows the Ct and ΔCt values from screening five MRSA isolates using the allele specific real time PCR reaction.

As expected, in all cases the Ct of the perfectly matched primer set was lower than the Ct for the mis-matched primer set, thus demonstrating that the reaction called the SNPs correctly (Table 64):—

TABLE 64

| | | | arcC272A | |
|---|---|---|---|---|
| | Multi Locus | arcC272 specific | Specific | |
| Isolate No. | Sequence Type | reaction | reaction | ΔCt |
| 1 | 30 | 15.88 | 20.66 | 4.78 |
| 22 | 30 | 16.715 | 21.465 | 4.75 |
| 5 | 30 | 17.365 | 20.17 | 2.805 |
| 7 | 88 | 21.225 | 17.64 | −3.585 |
| 12 | 88 | 20.46 | 17.27 | −3.19 |

Conventional PCR/Agarose Gel Electrophoresis-Based Diagnosis of the Truncated mecA Downstream Region Characteristic of Community Acquired MRSA

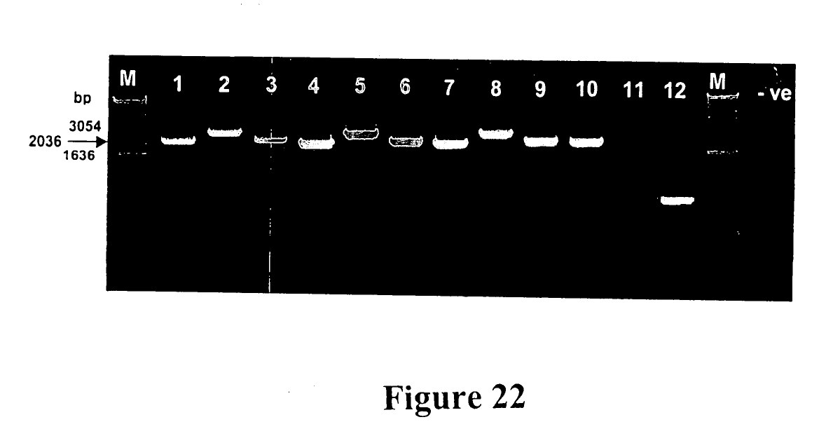

The results of applying this approach to four MRSA isolates is shown in FIG. 22.

It can be seen that this method discriminated between the community acquired isolates and the hospital acquired isolate. It can also be seen that that the bands obtained from the community acquired isolates are of the expected size (2200, 2300 and 2800 bp).

Demonstration of the Combinatorial Power of Interrogation of the mecA Downstream Region and arcC272

As mentioned above, the Oceania clone is ST-30 and has the short form of the mecA downstream region. Previous work has also revealed that this clone is pulse field gel electrophoretic type (pulsotype) A (Nimmo et al., J. Clin. Microbiol. 38: 3926-3931, 2000).

Thirty-five diverse MRSA isolates from South-East Queensland were subject to analysis to determine if interrogation of arcC272 and the mecA downstream region could discriminate pulsotype A MRSA from non-pulsotype A MRSA. The results are shown in Table 65.

TABLE 65

| | | | | | Short form | |
|---|---|---|---|---|---|---|
| | | | | | mecA | |
| | | | | | downstream | |
| code | Isolate | Acquisition | Pulsotype | MLST type | region | Base at arcC272 |
| 1 | A803355 | Community | A | 30 | yes | G |
| 2 | IP01M2046 | Hospital | P1 | 78 | no | A |
| 3 | PA01M18489 | Hospital | EMRSA- | 239 | no | G |
| | | | 1, 2, 4 | | | |
| 4 | IP01M1081 | Hospital | Q | ND | yes | A |
| 5 | 66460/98 | Community | A | 30 | yes | G |
| 6 | D828570 | Community | A | 30 | yes | G |
| 7 | F829549 | Community | D | New | yes | A |
| 8 | E822547 | Community | A | 30 | yes | G |
| 9 | E802537 | Community | A | 30 | yes | G |
| 10 | D828534 | Hospital | E | ND | no | A |
| 11 | C801535 | Hospital | D | New | no | A |
| 12 | A823547 | Community | A | 30 | yes | G |
| 13 | J710566 | Nursing home | C | ND | no | A |
| 14 | F810539 | Community | A | 30 | yes | G |
| 15 | E804531 | Hospital | I | ND | yes | A |
| 16 | D821552 | Community | A | 30 | yes | G |
| 17 | C810534 | Community | A | 30 | yes | G |
| 18 | B826559 | Community | A | 30 | yes | G |
| 19 | A806533 | Community | A | 30 | yes | G |
| 20 | B8-31 | Path centre | K | ND | yes | A |
| 21 | K704540 | Hospital | F | ND | no | G |
| 22 | E822485 | Hospital | B | ND | no | G |
| 23 | E803534 | Community | A | 30 | yes | G |
| 24 | D817541 | Community | A | 30 | yes | G |
| 25 | B827549 | Nursing home | E | ND | no | A |
| 26 | A830538 | Community | A | 30 | yes | G |
| 27 | K703484 | Hospital | G1 | ND | no | G |
| 28 | I825560 | Community | A | 30 | yes | G |
| 29 | K711532 | Hospital | F3 | ND | no | G |
| 30 | E812560 | Hospital | J | ND | no | G |
| 31 | K714372 | Hospital | F4 | ND | no | G |
| 32 | I823541 | Hospital | G2 | ND | no | G |
| 33 | K705613 | Hospital | F2 | ND | no | G |
| 34 | 68284/98 | Community | A | ND | yes | G |
| 35 | IPOOM14235 | Hospital | O | ND | no | G |

It can be seen that while neither the mecA downstream region nor arcC272 by themselves were highly discriminatory for pulsotype A, in combination they are 100% specific and sensitive with this group of isolates. This is because any of the non-pulsotype A isolates that have the short form mecA downstream region do not have a “G” at arcC272 (e.g. isolates 4 and 7) while any non-pulsotype A isolates that are “G” at arcC272 do not have the short form mecA downstream region (e.g. isolates 21, 22, 29).

This example demonstrates that a single SNP that is selected on the basis of its high discriminatory power can be particularly useful if used in combination with a procedure that interrogates a different kind of genetic polymorphism such as an indel in a hypervariable region. This procedure is much faster than pulse field gel electrophoresis, and could be streamlined still further by multiplexing the mecA downstream region PCR reactions or by carrying out these reactions in a real-time PCR machine, and measuring the size of the products by, for example, melting temperature. This approach greatly facilitates the routine surveillance for problematic clones of infectious agents.

### EXAMPLE 19

### Development of a an Allele Specific Real-Time PCR-Based Procedure for Interrogating a Set of S. aureus SNPs that Have High Generalized Discriminatory Power

In order to develop an S. aureus genotyping procedure that is suitable for answering the question, “are these two unknown isolates the same or different”, it is necessary to use a set of SNPs that have a high Simpson's Index of Diversity.

Accordingly, the subject program was used to construct a mega-alignment from the a suitable set S. aureus MLST database, and to identify a suitable set of SNPs. A single step allele specific real-time PCR procedure for interrogating these SNPs was then developed.

SNPs were selected from the S. aureus MLST database as described above.

The SNPs are:

arcC210

tpi243

arcC162

tpi241

yqiL333

aroE132

gmk129

These provide a Simpson's index of Diversity of 0.95.

Two MRSA isolates known to be ST-30 and ST-88 were used to demonstrate the procedure.

The primer sequences are shown in Table 66:

TABLE 66
Oligonucleotide primer sequences:

| | |
|---|---|
| arcC210 (Forward) | TATGATAGGCTATTGGTTGGAAACTG |
| | [SEQ ID NO: 86] |
| arcC210C | CGTATAAAAAGGACCAATTGGTTTG |
| (Reverse 1) | [SEQ ID NO: 87] |
| arcC210T | CGTATAAAAAGGACCAATTGGTTTA |
| (Reverse 2) | [SEQ ID NO: 88] |
| arcC210A | CGTATAAAAAGGACCAATTGGTTTT |
| (Reverse 3) | [SEQ ID NO: 89] |
| tpi243A (Forward 1) | GTAAATCATCAACATCTGAAGATGCA |
| | [SEQ ID NO: 90] |
| tpi243G (Forward 2) | GTAAATCATCAACATCTGAAGATGCG |
| | [SEQ ED NO: 91] |
| tpi243 (Reverse) | CTTCTTTGCTTGATAAGTCAGCAATAG |
| | [SEQ ID NO: 92] |
| arcC162T | GTGATAGAACTGTAGGCACAATCGTT |
| (Forward 1) | [SEQ ID NO: 93] |
| arcC162A | GTGATAGAACTGTAGGCACAATCGTA |
| (Forward 2) | [SEQ ID NO: 94] |
| arcC162 (Reverse) | GGGTTATTGAATCGTGGATCATC |
| | [SEQ ID NO: 95] |
| tpi241G (Forward 1) | GGTAAATCATCAACATCTGAAGATG |
| | [SEQ ID NO: 96] |
| tpi241A (Forward 2) | GGTAAATCATCAACATCTGAAGATA |
| | [SEQ ID NO: 97] |
| tpi241 (Reverse) | CTTCTTTGCTTGATAAGTCAGCAATAG |
| | [SEQ ID NO: 98] |
| yqiL333C | TGCTTGTCAACAACAGTCGCTTC |
| (Forward 1) | [SEQ ID NO: 99] |
| yqiL333T | TGCTTGTCAACAACAGTCGCTTT |
| (Forward 2) | [SEQ ID NO: 100] |
| yqiL333 (Reverse) | TCTGTTAAACCATCATATACCATGCTATC |
| | [SEQ ID NO: 101] |
| aroE132A | GGCTTTAATATCACAATTCCTCATAAAGAA |
| (Forward 1) | [SEQ ID NO: 102] |
| aroE132G | GGCTTTAATATCACAATTCCTCATAAAGAG |
| (Forward 2) | [SEQ ID NO: 103] |
| aroE132 (Reverse) | CTTGTCATCTTTTATCAAAACAGTGTTAAC |
| | [SEQ ID NO: 104] |
| gmk129C (Forward 1) | GGATGCGTTTGAAGCTTTAATC |
| | [SEQ ID NO: 105] |
| gmk129T (Forward 2) | GGATGCGTTTGAAGCTTTAATT |
| | [SEQ ID NO: 106] |
| gmk129 (Reverse) | TTGTATCTTTAACATATTGAACTGGTGTAC |
| | [SEQ ID NO: 107] |

The reactions used are contained in Table 67:

TABLE 67
Kinetic PCR conditions for mega-alignment Staph SNPs

| | |
|---|---|
| ABI Prism Sybr Green Master Mix | 12.5 μl |
| Forward Primer (2 μM working solution; Proligo) | 2.5 μl |
| Reverse Primer (2 μM working solution; Proligo) | 2.5 μl |
| Template DNA (final DNA concentration of about 2 ng) | 2 μl |
| Water | 5.5 μl |
| Total volume | 25 μl |

The cycling conditions were:

50° C. for 2 mins

95° C. for 10 mins

40 cycles of:
95° C. for 15 secs
56° C. for 10 secs
72° C. for 33 secs

Dissociation protocol: 60-95° C. over 20 mins.

All reactions were carried out in an Applied Biosystems ABI7000 real time PCR machine.

All the ΔCt values were calculated as per Example 17 and are consistent with the sequence types. They are shown below in Tables 68 to 74:

TABLE 68
arcC210

| ST | Nucleotide at SNP | ΔCt |
|---|---|---|
| ST-30 | T | 11.0 |
| ST-88 | T | 10.2 |

TABLE 69
tpi243

| ST | Nucleotide at SNP | ΔCt |
|---|---|---|
| ST-30 | G | 9.2 |
| ST-88 | A | 4.8 |

TABLE 70
arcC162

| ST | Nucleotide at SNP | ΔCt |
|---|---|---|
| ST-30 | A | 14.7 |
| ST-88 | T | 16.0 |

TABLE 71
tpi241

| ST | Nucleotide at SNP | ΔCt |
|---|---|---|
| ST-30 | G | 5.1 |
| ST-88 | G | 5.4 |

TABLE 72
yql333

| ST | Nucleotide at SNP | ΔCt |
|---|---|---|
| ST-30 | T | 4.5 |
| ST-88 | C | 7.6 |

TABLE 73
aroE132

| ST | Nucleotide at SNP | ΔCt |
|---|---|---|
| ST-30 | G | 10.0 |
| ST-88 | A | 3.7 |

TABLE 74
gmk129

| ST | Nucleotide at SNP | ΔCt |
|---|---|---|
| ST-30 | T | 5.7 |
| ST-88 | T | 7.0 |

In addition, alternative SNPs were tested. This is because additions to the database alter slightly the most discriminatory group of SNPs.

An alternative group is as follows:

arcC210

aroE87

arcC162

tpi241

pta294

aroE132

gmk129

This also provides a Simpson's Index of Diversity of 0.95.

Primers have been devised to interrogate the aroE87 and pta294 by allele specific real-time PCR. (These are the two SNPs that are not in the previous grou of SNPs). The primer sequences are shown in Table 75:

TABLE 75
Primer sequences

| | |
|---|---|
| pta294 (Forward) | GGTACAATGCTTGTTTATGCTGGTA |
| | [SEQ ID NO: 108] |
| pta294A (Reverse 1) | TAAAGCTGGACGCACAGTGTCT |
| | [SEQ ID NO: 109] |
| pta294C (Reverse 2) | TAAAGCTGGACGCACAGTGTCG |
| | [SEQ ID NO: 110] |
| pta294T (Reverse 3) | TAAAGCTGGACGCACAGTGTCA |
| | [SEQ ID NO: 111] |
| aroE87G (Forward 1) | GATTTTCATTTAATTAAAGAAATTATTTCG |
| | [SEQ ID NO: 112] |
| aroE87A (Forward 2) | GATTTTCATTTAATTAAAGAAATTATTTCA |
| | [SEQ ID NO: 113] |
| aroE87 (Reverse) | ACCTGCATTAATCGCTTGTTCA |
| | [SEQ ID NO: 114] |

The results from using these primers were also consistent with the known sequence types, and are shown in Tables 76 and 77:

TABLE 76
pta294

| ST | Nucleotide at SNP | ΔCt |
|---|---|---|
| ST-30 | C | 6.3 |
| ST-88 | A | 13.1 |

TABLE 77
aroE87

| ST | Nucleotide at SNP | ΔCt |
|---|---|---|
| ST-30 | A | 5.5 |
| ST-88 | G | 11.0 |

This example demonstrates a single step allele specific real-time PCR procedure for interrogating a group of S. aureus SNPs that on the basis of the MLST database provide a Simpson's index of Diversity of 0.95.

This procedure could be used to very quickly and easily determine if isolates are likely to the same or different from each other, and this will be of great assistance to the practice of public health microbiology and infection control.

A knowledge concerning the diversity of this species increases, it will be possible to construct mega-alignments that are more accurate surrogates for population structures, and that will assist in selecting SNPs that will be highly discriminatory in practice.

### EXAMPLE 20

### Monitoring Bacteria

The aim of this Example is to develop a method for monitoring bacteria within a sewerage treatment plant.

All of the 16s RNA sequences of microorganisms known to inhabit sewage treatment tanks are aligned and the instant program is used to identify a set of SNPs that provides a high Simpson's Index of Diversity. These SNPs in samples from the sewage treatment tank are then interrogated by two different methods:—
(A) DNA is extracted from the sample and the 16s DNA amplified by PCR. This DNA is then cloned and the SNPs in a larger number, e.g. 100, individual clones are interrogated by allele specific real-time PCR. From the results of this, the relative abundances of the different species are deduced;
(B) DNA is extracted from the sample and the SNPs interrogated by real-time allele-specific PCR. This method is able to indicate the proporation of molecules that have a particular base at each SNP. This string of “relative allele proporations” represents a profile that may be correlated with particular ecological states of the sewage treatment process.

Procedure A represents an efficient means of comprehensively analzying the microbial content of the sample while Procedure B represents a very rapid means of monitoring the ecological state of the process.

### EXAMPLE 21

### Financial Data Mining

The aim of this Example is to compare a large number of public companies in order to determine which characteristics may be predictive of future growth and profitability.

Data concerning the circumstances of a large number of public companies at some point in the past (e.g. five years ago) is collected and then arranged into a matrix. This point has been referred to as the “snapshot point”. Each row of the matrix represents a separate company and each row represents a parameter that may have a number of different values. An example of a parameter may be: “number of years within the five years preceding the snapshot point in which a loss of greater than 10% of turnover has been reported” and the possible values of this parameter are 0, 1, 2, 3, 4 or 5, or “highest educational qualification of CEO” in which case the possible values are primary school, high-school, bachelors degree, post-graduate degree”.

The companies that have grown and prospered during the time after the snap shot point are then classed as the group of interest while the remainder are classed as the out group. A “not N” analysis is then carried out to define a small subset of parameters that define the in-group with high degree of discrimination.

This information is then used to screen a large number of companies in order to select which companies are likely to be good investments, or alternatively is used to restructure an existing company in order to improve its competitiveness.

The advantage of the “not N” approach is that it allows for the fact that a parameter may have several values within the group of interest and yet still be highly discriminatory for that group.

A variation of this approach which controls for market cycles, fads and trends is to use a different snap-shot point for each company.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations of any two or more of said steps or features.

### BIBLIOGRAPHY

Bonner and Laskey, Eur. J. Biochem. 46: 83, 1974;
Chee et al., Science 274: 610-614, 1996;
Conner et al., Proc. Natl. Acad. Sci. USA 80: 278-282, 1983;
DiRisi et al., Nature Genetics 14: 457-460, 1996;
Douillard and Hoffman, Basic Facts about Hybridomas, in Compendium of Immunology Vol. 11, ed. by Schwartz, 1981;
Elghanian et al., Science 277: 1078-1081, 1997;
Finkelstein et al., Genomics 7: 167-172, 1990;
Germer et al., Genome Research 10: 258-266, 2000;
Grompe et al., Proc. Natl. Acad. Sci. USA 86: 5855-5892, 1989;
Grosch et al., Br. J. Clin. Pharma. 52: 711-714, 2001;
Grompe, Proc. Natl. Acad. Sci. USA 86: 5855-5892, 1993;
Hacia et al., Nature Genetics 14: 441-447, 1996;
Hessner et al., Clin. Chem. 46: 1051-1056, 2000;
Huygens et al., J. Clin. Microbiol. 40: 3093-3097; 2002;
Hunter and Gaston, J. Clin. Microbiol. 26: 2465-2456, 1988;
Kinszler et al., Science 251: 1366-1370, 1991;
Kohler and Milstein, European Journal of Immunology 6: 511-519, 1976;
Kohler and Milstein, Nature 256: 495-499, 1975;
Lipshutz et al., Biotechniques 19: 442-447, 1995;
Livak et al., PCR Methods Appl. 4: 357-362, 1995;
Lockhart et al., Nature Biotechnology 14: 1675-1680, 1996;
Maiden et al., Proc. Natl. Acad. Sci. USA 95: 3140-3145, 1998;
Marmur and Doty, J. Mol. Biol. 5: 109, 1962;
Modrich, Ann. Rev. Genet. 25: 229-253, 1991;
Morin et al., Biotechniques 27: 538-540, 542, 544 [Passim], 1999;
Nazarenko et al., Nucleic Acids Research 30: e37, 2002;
Newtown et al., Nucl. Acids. Res. 17: 2503-2516, 1989;
Nimmo et al., J. Clin. Microbiol. 38: 3926-3931, 2000;
Oliveira et al., Antimicrobiol Agents and Chemotherapy 44: 1906-1910, 2000;
Orita et al., Proc. Nat. Acad. Sci. USA 86: 2776-2770, 1989;
Ruano and Kidd, Nucl. Acids. Res. 17:8392, 1989;
Sheffield et al., Am. J. Hum. Genet. 49: 699-706, 1991;
Sheffield et al., Proc. Nail. Acad. Sci. USA 86: 232-236, 1989;
Shoemaker et al., Nature Genetics 14: 450-456, 1996;
Thelwell et al., Nucleic Acids Research 28: 3752-3761, 2000;
Tyagi and Kramer, Nat. Biotechnol. 14: 303-308, 1996;
Wartell et al., Nucl. Acids Res. 18:2699-2705, 1990;
White et al., Genomics 12: 301-306, 1992;

1. A method for analyzing a data set, said method comprising the steps of:
compiling a data set for a population, said data set comprising a data string for each member of the population;
identifying one or more variable parameters, said variable parameters present in each of the data strings;
comparing the one or more variable parameters between at least two of the data strings; and
identifying a subset of the population on the basis of the comparison.

2. A method for assessing a multi-parametric data set, said method comprising:—
(a) inputting data from the multi-parametric data set;
(b) determining differences between populations of objects within the data set; and
(c) generating a fingerprint of the populations based on differences between the objects.

3. A method of assessing a data set with respect to one or more other data sets, each data set being formed from a sequence of elements, each element having a respective one of a number of values, the method including:—
(a) determining polymorphic elements having different values between the data set and any other data set;
(b) determining a discriminatory power for at least some of the polymorphic elements, the discriminatory power representing the usefulness of the polymorphic element in determining the similarity between the data set and any other data set; and
(c) selecting one or more of the polymorphic elements in accordance with the determined discriminatory powers.

4. The method of claim 3 wherein the method of determining the polymorphic elements includes comparing the value of each element with the value of a corresponding element in each other data set.

5. The method of claim 4 wherein each element having a respective location within the data set comprises a corresponding element having the same location in the other data set.

6. The method of claim 5 wherein the data set includes location information representing the location of each element.

7. The method of claim 3 further including selecting the polymorphic elements to determine an identifier representative of the data set.

8. The method of claim 3 wherein the polymorphic elements are selected to allow the data set to be discriminated from each of the other data sets.

9. The method of claim 3 wherein the polymorphic elements are selected to allow the data set and a selected one of other data sets to be determined as identical to each other.

10. The method of claim 8 wherein the discriminatory power of each polymorphic element is determined using the formula:—
$$D = 1 - \frac{1}{N ( N - 1 )} {\sum }_{j = 1}^{s} {n}_{j} ( {n}_{j} - 1 )$$
where:
N is the number of data sets being considered;
s is the number of classes defined; and
nⱼ is the number of data sets of the jth class.

11. The method of claim 8 wherein the discriminatory power of each polymorphic element is based on the number of other data sets that have an identical value for the corresponding element.

12. The method of claim 3 wherein the method of selecting the elements includes:—
(a) selecting a first polymorphic element having the highest discriminatory power;
(b) selecting a next polymorphic element which in combination with the selected polymorphic element(s) has the next highest discriminatory power; and
(c) repeating step (b) with at least one of:—
(i) a predetermined number of times; or
(ii) until a predetermined level of discrimination is reached.

13. The method of claim 3 wherein the method of selecting the elements includes:—
(a) selecting a number of sub-sets of the polymorphic elements;
(b) determining the discriminatory power of each sub-set; and
(c) selecting the elements to be the polymorphic elements of the sub-set having the highest discriminatory power.

14. The method of claim 13 wherein the method of selecting a number of sub-sets of the polymorphic elements includes performing an initial screening process to determine a number of polymorphic elements having at least a predetermined discriminatory power.

15. The method of claim 3 wherein the method further includes determining a consensus data set defining a group of data sets from the data set and each other data set.

16. The method of claim 15 wherein the method of defining the consensus data set includes:—
(a) determining polymorphic elements having different values between each data set in the group; and
(b) defining the consensus data set by eliminating each of the polymorphic elements from a selected one of the data sets in the group.

17. The method of claim 16 wherein the method of defining the consensus data set includes:—
(a) determining the values of corresponding elements in the group;
(b) determining any missing values, the missing values being values that are not present for corresponding elements in the group; and
(c) defining the consensus data set in terms of any missing values that are present in corresponding elements not included in the group.

18. The method of claim 3 wherein the data set represents biological entities.

19. The method of claim 18 wherein the biological entities may be one or more of nucleic acids, proteins, amino acids, nucleic acid sequences, amino acids sequences, microorganisms including bacteria, viruses, prions, unicellular organisms, prokaryotes and eukaryotes.

20. A method of assessing a data set with respect to one or more other data sets, each data set being formed from a sequence of elements, each element having a respective one of a number of values, the method being substantially as hereinbefore described.

21. A method of assessing a nucleotide sequence data set which respect to one or more other nucleotide sequence data sets, each nucleotide in each data set having a respective one of a number of values, the method including:
(a) determining polymorphic nucleotides having different values between the data set and any other data set;
(b) determining a discriminatory power for at least some of the polymorphic nucleotides, the discriminatory power representing the usefulness of the polymorphic nucleotides in determining the similarity between the data set and any other data set; and
(c) selecting one or more of the polymorphic nucleotides in accordance with the determined discriminatory powers.

22. The method of claim 21 wherein the method of determining the polymorphic nucleotides includes comparing the value of each nucleotide with the value of a corresponding nucleotide in each other data set.

23. The method of claim 22 wherein each nucleotide having a respective location within the data set comprises a corresponding nucleotide having the same location in the other data set.

24. The method of claim 23 wherein the data set includes location information representing the location of each nucleotide.

25. The method of claim 21 further including selecting the polymorphic nucleotides to determine an identifier representative of the data set.

26. The method of claim 21 wherein the polymorphic nucleotides are selected to allow the data set to be discriminated from each of the other data sets.

27. The method of claim 21 wherein the polymorphic nucleotides are selected to allow the data set and a selected one of other data sets to be determined as identical to each other.

28. The method of claim 26 wherein the discriminatory power of each polymorphic nucleotide is determined using the formula:—
$$D = 1 - \frac{1}{N ( N - 1 )} {\sum }_{j = 1}^{s} {n}_{j} ( {n}_{j} - 1 )$$
where:
N is the number of data sets being considered;
s is the number of classes defined; and
nⱼ is the number of data sets of the jth class.

29. The method of claim 26 wherein the discriminatory power of each polymorphic nucleotide is based on the number of other data sets that have an identical value for the corresponding nucleotide.

30. The method of claim 21 wherein the method of selecting the nucleotides includes:—
(a) selecting a first polymorphic nucleotide having the highest discriminatory power;
(b) selecting a next polymorphic nucleotide which in combination with the selected polymorphic nucleotide(s) has the next highest discriminatory power; and
(c) repeating step (b) with at least one of:—
(i) a predetermined number of times; or
(ii) until a predetermined level of discrimination is reached.

31. The method of claim 21 wherein the method of selecting the nucleotides includes:—
(a) selecting a number of sub-sets of the polymorphic nucleotides;
(b) determining the discriminatory power of each sub-set; and
(c) selecting the elements to be the polymorphic nucleotides of the sub-set having the highest discriminatory power.

32. The method of claim 31 wherein the method of selecting a number of sub-sets of the polymorphic nucleotides includes performing an initial screening process to determine a number of polymorphic nucleotides having at least a predetermined discriminatory power.

33. The method of claim 21 wherein the method further includes determining a consensus data set defining a group of data sets from the data set and each other data set.

34. The method of claim 33 wherein the method of defining the consensus data set includes:—
(a) determining polymorphic nucleotides having different values between each data set in the group; and
(b) defining the consensus data set by eliminating each of the polymorphic nucleotides from a selected one of the data sets in the group.

35. The method of claim 34 wherein the method of defining the consensus data set includes:—
(a) determining the values of corresponding nucleotides in the group;
(b) determining any missing values, the missing values being values that are not present for corresponding nucleotides in the group; and
(c) defining the consensus data set in terms of any missing values that are present in corresponding nucleotides not included in the group.

36. The method of any one of the claims 21 to 35 claim 21 wherein the data set represents biological entities.

37. The method of claim 36 wherein the biological entities may be one or more of nucleic acids, proteins, amino acids, nucleic acid sequences, amino acids sequences, microorganisms including bacteria, viruses, prions, unicellular organisms, prokaryotes and eukaryotes.

38. The method of claim 37 wherein the nucleotide sequences are RNA or DNA.

39. The method of claim 37 wherein the nucleotide sequences are or encode ribosomal DNA.

40. The method of claim 36 wherein the biological entity is selected from Salmonella, Escherichia, Klebsiella, Pasteurella, Bacillus (including Bacillus anthracis), Clostridium, Corynebacterium, Mycoplasma, Ureaplasma, Actinomyces, Mycobacterium, Chlamydia, Chlamydophila, Leptospira, Spirochaeta, Borrelia, Treponema, Pseudomonas, Burkholderia, Dichelobacter, Haemophilus, Ralstonia, Xanthomonas, Moraxella, Acinetobacter, Branhamella, Kingella, Erwinia, Enterobacter, Arozona, Citrobacter, Proteus, Providencia, Yersinia, Shigella, Edwardsiella, Vibrio, Rickettsia, Coxiella, Ehrlichia, Arcobacteria, Peptostreptococcus, Candida, Aspergillus, Trichomonas, Bacterioides, Coccidiomyces, Pneumocystis, Cryptosporidium, Porphyromonas, Actinobacillus, Lactococcus, Lactobacillua, Zymononas, Saccharomyces, Propionibacterium, Streptomyces, Penicillum, Neisseria, Staphylococcus, Campylobacter, Streptococcus, Enterococcus and Helicobacter.

41. The method of claim 21 further comprising interrogating a hypervariable genetic region.

42. The method of claim 41 wherein the hypervariable region is a hypervariable locus.

43. The method of claim 37 wherein the biological entity is Neissera meningitidis.

44. The method of claim 43 wherein highly discriminatory polymorphic nucleotides are fumC435 and pdhC12.

45. The method of claim 43 wherein the highly discriminatory polymorphic nucleotides are abcZ411, aroE455,fumC201 and pdhC274.

46. The method of claim 43 wherein the highly discriminatory polymorphic nucleotides are gdh129, abcZ423, aroE82,fumC9,pdhC129, adk21 and gdh492.

47. The method of claim 37 wherein the biological entity is Staphylococcus aureus.

48. The method of claim 47 wherein the highly discriminatory polymorphic nucleotide is arcC272.

49. The method of claim 47 wherein the highly discriminatory polymorphic nucleotide is are arcC210, tpi243, aroC162, tpi241, yqiL333, aroE132 and gmk129.

50. The method of claim 47 wherein the highly discriminatory polymorphic nucleotide are aroE87 and pta294.

51. An oligonucleotide probe or primer useful in identifying or discriminating a biological entity as defined in claim 37.

52. The oligonucleotide probe or primer of claim 51 wherein the probe or primer is used in real-time PCR to identify or discriminate the biological entity.

53. The oligonucleotide probe or primer according to claim 52 wherein the biological entity is Neisseria meningitidis ST-11 and the probe or primer is selected from SEQ ID NOs:32, 33, 34, 35, 36 and 37.

54. The oligonucleotide probe or primer according to claim 52 wherein the biological entity is Neisseria meningitidis ST-42 and the probe or primer is selected from SEQ ID NOs:38, 39, 40, 41, 42, 43, 44, 45, 46, 47, 48 and 49.

55. The oligonucleotide probe or primer according to claim 52 wherein the biological entity is Neisseria meningitidis and the probe or primer is selected from SEQ ID NOs:50, 51, 52, 53, 54, 55, 56, 57, 58, 59, 60, 61, 62, 63, 64, 65, 66, 67, 68, 69, 70, 71, 72, 73, 74 and 75.

56. The oligonucleotide probe or primer according to claim 52 wherein the biological entity is Staphylococcus aureus ST-30 and the probe or primer is selected from SEQ ID NOs:77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, and 114.

57. The oligonucleotide probe or primer according to claim 52 wherein the biological entity is selected from Helicobacter pylori, Campylobacter jejuni, Streptococcus pneumoneae, Streptococcus pyogenes, Enterococcus faelcium and Streptococcus aureus and the probe or prober is selected from those listed in Example 15.

58. A processing system for assessing a data set with respect to one or more other data sets, each data set being formed from a sequence of elements, each element having a respective one of a number of values, the processing system being adapted to:—
(a) compare the value of each element of the data set with the value of corresponding elements in each other data set;
(b) identify one or more elements having different values between the data sets; and
(c) generate an indication of the one or more elements.

59. The processing system of claim 58 wherein the processing system includes a store for storing the one or more other data sets.

60. The processing system of claim 57 wherein the processing system is adapted to perform the method of.

61. The processing system for assessing a data set with respect to one or more other data sets, the processing system being substantially as hereinbefore described.

62. A computer program product including computer executable code which when executed on a suitable processing system causes the processing system to:—
(a) compare the value of each element of the data set with the value of corresponding elements in each other data set;
(b) identify one or more elements having different values between the data sets; and
(c) generate an indication of the one or more elements.

63. The computer program product of claim 62 wherein the computer program product is adapted to cause the processing system to perform the method of any assessing a data set with respect to one or more other data sets, each data set being formed from a sequence of elements, each element having a respective one of a number of values, the method including:—
(d) determining polymorphic elements having different values between the data set and any other data set;
(e) determining a discriminatory power for at least some of the polymorphic elements, the discriminatory power representing the usefulness of the polymorphic element in determining the similarity between the data set and any other data set; and
(f) selecting one or more of the polymorphic elements in accordance with the determined discriminatory powers.

64. A computer program product for assessing a data set with respect to one or more other data sets, the computer program product being substantially as hereinbefore described.

65. A method for analyzing a data set to determine a business's financial well being, said method comprising the steps of:
compiling a data set for two or more businesses, said data set comprising a data string for each business;
identifying one or more variable parameters, said variable parameters present in each of the data strings;
comprising the one or more variable parameters between at least two of the data strings; and
identifying a subset of the businesses on the basis of the comparison.

66. The method of claim 65 wherein a parameter is the number of years within a preceding five year snapshot point in which a loss of greater than 10% of turnover has been reported.

67. The method of claim 66 wherein a parameter is the highest educational qualification of the operations chief of the business.

68. The method of claim 66 wherein a parameter is annual turnover.

69. The method of claim 65 wherein a parameter is selected from financial data.

70. The method of claim 65 wherein the parameter is selected to allow the data set to be discriminated from each of the other data sets.

71. The method of claim 70 wherein the discriminatory power of each paramater is determined using the formula:—
$$D = 1 - \frac{1}{N ( N - 1 )} {\sum }_{j = 1}^{s} {n}_{j} ( {n}_{j} - 1 )$$
where:
N is the number of data sets being considered;
s is the number of classes defined; and
nⱼ is the number of data sets of the jth class.

72. The method of claim 65 wherein the method of selecting the parameters includes:—
(a) selecting a first parameter having the highest discriminatory power;
(b) selecting a next parameter which in combination with the selected parameter(s) has the next highest discriminatory power; and
(c) repeating step (b) with at least one of:—
(i) a predetermined number of times; or
(ii) until a predetermined level of discrimination is reached.

73. The method of claim 65 wherein the method of selecting the parameters includes:—
(a) selecting a number of sub-sets of the parameters;
(b) determining the discriminatory power of each sub-set; and
(c) selecting the elements to be the parameters of the sub-set having the highest discriminatory power.

74. The method of claim 73 wherein the method of selecting a number of sub-sets of the parameters includes performing an initial screening process to determine a number of parameters having at least a predetermined discriminatory power.

75. The method of claim 65 wherein the method further includes determining a consensus data set defining a group of data sets from the data set and each other data set.

76. The method of claim 75 wherein the method of defining the consensus data set includes:—
(a) determining parameters having different values between each data set in the group; and
(b) defining the consensus data set by eliminating each of the parameters from a selected one of the data sets in the group.

77. The method of claim 76 wherein the method of defining the consensus data set includes:—
(a) determining the values of corresponding parameters in the group;
(b) determining any missing values, the missing values being values that are not present for corresponding parameters in the group; and
(c) defining the consensus data set in terms of any missing values that are present in parameters not included in the group.

78. A method of conducting a business comprising the steps of monitoring nucleotide or amino acid databases for the presence of microorganisms or viruses identified at a point of diagnosis having a defined informative SNP and relaying the data obtained to a public health authority or monitoring agency.


SEQUENCE LISTING (114 sequences)

SEQ ID NO: 1 - DNA, 481 bp, Artificial Sequence
  Synthetic allele
atcggtttggccaacgacatcacgcaggtcaaaaacattgccatcgaaggcaaaaccatttgcttttgggcgcgggcggcgcggtgcgcggcgtgattcctgttttgaaagaacaccgcctgcccgtatcgtcattgccaaccgcacccacgccaaagccgaagaattggcgcggctttcggcattgaagccgtcccgatggcggatgtgaacggcggttttgatatcatcatcaaggcacgtccggcggcttgagcggtcagcttcctgccgtcagtcctgaaattttcctcggtgccgccttgcctacgatatggtttacggcgacgcggcgcaggagtttttgaactttgccaaagcaacggtgcggccgaagtttcagacggactgggtatgctggtcggtcaagcggcgcttcctacgccctctggcgcggatttacgcccgatatccgccctgttatcgaatacataaagccatg

SEQ ID NO: 2 - DNA, 490 bp, Artificial Sequence
  Synthetic allele
tatcggtttgaccaacgacatcacgcaggtcaaaaatattgccatcgagggcaaaaccattttgcttttgggcgcaggcggcgcggtgcgcggcgtgattcctgttttgaaagaacaccgtcctgcccgtatcgtcattgccaaccgtacccgcgccaaagccgaggaattggcgcagcttttcggcattgaagccgtcccgatggcggatgtgaacggcggttttgatatcatcatcaacggcacgtcgggcggtctaaacggtcagattcccgatattccgcccgatatttttcaaaactgcgcgcttgcctacgatatggtgtacggctgcgcggcaaaaccgtttttagattttgcacgacaatcgggtgcgaaaaaaactgccgacggactgggtatgctagtcggtcaagcggcggcttcctacgccctctggcgcggatttacgcccgatatccgccccgttatcgaatacatgaaagcccta

SEQ ID NO: 3 - DNA, 490 bp, Artificial Sequence
  Synthetic allele
tatcggtttggccaacgacatcacgcaggtcaaaaacattgccatcgaaggcaaaaccatcttgcttttgggcgcgggcggcgcggtgcgcggcgtgattcctgttttgaaagaacaccgtcctgcccgtatcgtcattgccaaccgcacccacgccaaagccgaagaattggcgcggcttttcggcattgaagccgtcccgatggcggatgtgaacggcggttttgatatcatcatcaacggcacgtccggcggcttgagcggtcagcttcctgccgtcagtcctgaaattttcctcggctgccgccttgcctacgatatggtttacggcgacgcggcgcaggagtttttgaactttgcccaaagcaacggtgcggccgaagtttcagacggactgggtatgctggtcggtcaagcggcggcttcctacgccctctggcgcggatttacgcccgatatccgccctgttatcgaatacatgaaagccatg

SEQ ID NO: 4 - DNA, 40 bp, Artificial Sequence
  Synthetic allele
tcctgcctactcgtggtgtcgacccgccagtgagttcggt

SEQ ID NO: 5 - DNA, 40 bp, Artificial Sequence
  Synthetic allele
tcctgcctactcatgacgtcgacctaccgacgggccgtgt

SEQ ID NO: 6 - DNA, 88 bp, Artificial Sequence
  Synthetic allele
tttgatactgttgccgaaggtttgggcgaaattcgcgatttattgcgccgttatcatcattgcaacttgagacaatgccaagtttgaa

SEQ ID NO: 7 - DNA, 10 bp, Artificial Sequence
  Synthetic allele
gatcgttcgc

SEQ ID NO: 8 - DNA, 10 bp, Artificial Sequence
  Synthetic allele
gatgataggc

SEQ ID NO: 9 - DNA, 10 bp, Artificial Sequence
  Synthetic allele
gataatacga

SEQ ID NO: 10 - DNA, 10 bp, Artificial Sequence
  Synthetic allele
gatgcatggt

SEQ ID NO: 11 - DNA, 10 bp, Artificial Sequence
  Synthetic allele
gatcgttcgc

SEQ ID NO: 12 - DNA, 10 bp, Artificial Sequence
  Synthetic allele
gatgataggd

SEQ ID NO: 13 - DNA, 10 bp, Artificial Sequence
  Synthetic allele
gatcgttcgc

SEQ ID NO: 14 - DNA, 10 bp, Artificial Sequence
  Synthetic allele
gatgataggc

SEQ ID NO: 15 - DNA, 10 bp, Artificial Sequence
  Synthetic allele
gataatacga

SEQ ID NO: 16 - DNA, 10 bp, Artificial Sequence
  Synthetic allele
gatgcatggt

SEQ ID NO: 17 - DNA, 10 bp, Artificial Sequence
  Synthetic allele
gatcgttcgc

SEQ ID NO: 18 - DNA, 10 bp, Artificial Sequence
  Synthetic allele
gatcgttcgc

SEQ ID NO: 19 - DNA, 10 bp, Artificial Sequence
  Synthetic allele
gatcgttcgc

SEQ ID NO: 20 - DNA, 10 bp, Artificial Sequence
  Synthetic allele
gatgataggc

SEQ ID NO: 21 - DNA, 10 bp, Artificial Sequence
  Synthetic allele
gataatacga

SEQ ID NO: 22 - DNA, 10 bp, Artificial Sequence
  Synthetic allele
gatgcatggt

SEQ ID NO: 23 - DNA, 5 bp, Artificial Sequence
  Synthetic allele
gtatc

SEQ ID NO: 24 - DNA, 5 bp, Artificial Sequence
  Synthetic allele
gtctc

SEQ ID NO: 25 - DNA, 5 bp, Artificial Sequence
  Synthetic allele
atcta

SEQ ID NO: 26 - DNA, 5 bp, Artificial Sequence
  Synthetic allele
aaagg

SEQ ID NO: 27 - DNA, 5 bp, Artificial Sequence
  Synthetic allele
atagg

SEQ ID NO: 28 - DNA, 10 bp, Artificial Sequence
  Synthetic allele
gtatcaaagg

SEQ ID NO: 29 - DNA, 10 bp, Artificial Sequence
  Synthetic allele
gtctcaaagg

SEQ ID NO: 30 - DNA, 10 bp, Artificial Sequence
  Synthetic allele
gtctcatagg

SEQ ID NO: 31 - DNA, 10 bp, Artificial Sequence
  Synthetic allele
atctaatagg

SEQ ID NO: 32 - DNA, 23 bp, artificial sequence
  fumC435-T
accattccctgatgctggttact

SEQ ID NO: 33 - DNA, 22 bp, artificial sequence
  fumC435-C
ccattccctgatgctggttacc

SEQ ID NO: 34 - DNA, 19 bp, Artificial Sequence
  Consensus sequence
cagcaagcccaactcaacg

SEQ ID NO: 35 - DNA, 24 bp, artificial sequence
  pdhC12-T
cctttcaagatgtcttgttccgca

SEQ ID NO: 36 - DNA, 23 bp, artificial sequence
  pdhC12-C
ctttcaagatgtcttgttctgcg

SEQ ID NO: 37 - DNA, 25 bp, Artificial Sequence
  Consensus Sequence
cgtgttctactacatcaccctgatg

SEQ ID NO: 38 - DNA, 20 bp, artificial sequence
  abcZ411-T
caagttcgacaatccgcgta

SEQ ID NO: 39 - DNA, 20 bp, artificial sequence
  abcZ411-C
cgagttcgacaatccgcgtg

SEQ ID NO: 40 - DNA, 21 bp, Artificial Sequence
  Consensus Sequence
cttggtcgtcattacccacga

SEQ ID NO: 41 - DNA, 25 bp, artificial sequence
  aroE455
tgtattcgataacagggcggatatt

SEQ ID NO: 42 - DNA, 25 bp, artificial sequence
  aroE455-G
tgtattcgataacggggcggatatc

SEQ ID NO: 43 - DNA, 19 bp, Artificial Sequence
  Consensus Sequence
tgggtatgctggtcggtca

SEQ ID NO: 44 - DNA, 17 bp, artificial sequence
  fumC201-A
cgacccaatgcgaagca

SEQ ID NO: 45 - DNA, 17 bp, artificial sequence
  fumC201-G
cgacccaatgcgaagcg

SEQ ID NO: 46 - DNA, 21 bp, Artificial Sequence
  Consensus Sequence
gtaacgtcgttgccgaacact

SEQ ID NO: 47 - DNA, 20 bp, artificial sequence
  pdhC274-C
ggaccgtcatgaccttgcag

SEQ ID NO: 48 - DNA, 20 bp, artificial sequence
  pdhC274-T
ggaccgtcatgaccttgcaa

SEQ ID NO: 49 - DNA, 18 bp, Artificial Sequence
  Consensus Sequence
gaacgcttcaaccgcctg

SEQ ID NO: 50 - DNA, 22 bp, artificial sequence
  Mega-pgm93-A
ccgcaatcctaaagccaaagta

SEQ ID NO: 51 - DNA, 15 bp, artificial sequence
  Mega-pgm93-C
cccggcgcgaaagtc

SEQ ID NO: 52 - DNA, 22 bp, artificial sequence
  Mega-pgm93-G
ccgcaatcctaaagcaaaagtg

SEQ ID NO: 53 - DNA, 20 bp, artificial sequence
  Mega-pgm93-Rev
ccgccgtgttctttaatcca

SEQ ID NO: 54 - DNA, 21 bp, artificial sequence
  Mega-aroE283-A
ggtcagattcccggtattcca

SEQ ID NO: 55 - DNA, 18 bp, artificial sequence
  Mega-aroE283-C
cagcttcctgccgtcagc

SEQ ID NO: 56 - DNA, 21 bp, artificial sequence
  Mega-aroE283-G
ggtcagattcccgatattccg

SEQ ID NO: 57 - DNA, 17 bp, artificial sequence
  Mega-aroE283A-T
agcttccggccgtcaat

SEQ ID NO: 58 - DNA, 20 bp, artificial sequence
  Mega-aroE283G-T
gtcagcttcctgccgtcagt

SEQ ID NO: 59 - DNA, 23 bp, artificial sequence
  Mega-aroE283-rev
ccgtacaccatatcgtaggcaag

SEQ ID NO: 60 - DNA, 16 bp, artificial sequence
  Mega-fumC114-C
ttcgcccaaaccgcag

SEQ ID NO: 61 - DNA, 16 bp, artificial sequence
  Mega-fumC114-T
ttcgcccaaaccgcaa

SEQ ID NO: 62 - DNA, 18 bp, artificial sequence
  Mega-fumC114-For
aatcgccaacgacatccg

SEQ ID NO: 63 - DNA, 22 bp, artificial sequence
  Mega-abcZ183-T
gttttctggcaaaccaagttca

SEQ ID NO: 64 - DNA, 17 bp, artificial sequence
  Mega-abcZ183-C
ccggcaaaccgagttcg

SEQ ID NO: 65 - DNA, 17 bp, artificial sequence
  Mega-abcZ183-G
ccggcaaaccgagttcc

SEQ ID NO: 66 - DNA, 18 bp, artificial sequence
  Mega-abcZ183-for
gaagcgaaggacggctgg

SEQ ID NO: 67 - DNA, 20 bp, artificial sequence
  Mega-abcZ54-C
gcgatttattgcgccgttac

SEQ ID NO: 68 - DNA, 20 bp, artificial sequence
  Mega-abcZ54-T
gcgatttattgcgccgttat

SEQ ID NO: 69 - DNA, 18 bp, artificial sequence
  Mega-abcZ54-rev
gccgtccttcgcttcgat

SEQ ID NO: 70 - DNA, 18 bp, artificial sequence
  Mega-gdh60-A
cagctgaccatcgccgaa

SEQ ID NO: 71 - DNA, 18 bp, artificial sequence
  Mega-gdh60-G
cagctgaccatcgccgag

SEQ ID NO: 72 - DNA, 18 bp, artificial sequence
  Mega-gdh60-rev
tttgcaccatatcgcgca

SEQ ID NO: 73 - DNA, 20 bp, artificial sequence
  Mega-pdhC103-C
ccggcaatgacttcttgcag

SEQ ID NO: 74 - DNA, 20 bp, artificial sequence
  Mega-pdhC103-T
ccggcaatcacttcttgcaa

SEQ ID NO: 75 - DNA, 24 bp, artificial sequence
  Mega-pdhC103-for
aaaggtatgtacctgctgaaagcc

SEQ ID NO: 76 - DNA, 2682 bp, Artificial Sequence
  Synthetic allele
ttattaatccaacaagctaaatcgaacagtgacacaacgccggcaatgccattggatacttgtggtgcaatgtcacaaggtatgataggctattggttggaaactgaaatcaatcgcattttaactgaaatgaatagtgatagaactgtaggcacaatcgtaacacgtgtggaagtagataaagatgatccacgatttgataacccaactaaaccaattggtcctttttatacgaaagaagaagttgaagaattacaaaaagaacagccaggctcagtctttaaagaagatgcaggacgtggttatagaaaagtagttgcgtcaccactacctcaatctatactagaacaccagttaattcgaactttagcagacggtaaaaatattgtcattgcatgcggtggtggcggtattccagttataaaaaaagaaaatacctatgaaggtgttgaagcgaattttaattctttaggattagatgatacttatgaagctttaaatattccaattgaagattttcatttaattaaagaaattatttcaaaaaaagaattagatggctttaatatcacaattcctcataaagagcgtatcataccgtatttagatcatgttgatgaacaagcgattaatgcaggtgcagttaacactgttttgataaaagatggcaagtggatagggtataatacagatggtattggttatgttaaaggattgcacagcgtttatccagatttagaaaatgcatacattttaattttgggagcaggtggtgcaagtaaaggtattgcttatgaattagcaaaatttgtaaagcccaaattaactgttgcgaatagaacgatggctcgttttgaatcttggaatttaaatataaaccaaatttcattggcagatgctgaaaagtatttaggtgctgattggattgtcatcacagctggatggggattagcggttacaatgggtgtgtatgctgttggtcaattctcaggtgcacatttaaacccagcggtgtctttagctcttgcattagacggaagttttgattggtcattagttcctggttatattgttgctcaaatgttaggtgcaattgtcggagcaacaattgtatggttaatgtacttgccacattggaaagcgacagaagaagctggcgcgaaattaggtgttttctctacagcaccggctattaagaattactttgccaactttttaagtgaaattatcggaacaatggcattaactttaggtattttatttatcggtgtaaacaaaattgctgatggtttaaatcctttaattgtcggagcattaattgttgcaatcggattaagtttaggcggtgctactggttatgcaatcaacccagcacgtcgaatatttgaagatccaagtacatcatataagtattctatttcaatgacaacacgtcaaatgcgtgaaggtgaagttgatggcgtagattacttttttaaaactagggatgcgtttgaagctttaattaaagatgaccaatttatagaatatgctgaatatgtaggcaactattatggtacaccagttcaatatgttaaagatacaatggacgaaggtcatgatgtatttttagaaattgaagtagaaggtgcaaagcaagttagaaagaaatttccagatgcgttatttattttcttagcacctccaagtttagatcacttgagagagcgattagtaggtagaggaacagaatctgatgagaaaatacaaagtcgtattaacgaagcacgtaaagaagtcgaaatgatgaatttatacgattacgttgcaacacaattacaagcaacagattatgttacaccaatcgtgttaggtgatgagactaaggttcaatctttagcgcaaaaacttaatcttgatatttctaatattgaattaattaatcctgcgacaagtgaattgaaagctgaattagttcaatcatttgttgaacgacgtaaaggtaaagcgactgaagaacaagcacaagaattattaaacaatgtgaactacttcggtacaatgcttgtttatgctggtaaagcagatggtttagttagtggtgcagcacattcaacaggcgacactgtgcgtccagctttacaaatcatcaaaacgaaaccaggtgtatcaagaacatcaggtatcttctttatgattaaaggtgatgaacagtacatctttggtgattgtgcaatcaatccagaacttgattcacaaggacttgcagaaattgcagtagaaagtgcaaaatcagcattacacgaaacagatgaagaaattaacaaaaaagcgcacgctattttcaaacatggaatgactccaattatttgtgttggtgaaacagacgaagagcgtgaaagtggtaaagctaacgatgttgtaggtgagcaagttaagaaagctgttgcaggtttatctgaagatcaacttaaatcagttgtaattgcttatgaaccaatctgggcaatcggaactggtaaatcatcaacatctgaagatgcgaatgaaatgtgtgcatttgtacgtcaaactattgctgacttatcaagcaaagaagtatcagaagcaactcgtattcaatatggtggtagtgttaaacctaacaacattaaagaatacatggcacaaactgatattgatggggcattagtaggtggcgca

SEQ ID NO: 77 - DNA, 26 bp, artificial sequence
  arcC272G (forward 1) (ST-30 specific)
gaagaattacaaaaagaacagccagg

SEQ ID NO: 78 - DNA, 26 bp, artificial sequence
  arcC272A (forward 2) (non-ST-30 specific)
gaagaattacaaaaagaacagccaga

SEQ ID NO: 79 - DNA, 27 bp, artificial sequence
  arcC272 (reverse)
ggtagtggtgacgcaactacttttcta

SEQ ID NO: 80 - DNA, 19 bp, artificial sequence
  mecA P1 primer
atcgatggtaaaggttggc

SEQ ID NO: 81 - DNA, 20 bp, artificial sequence
  HVR P1 primer
atgtcccaagctccattttg

SEQ ID NO: 82 - DNA, 20 bp, artificial sequence
  HVR P2 primer
tggagcttgggacataaatg

SEQ ID NO: 83 - DNA, 20 bp, artificial sequence
  IS P4 primer
caggtctcttcagatctacg

SEQ ID NO: 84 - DNA, 20 bp, artificial sequence
  MDV R5 primer
catggctatgatttagtagc

SEQ ID NO: 85 - DNA, 16 bp, artificial sequence
  INS117 R2 primer
gttttttcagccgctt

SEQ ID NO: 86 - DNA, 26 bp, artificial sequence
  arcC210 (forward)
tatgataggctattggttggaaactg

SEQ ID NO: 87 - DNA, 25 bp, artificial sequence
  arC210C (reverse 1)
cgtataaaaaggaccaattggtttg

SEQ ID NO: 88 - DNA, 25 bp, artificial sequence
  arcC210T (reverse 2)
cgtataaaaaggaccaattggttta

SEQ ID NO: 89 - DNA, 25 bp, artificial sequence
  arcC210A (reverse 3)
cgtataaaaaggaccaattggtttt

SEQ ID NO: 90 - DNA, 26 bp, artificial sequence
  tip243A (forward)
gtaaatcatcaacatctgaagatgca

SEQ ID NO: 91 - DNA, 26 bp, artificial sequence
  tpi243G (forward 2)
gtaaatcatcaacatctgaagatgcg

SEQ ID NO: 92 - DNA, 27 bp, artificial sequence
  tip243 (reverse)
cttctttgcttgataagtcagcaatag

SEQ ID NO: 93 - DNA, 26 bp, artificial sequence
  arcC162T (forward)
gtgatagaactgtaggcacaatcgtt

SEQ ID NO: 94 - DNA, 26 bp, artificial sequence
  arcC162A (forward 2)
gtgatagaactgtaggcacaatcgta

SEQ ID NO: 95 - DNA, 23 bp, artificial sequence
  arcC162 (reverse)
gggttattgaatcgtggatcatc

SEQ ID NO: 96 - DNA, 25 bp, artificial sequence
  tpi241G (forward 1)
ggtaaatcatcaacatctgaagatg

SEQ ID NO: 97 - DNA, 25 bp, artificial sequence
  tpi241A (forward 2)
ggtaaatcatcaacatctgaagata

SEQ ID NO: 98 - DNA, 27 bp, artificial sequence
  tpi241 (reverse)
cttctttgcttgataagtcagcaatag

SEQ ID NO: 99 - DNA, 23 bp, artificial sequence
  yqiL333C (forward 1)
tgcttgtcaacaacagtcgcttc

SEQ ID NO: 100 - DNA, 23 bp, artificial sequence
  yqiL333T (forward 2)
tgcttgtcaacaacagtcgcttt

SEQ ID NO: 101 - DNA, 29 bp, artificial sequence
  yqiL333 (reverse)
tctgttaaaccatcatataccatgctatc

SEQ ID NO: 102 - DNA, 30 bp, artificial sequence
  aroE132A (forward)
ggctttaatatcacaattcctcataaagaa

SEQ ID NO: 103 - DNA, 30 bp, artificial sequence
  aroE132G (forward 2)
ggctttaatatcacaattcctcataaagag

SEQ ID NO: 104 - DNA, 30 bp, artificial sequence
  aroE132 (reverse)
cttgtcatcttttatcaaaacagtgttaac

SEQ ID NO: 105 - DNA, 22 bp, artificial sequence
  gmk129C (forward 1)
ggatgcgtttgaagctttaatc

SEQ ID NO: 106 - DNA, 22 bp, artificial sequence
  gmk129T (forward 2)
ggatgcgtttgaagctttaatt

SEQ ID NO: 107 - DNA, 30 bp, artificial sequence
  gmk129 (reverse)
ttgtatctttaacatattgaactggtgtac

SEQ ID NO: 108 - DNA, 25 bp, artificial sequence
  pta294 (forward)
ggtacaatgcttgtttatgctggta

SEQ ID NO: 109 - DNA, 22 bp, artificial sequence
  pta294A (reverse 1)
taaagctggacgcacagtgtct

SEQ ID NO: 110 - DNA, 22 bp, artificial sequence
  pta294C (reverse 2)
taaagctggacgcacagtgtcg

SEQ ID NO: 111 - DNA, 22 bp, artificial sequence
  pta294T (reverse 3)
taaagctggacgcacagtgtca

SEQ ID NO: 112 - DNA, 30 bp, artificial sequence
  aroE87G (forward 1)
gattttcatttaattaaagaaattatttcg

SEQ ID NO: 113 - DNA, 30 bp, artificial sequence
  aroE87A (forward 2)
gattttcatttaattaaagaaattatttca

SEQ ID NO: 114 - DNA, 22 bp, artificial sequence
  aroE87 (reverse)
acctgcattaatcgcttgttca